(19) United States
(12) Patent Application Publication
(10) Pub. No.: US 2026/0207982 A1
(43) Pub. Date: Jul. 23, 2026

(54) REACTIVE METAL-MEDIATED ELECTROCHEMICAL DEGRADATION OF HALOGENATED COMPOUNDS

(71) Applicant: The University of Chicago, Chicago, IL (US)

(72) Inventors: Chibueze Amanchukwu, Chicago, IL (US); Bidushi Sarkar, Chicago, IL (US)

(21) Appl. No.: 19/455,166

(22) Filed: Jan. 21, 2026

Related U.S. Application Data
(60) Provisional application No. 63/748,533, filed on Jan. 23, 2025.

(51) Int. Cl. A62D 3/115; A62D 101/22; A62D 101/28

(52) U.S. Cl. CPC A62D 3/115; A62D 2101/22; A62D 2101/28

(57) ABSTRACT

Electrochemical degradation systems for halogenated compounds are provided, the system including a working electrode, and a nonaqueous solution of an ionic compound and the halogenated compound in an organic solvent, the solution in contact with the working electrode. Methods for degrading a halogenated compound are further provided.

### CROSS-REFERENCE TO RELATED APPLICATIONS

The present patent document claims the benefit of priority under 35 U.S.C. 119 (e) to U.S. Provisional Patent Application No. 63/748,533, which was filed on Jan. 23, 2025, and is hereby incorporated by reference in its entirety.

### TECHNICAL FIELD

The present disclosure relates to electrochemical processes.

### BACKGROUND

Per- and polyfluoroalkyl substances (“PFASs”) are a class of halogenated compounds that are used in many consumer and industrial applications. PFASs contain at least one perfluorinated carbon atom in which all carbon-hydrogen bonds have been replaced by carbon-fluorine bonds, and have a wide range of properties, such as high chemical stability and water resistance. Unfortunately, PFASs persist in the environment such that they have been nicknamed “forever chemicals,” and have been implicated in health-related concerns including cancer and immune impairment. Regulations have been proposed or implemented around the world to curtail the use of PFASs in drinking water and limit their concentrations. While reliable detecting and capturing techniques have been developed, few approaches have been developed to permanently degrade and mineralize PFASs to fluoride.

PFAS degradation is particularly important because many environmental and health exposures to PFASs result from improper disposal and limitations on current degradation technologies due to the strength of the carbon-fluorine bond. Among PFASs of particular interest is perfluorooctanoic acid (“PFOA”), because PFOA is ranked among the top ten pollutants by the U.S. Environmental Protection Agency (“EPA”) and is consistently observed in the environment and in almost all humans.

Electrochemical oxidation techniques—not reduction—to degrade PFASs have been heavily explored. Electrodes such as boron-doped diamond (“BDD”) are state-of-the-art for electrochemical oxidation and have a high overpotential for oxygen evolution. When electrochemical oxidation is performed under aqueous conditions, the higher potentials required for PFAS oxidation are obtainable. However, electrochemical oxidation is practically limited by the supply of BDD, which is highly expensive. Further, carbon-fluorine binds are highly resistant to oxidation.

By contrast, fluorinated compounds are vulnerable to reduction. At reductive conditions, and/or in contact with reactive metals such as lithium or sodium, fluorinated solvents and salts are known to degrade to form solid electrolyte interfaces. Chemical and surface characterization techniques demonstrate mineralization to fluoride anion (F⁻). The generation of aqueous electrons for reductive degradation of PFAS in water typically requires complex and energy-intensive methods such as plasma discharge, UV irradiation, or radiolysis. The aqueous electrons are highly reactive and may be easily scavenged by H⁺ or molecular oxygen present in water. The scavenging effect may significantly limit the availability of aqueous electrons for effective PFAS degradation and often requires anaerobic conditions to mitigate the scavenging. While PFASs are often present in the environment in water or in soil, the PFASs may be captured, concentrated, and destroyed in different media.

Thus, there is a need for reactive metal-assisted degradation processes via electroreduction (ReMADE) for remediation of halogenated compounds. Further, there is a need for degradation processes that achieve efficient degradation and defluorination of PFASs without formation of short-chain PFASs, and that achieve complete mineralization to fluoride. Further, there is a need for opportunities to recycle fluoride obtained from degradation of PFASs as useful ingredients. Further, there is a need for nonaqueous electrolytes to take advantage of reactive metals and reduction potentials for PFAS degradation. Further, there is a need to mineralize PFASs to fluoride in order to valorize the fluoride for synthesizing valuable non-PFAS fluorinated compounds.

### SUMMARY

In an example, the present disclosure provides an electrochemical degradation system for a halogenated compound, the system including: a working electrode, to which a current density is applicable; and a nonaqueous solution of an ionic compound and the halogenated compound in an organic solvent, the solution in contact with the working electrode.

In another example, the present disclosure provides fluoride anion obtained from operation of an example of an electrochemical degradation system for a halogenated compound.

In yet another example, the present disclosure provides a method for degrading a halogenated compound, including: applying a current density to a working electrode in contact with a nonaqueous solution of an ionic compound and the halogenated compound in an organic solvent to provide a product solution including fluoride anion.

Further areas of applicability will become apparent from the description provided herein. It should be understood that the description and specific examples are intended for purposes of illustration only and are not intended to limit the scope of the present disclosure.

### DRAWINGS

In order that the present disclosure may be well understood, there will now be described various forms thereof, given by way of example, reference being made to the accompanying drawings. The components in the figures are not necessarily to scale.

The patent or application file contains at least one drawing executed in color. Copies of this patent or patent application publication with color drawing(s) will be provided by the Office upon request and payment of the necessary fee.

FIG. 1 illustrates examples of nonaqueous solvents used to determine reactivity of metals toward PFASs according to the principles of the present disclosure;

FIG. 2 illustrates the surface of lithium exposed to PFOA in examples of nonaqueous solvents for 24 hours according to the principles of the present disclosure;

FIG. 3 illustrates a plot of F 1s XPS data demonstrating relative intensity/concentration of PFOA, and the mineralized LiF resulting from the reaction of lithium in PFOA for the examples of nonaqueous solvents analyzed in FIG. 2 and additionally an example of copper in dimethyl sulfoxide (“DMSO”) according to the principles of the present disclosure;

FIG. 4 illustrates another plot of Li 1s XPS demonstrating relative intensity/concentration of mineralized LiF relative to unreacted Li for the reaction of lithium in PFOA for the examples of nonaqueous solvents analyzed in FIG. 2 and an example of copper in dimethyl sulfoxide according to the principles of the present disclosure;

FIG. 5 illustrates comparative ¹⁹F solution NMR spectra of the supernatants for the examples of lithium in FIG. 2 according to the principles of the present disclosure;

FIG. 6 illustrates ¹⁹F solution NMR spectra of LiF in each of water (top) and DMSO (bottom) as control experiments;

FIG. 7 illustrates a schematic of an example of an electrochemical cell according to the principles of the present disclosure;

FIG. 8 illustrates a scheme of the degradation reaction of PFOA in the presence and absence of lithium, according to the principles of the present disclosure;

FIG. 9 illustrates a plot of PFOA (1 mM) degradation over time, based on ¹⁹F NMR data, in the presence of lithium (0.5 M LiClO₄) and absence of lithium (0.5 M TBAClO₄) in DMSO at applied current density of 50 mA/cm² according to the principles of the present disclosure;

FIG. 10 illustrates a plot of the rate of defluorination (fluoride recovery) over time calculated from a fluoride ion selective electrode (“ISE”) in the presence and absence of lithium according to the principles of the present disclosure;

FIG. 11 illustrates an electrochemical profile demonstrating conventional nucleation and growth of lithium metal electrodeposition on a copper surface at 50 mA/cm² according to the principles of the present disclosure;

FIG. 12 illustrates an electrochemical profile demonstrating electroreduction in DMSO in the presence of TBAClO₄ as a supporting electrolyte at 50 mA/cm² according to the principles of the present disclosure;

FIG. 13 illustrates ¹⁹F spectra at 0 hours and 24 hours, demonstrating almost complete PFOA degradation to fluoride according to the principles of the present disclosure;

FIG. 14 illustrates ion chromatography analysis of PFOA degradation at 24 hours with mobile phase including 1.9 mM bis(2-hydroxyethyl)amino tris(hydroxymethyl) methane (“Bis-Tris”) compared to control with all possible compounds, according to the principles of the present disclosure;

FIG. 15 illustrates ion chromatography analysis of PFOA degradation at 24 hours, mobile phase not including Bis-Tris in the degraded sample subjected to reductive degradation, compared to control with all possible compounds, according to the principles of the present disclosure;

FIG. 16 illustrates a plot of GCMS analysis for degraded PFOA subjected to reductive degradation for 24 hours at 50 mA/cm² compared to a control sample without PFOA, according to the principles of the present disclosure;

FIG. 17 illustrates a plot of LCMS analysis for degraded PFOA subjected to reductive degradation for 24 hours at 50 mA/cm², according to the principles of the present disclosure;

FIG. 18 illustrates ¹⁹F NMR spectra of electrolytes with different amounts of added water subjected to chronopotentiometry at a current density of 50 mA/cm² for 24 h. These measurements were performed outside the glovebox in the presence of air (degradation amounts are in Table 2);

FIG. 19A illustrates with ¹⁹F NMR showing PFOA degradation after 24 hours in the presence of fresh of Li surface and absence of current;

FIG. 19B illustrates a schematic depicting the control experiments with different depositions (at J=−50 mA/cm²) and rest cycles carried over 24 hours, where tₙ (n=1, 3, 5, . . . ) represent the deposition times, and tₙ+1 correspond to the subsequent rest times. For example, if each deposition step lasts 0.5 h followed by a 1 h rest period, then t₁=0.5 h, t₂=1.5 h, t₃=2 h, t₄=3 h, t₅=3.5 h and so on;

FIG. 19C illustrates relation of PFOA degradation with charge passed and the number of cycles (reaction conditions are in Table 3);

FIG. 20A illustrates ¹⁹F NMR spectra of PFOA degradation without any PTFE source (e.g., no stir bar (no rotation) or Teflon coating on the working electrode, with 1 mM PFOA and 0.5 M LiClO₄ in DMSO, the middle spectrum representing the ¹⁹F NMR in DMSO-d₆ of LiF in the electrolyte at 24 hours, indicating the presence of dissolved LiF in the electrolyte, and the top spectrum representing the ¹⁹F NMR in D₂O of LiF detected on the working electrode surface collected by quenching in DI water and adding D₂O (x denotes internal reference, 6 mM LiTFSI), according to the principles of the present disclosure;

FIG. 20B illustrates degradation and defluorination of PFOA without stirring (data in FIG. 20A) and with stirring (but without any Teflon coated stir bar and no Teflon coating on the working electrode. A parylene-C-coated stainless steel stir bar was used instead), according to the principles of the present disclosure;

FIG. 21 illustrates a schematic of an example of H-cell experiments with 1 mM PFOA in catholyte with 0.5 M LiClO₄ in which catholyte was separated from anolyte in dry DMSO, at rest for 24 hours, compared to the cathode subjected to a constant current density of 50 mA/cm² with the working electrode washed with water after 24 hours, according to the principles of the present disclosure;

FIG. 22 illustrates a schematic of an example of H-cell experiments with 1 mM PFOA and 0.5 M LiClO₄ in anolyte (A) in dry DMSO, with ¹⁹F NMR spectra of the anolyte (A) at 0 hours, and the anolyte (A), catholyte (C), and working electrode (E) after being subjected to a constant current density of 50 mA/cm² for 24 hours, according to the principles of the present disclosure;

FIG. 23 illustrates a schematic of an example of H-cell experiments with 1 mM PFOA and 0.5 M LiClO₄ in anolyte (A) in dry DMSO, with ¹⁹F NMR spectra of the anolyte (A) and catholyte (C) at 0 hours and at 24 hours, according to the principles of the present disclosure;

FIG. 24 illustrates XPS data for C Is for copper electrode in tetrabutylammonium (“TBA”)-based electrolyte and the lithium metal surface for PFOA degradation, according to the principles of the present disclosure;

FIG. 25 illustrates XPS data for F 1s for copper electrode in TBA-based electrolyte and the lithium metal surface for PFOA degradation, according to the principles of the present disclosure;

FIG. 26 illustrates XPS data for Li Is for copper electrode in TBA-based electrolyte and the lithium metal surface for PFOA degradation, according to the principles of the present disclosure;

FIG. 27 illustrates ¹⁹F NMR spectra before (0 hours) and after (24 hours) electrochemical degradation in presence of 0.5 M TBAClO₄ with 1 mM PFOA in DMSO, according to the principles of the present disclosure;

FIG. 28 illustrates a ¹⁹F NMR spectrum for electrodeposited lithium on a copper electrode surface washed with water after 24 hours in the presence of 0.5 M LiClO₄, according to the principles of the present disclosure;

FIG. 29A illustrates with ¹⁹F NMR showing the disappearance of PFOA peaks by lithium-mediated electroreduction (“LME”) for 1 mM PFOA ran for 30 h (inset shows zoomed region and absence of any PFOA peaks);

FIG. 29B illustrates ¹⁹F NMR spectra of different PFOA concentrations over 24 h of LME, trifluoroacetic acid (TFA) and lithium fluoride (LiF) are observed as degradation products;

FIG. 29C illustrates the degradation and defluorination efficiency data with changing initial PFOA concentration;

FIG. 30 illustrates an electrochemical voltage-transient profile under chronopotentiometric conditions for different applied current densities in DMSO with 1 mM PFOA and 0.5 M LiClO₄, according to the principles of the present disclosure;

FIG. 31 illustrates a plot of PFOA degradation over time, based on ¹⁹F NMR data, demonstrating the influence of varying current density on extent of PFOA degradation, according to the principles of the present disclosure;

FIG. 32 illustrates ¹⁹F NMR spectra demonstrating PFOA degradation after 24 hours at different current densities, including a selected region of the spectra at 50× magnification, according to the principles of the present disclosure;

FIG. 33 illustrates a plot of ln ([A/A₀]) over time where A₀ is starting PFOA concentration (1 mM) and A is PFOA concentration at time t for a degradation reaction carried out in DMSO at 50 mA/cm², according to the principles of the present disclosure;

FIG. 34 illustrates a plot of charged passed over time for varying applied current densities in DMSO with 1 mM PFOA and 0.5 M LiClO₄, according to the principles of the present disclosure;

FIG. 35 illustrates a plot of PFOA degradation based on ¹⁹F data for amount of charge passed at varying current densities, according to the principles of the present disclosure;

FIG. 36 illustrates a plot of potential over time for lithium electrodeposition with Pt as counter electrode, Cu as working electrode, and Ag as reference electrode, according to the principles of the present disclosure;

FIG. 37 illustrates 19NMR spectra for PFOA degradation with Pt counter electrode, with 1 mM PFOA and 0.5 M LiClO₄ at constant applied current density of 50 mA/cm² in DMSO, according to the principles of the present disclosure;

FIG. 38 illustrates a bar graph plot of percentage of PFOA degradation (based on ¹⁹F NMR data) and PFOA defluorination (calculated from fluoride ISE) for comparison of graphite rod (“GR”) to platinum wire (“Pt”) as counter electrode under conditions of 1 mM PFOA and 0.5 M LiClO₄ in DMSO, according to the principles of the present disclosure;

FIG. 39 illustrates a bar graph plot of percentage of PFOA degradation (based on ¹⁹F NMR data) and PFOA defluorination (calculated from fluoride ISE) for comparison of electrolytes, according to the principles of the present disclosure;

FIG. 40 illustrates a plot correlating PFOA degradation (based on ¹⁹F NMR data) and PFOA defluorination (calculated from fluoride ISE) to Coulombic efficiency for Li/Cu coin cells in various electrolytes and lithium salts at a capacity of 0.5 mAh/cm², according to the principles of the present disclosure;

FIG. 41 illustrates a scanning electron microscope (“SEM”) image of electrodeposited Li in DMSO at current density of 10 mA/cm², according to the principles of the present disclosure;

FIG. 42 illustrates a SEM image of electrodeposited Li in DMSO at current density of 30 mA/cm², according to the principles of the present disclosure;

FIG. 43 illustrates a SEM image of electrodeposited Li in DMSO at current density of 50 mA/cm², according to the principles of the present disclosure;

FIG. 44 illustrates a SEM image of electrodeposited Li at a current density of 50 mA/cm² in ethylene carbonate and diglyme (“EC:DG”) as electrolyte, according to the principles of the present disclosure;

FIG. 45 illustrates a SEM image of electrodeposited Li at a current density of 50 mA/cm² in ethylene carbonate and diethyl carbonate (“EC:DEC”) as electrolyte, according to the principles of the present disclosure;

FIG. 46 illustrates a SEM image of electrodeposited Li at a current density of 50 mA/cm² in propylene carbonate (“PC”) as electrolyte, according to the principles of the present disclosure;

FIG. 47 illustrates a schematic demonstrating degradation of PFOA near a lithium surface in DMSO liquid solvent and in the gas phase, as determined by DFT calculations, according to the principles of the present disclosure;

FIG. 48 illustrates calculated optimized representations of PFAS molecules in DMSO solvent;

FIG. 49 illustrates schematics of degradation of PFOA near a lithium surface in different implicit solvents and in the gas phase, as determined by DFT calculations, and a plot of charge transfer dynamics and PFOA degradation in various solvents and in the gas phase;

FIG. 50 shows the time-resolved evolution of C—F bond distances illustrating the stepwise defluorination of PFOA on a lithium surface under reductive conditions (atom numbering corresponds to the labeling scheme shown in FIG. 34);

FIG. 51 illustrates the spin density analysis confirming radical formation during C—F bond cleavage in PFOA degradation on lithium under reductive conditions, with yellow and cyan isosurfaces represent positive (0.003 e/Å³, excess α-spin) and negative (0.0005 e/Å³, excess β-spin) spin densities, respectively, indicating unpaired electron localization consistent with a radical-driven mechanism observed in Ab Initio Molecular Dynamics (“AIMD”) simulations;

FIG. 52 shows the time-dependent snapshots of representative trajectories showing the degradation mechanism of various C—F bonds in PFOA on a Li surface in DMSO solvent, as determined by AIMD simulations over a 0.025 and 0.0325 ps duration under applied positive and negative electric fields;

FIG. 53 is a plot showing the charge transfer dynamics (ΔQ(e)) from the Li surface in DMSO solvent, as determined by AIMD simulations over a 0.025 and 0.0325 ps duration under applied positive and negative electric fields, to a PFOA molecule and the percentage of PFOA degradation (i.e., % C—F bond breaking) at various simulation times;

FIG. 54 shows time-resolved snapshots from representative trajectories illustrate the degradation mechanism of various C—F bonds in PFOA on a Li surface in explicit DMSO solvent, as determined by AIMD simulations over durations of 0.025, 0.0325, and 0.055 ps under reductive conditions, the percentage of PFOA degradation (i.e., C—F bond cleavage) is shown;

FIG. 55 illustrates the mechanistic pathways for PFOA degradation on lithium surface promote C—F bond cleavage under oxidative conditions, as revealed by AIMD simulations;

FIG. 56 illustrates the spin density analysis confirming radical formation during C—F bond cleavage in PFOA degradation on lithium under oxidative conditions, with yellow and cyan isosurfaces represent positive (0.003 e/Å3, excess α-spin) and negative (0.001 e/Å3, excess β-spin) spin densities, respectively, indicating unpaired electron localization consistent with a radical-driven mechanism observed in AIMD simulations;

FIG. 57 illustrates ¹⁹F NMR spectra demonstrating electrochemical degradation of short alkyl chain PFASs at an applied current density of 50 mA/cm² in 1 mM LiTFA at 0 hours (bottom) and 24 hours (top) according to the principles of the present disclosure;

FIG. 58 illustrates ¹⁹F NMR spectra demonstrating electrochemical degradation of short alkyl chain PFASs at an applied current density of 50 mA/cm² in 1 mM GenX in DMSO with 0.5 M LiClO₄, according to the principles of the present disclosure;

FIG. 59 illustrates gas phase and solvent-optimized geometries for degradation of LiTFA onto a Li surface for the example of degradation illustrated in FIG. 57;

FIG. 60 illustrates time-dependent snapshots of various trajectories demonstrating degradation mechanisms of various C—F bonds in LiTFA on a lithium surface for the example of degradation illustrated in FIG. 57;

FIG. 61 illustrates a plot of the charge transfer dynamics from lithium surface to a LiTFA molecule and the percentage of PFOA degradation at various simulation times for the example of degradation illustrated in FIG. 57;

FIG. 62 illustrates gas phase and solvent-optimized geometries for degradation of GenX onto a Li surface for the example of degradation illustrated in FIG. 58;

FIG. 63 illustrates time-dependent snapshots of various trajectories demonstrating degradation mechanisms of various C—F bonds in GenX on a lithium surface for the example of degradation illustrated in FIG. 58;

FIG. 64 illustrates a plot of the charge transfer dynamics from lithium surface to a GenX molecule and the percentage of PFOA degradation at various simulation times for the example of degradation illustrated in FIG. 58;

FIG. 65 illustrates ¹⁹F NMR spectra demonstrating PFOA degradation after 24 hours at constant applied current density of 50 mA/cm² in DMSO with 2 M KClO₄, with Cu as working electrode, Pt as counter electrode, and Ag as reference electrode, according to the principles of the present disclosure;

FIG. 66 illustrates a 1H NMR spectrum for a reaction between commercial KF and ethane sulfonyl fluoride (“ESF”) with continuous stirring at 1500 rpm at room temperature after 2 days;

FIG. 67 illustrates a ¹⁹F NMR spectrum for the reaction illustrated in FIG. 66;

FIG. 68 illustrates a reaction scheme from mineralization of PFASs to separation of fluorides and valorization to non-PFAS product, according to the principles of the present disclosure;

FIG. 69 illustrates a ¹⁹F NMR spectrum in D₂O depicting KF separated from the DMSO mixture following the washing and ion exchange resin separation;

FIG. 70 illustrates 1H NMR spectra demonstrating the formation of ESF from ethane sulfonyl chloride (“ESC1”) from four hours (“4 h”) to 2 days (“2 D”); and

FIG. 71 illustrates a ¹⁹F NMR spectrum demonstrating formation of ESF after 2 days with internal standard of 2,2-difluoroethanol.

The drawings described herein are for illustration purposes only and are not intended to limit the scope of the present disclosure in any way.

### DETAILED DESCRIPTION

The following description is merely exemplary in nature and is not intended to limit the present disclosure, application, or uses.

The uses of the terms “a” and “an” and “the” and similar referents in the context of describing the present disclosure (especially in the context of the following claims) are to be construed to cover both the singular and the plural, unless otherwise indicated herein or clearly contradicted by context. The use of the term “plurality of” is defined by the Applicant in the broadest sense, superseding any other implied definitions or limitations hereinbefore or hereinafter unless expressly asserted by Applicant to the contrary, to mean a quantity of more than one. All methods described herein may be performed in any suitable order unless otherwise indicated herein by context.

As will be understood by one skilled in the art, for any and all purposes, all ranges recited herein also encompass any and all possible sub-ranges and combinations of sub-ranges thereof, as well as the individual values making up the range, particularly integer values. It is therefore understood that each unit between two particular units are also disclosed. For example, if 10 to 15 is disclosed, then 11, 12, 13, and 14 are also disclosed, individually, and as part of a range. A recited range (for example, weight percentages or carbon groups) includes each specific value, integer, decimal, or identity within the range. Any listed range may be easily recognized as sufficiently describing and enabling the same range being broken down into at least equal halves, thirds, quarters, fifths, or tenths. As will also be understood by one skilled in the art, all language such as “up to,” “at least,” “greater than,” “less than,” “more than,” “or more,” and the like, include the number recited and such terms refer to ranges that can be subsequently broken down into sub-ranges. In the same manner, all ratios recited herein also include all sub-ratios falling within the broader ratio. Accordingly, specific values recited also include all sub-ratios falling with the broader ratio. Accordingly, specific values recited for radicals, substituents, and ranges are for illustration only; they do not exclude other defined values or other values within defined ranges for radicals and substituents. It will be further understood that the endpoints of each of the ranges are significant both in relation to the other endpoint, and independently of the other endpoint.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of the members of a recited group. Accordingly, provisos may apply to any of the disclosed categories or examples whereby any one or more of the recited elements, species, or examples may be excluded from such categories or examples, for example, for use in an explicit negative limitation.

As used herein, the terms “comprise(s),” “include(s),” “having,” “has,” “can,” “contain(s),” and variants thereof, are intended to be open-ended transitional phrases, terms, or words that do not preclude the possibility of additional acts, structures, elements, or components. The present description also contemplates other embodiments “comprising,” “consisting of,” and “consisting essentially of” the examples or elements presented herein, whether explicitly set forth or not.

As used herein, the term “about,” when used in the context of a numerical value or range set forth means a variation of ±15%, or less, of the numerical value. For example, a value differing by ±15%, ±14%, ±10%, or ±5%, among others, would satisfy the definition of “about,” unless more narrowly defined in particular instances.

The term “alkyl,” by itself or as part of another substituent, refers, unless otherwise stated, to a straight, branched, or cyclic chain aliphatic hydrocarbon (“cycloalkyl”) monovalent radical having the number of carbon atoms designated (in other words, “C₁-C₈” means one to eight carbons, and includes C₂, C₃, C₄, C₅, C₆, and C₇). Examples include methyl, ethyl, propyl, isopropyl, cyclopropyl, butyl, isobutyl, sec-butyl, tert-butyl, cyclobutyl, methylcyclopropyl, cyclopropylmethyl, pentyl, neopentyl, hexyl, and cyclohexyl.

The term “alkoxy,” by itself or as part of another substituent, refers, unless otherwise stated, an alkyl group having the designated number of carbon atoms, as defined above, connected to the rest of a molecule via an oxygen atom, such as, for example, methoxy, ethoxy, 1-propoxy, 2-propoxy (“isopropoxy”), and the higher homologs and isomers.

Each of the terms “alkene” and “olefin,” by itself or as part of another substituent, refers unless otherwise stated, to a stable mono-unsaturated or di-unsaturated or poly-unsaturated straight chain, branched chain, or cyclic hydrocarbon (“cycloalkene”), “unsaturated” meaning a carbon-carbon double bond (—CH═CH—).

The term “alkenyl,” by itself or as part of another substituent, refers to a stable mono-unsaturated or di-unsaturated or poly-unsaturated straight chain, branched chain, or cyclic hydrocarbon monovalent radical having the number of carbon atoms designated. Examples may include vinyl, propenyl, allyl, crotyl, isopentenyl, butadienyl, 1,3-pentadienyl, 1,4-pentadienyl, cylopentenyl, cyclopentadienyl, and the higher homologs and isomers.

The term “aromatic” generally refers to a carbocycle or heterocycle having one or more polyunsaturated rings having aromatic character (in other words, having (4n+2) delocalized π (pi) electrons where n is an integer).

The term “aryl,” by itself or in combination with another substituent, refers, unless otherwise stated, to a carbocyclic aromatic system substituent containing one or more rings (typically one, two, or three rings), wherein such rings may be attached together in a pendant manner, such as biphenyl, or may be fused, such as naphthalene. Examples may include phenyl, benzyl, anthracyl, and naphthyl. Preferred are phenyl, benzyl, and naphthyl; most preferred are phenyl and benzyl.

The term “halogen,” by itself or as part of another substituent, refers, unless otherwise stated, to a monovalent fluorine, chlorine, bromine, or iodine atom.

The term “fluoro-substituted” refers to the substitution of one, more than one, or all hydrogens in a hydrocarbon or a monovalent hydrocarbon substituent with monovalent fluorine atoms.

Herein is described a process of reactive metal-assisted degradation via electroreduction (ReMADE) for the remediation of halogenated compounds. In an example, the process may occur at ambient temperature and pressure in a single-chamber electrochemical cell that may be free of membrane and catalyst. In certain examples, upon lithium metal electrodeposition, up to 95% PFOA degradation and 94% defluorination may be achieved, without formation of short chain PFAS compounds, and with mineralization to fluoride. In certain examples, the fluoride obtained may be used as a fluorine source for synthesis of non-PFAS fluorinated compounds (such as ethane sulfonyl fluoride, ESF). In certain examples, the degradation process may be performed in a solvent such as a sulfoxide, an ether, or a carbonate.

In an example, a sulfoxide may be a compound of formula (I):

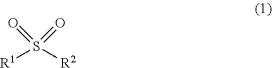

wherein each of R¹ and R² is independently selected from straight or branched (C₁-C₈)alkyl, (C₁-C₈) cycloalkyl, or aryl, or R¹ and R² together with the sulfur atom to which R¹ and R² are bonded form a heterocyclic ring.

Examples of sulfoxides may include dimethyl sulfoxide, methyl phenyl sulfoxide, and diphenyl sulfoxide.

In an example, an ether may be a compound of formula (II):

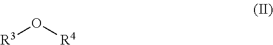

wherein each of R³ and R⁴ is independently selected from a substituted or unsubstituted straight or branched (C₁-C₈)alkyl, substituted or unsubstituted (C₁-C₈) cycloalkyl, substituted or unsubstituted straight or branched (C₁-C₈)alkenyl, or aryl, or R³ and R⁴ together with the oxygen atom to which R³ and R⁴ are bonded form a heterocyclic ring; and wherein the substituted (C₁-C₈)alkyl, substituted (C₁-C₈) cycloalkyl, or substituted (C₁-C₈)alkenyl are substituted with one or more alkoxy group substituents.

Examples of ethers may include diglyme.

In an example, a carbonate may be a compound of formula (III):

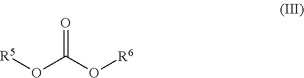

wherein each of R³ and R⁶ is independently selected from straight or branched (C₁-C₈)alkyl, (C₁-C₈) cycloalkyl, or aryl, or R⁵ and R⁶ together with the oxygen atoms to which each of R⁵ and R⁶ are bonded form a heterocyclic ring.

Examples of carbonates may include diphenyl carbonate, ethylene carbonate, trimethylene carbonate, propylene carbonate, dimethyl carbonate, and diethyl carbonate.

In an example, a concentration of a PFAS in a solvent may be from about 0.1 mM to about 5.0 mM, including, for example, from about 0.2 mM, or from about 0.3 mM, or from about 0.4 mM, or from about 0.5 mM, or from about 0.6 mM, or from about 0.7 mM, or from about 0.8 mM, or from about 0.9 mM, or from about 1.0 mM, or from about 1.1 mM, or from about 1.2 mM, or from about 1.3 mM, or from about 1.4 mM, or from about 1.5 mM, or from about 1.6 mM, or from about 1.7 mM, or from about 1.8 mM, or from about 1.9 mM, or from about 2.0 mM, or from about 2.1 mM, or from about 2.2 mM, or from about 2.3 mM, or from about 2.4 mM, or from about 2.5 mM, or from about 2.6 mM, or from about 2.7 mM, or from about 2.8 mM, or from about 2.9 mM, or from about 3.0 mM, or from about 3.1 mM, or from about 3.2 mM, or from about 3.3 mM, or from about 3.4 mM, or from about 3.5 mM, or from about 3.6 mM, or from about 3.7 mM, or from about 3.8 mM, or from about 3.9 mM, or from about 4.0 mM, or from about 4.1 mM, or from about 4.2 mM, or from about 4.3 mM, or from about 4.4 mM, or from about 4.5 mM, or from about 4.6 mM, or from about 4.7 mM, or from about 4.8 mM, or from about 4.9 mM; or to about 0.2 mM, or to about 0.3 mM, or to about 0.4 mM, or to about 0.5 mM, or to about 0.6 mM, or to about 0.7 mM, or to about 0.8 mM, or to about 0.9 mM, or to about 1.0 mM, or to about 1.1 mM, or to about 1.2 mM, or to about 1.3 mM, or to about 1.4 mM, or to about 1.5 mM, or to about 1.6 mM, or to about 1.7 mM, or to about 1.8 mM, or to about 1.9 mM, or to about 2.0 mM, or to about 2.1 mM, or to about 2.2 mM, or to about 2.3 mM, or to about 2.4 mM, or to about 2.5 mM, or to about 2.6 mM, or to about 2.7 mM, or to about 2.8 mM, or to about 2.9 mM, or to about 3.0 mM, or to about 3.1 mM, or to about 3.2 mM, or to about 3.3 mM, or to about 3.4 mM, or to about 3.5 mM, or to about 3.6 mM, or to about 3.7 mM, or to about 3.8 mM, or to about 3.9 mM, or to about 4.0 mM, or to about 4.1 mM, or to about 4.2 mM, or to about 4.3 mM, or to about 4.4 mM, or to about 4.5 mM, or to about 4.6 mM, or to about 4.7 mM, or to about 4.8 mM, or to about 4.9 mM; or a range formed from any two of the foregoing concentrations, including any subranges therebetween. Examples of PFASs may include:

| | |
|---|---|
| 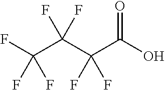 [SMILES: O=C(O)C(F)(F)C(F)(F)C(F)(F)F] | Chemical Abstracts Service (“CAS”) No. 375-22-4 |
| perfluorobutanoic acid (“PFBA”); | |
| 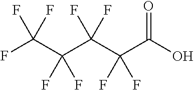 [SMILES: O=C(O)C(F)(F)C(F)(F)C(F)(F)C(F)(F)F] | CAS No. 2706-90-3 |
| perfluoropentanoic acid (“PFPeA”); | |
| 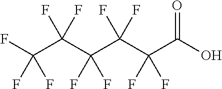 [SMILES: O=C(O)C(F)(F)C(F)(F)C(F)(F)C(F)(F)C(F)(F)F] | CAS No. 307-24-4 |
| perfluorohexanoic acid (“PFHxA”) | |
| 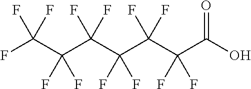 [SMILES: O=C(O)C(F)(F)C(F)(F)C(F)(F)C(F)(F)C(F)(F)C(F)(F)F] | CAS No. 375-85-9 |
| perfluoroheptanoic acid (“PFHpA”); | |
| 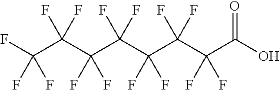 [SMILES: O=C(O)C(F)(F)C(F)(F)C(F)(F)C(F)(F)C(F)(F)C(F)(F)C(F)(F)F] | CAS No. 335-67-1 |
| perfluorooctanoic acid (“PFOA”); | |
| 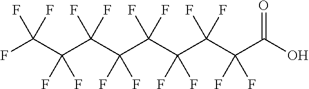 [SMILES: O=C(O)C(F)(F)C(F)(F)C(F)(F)C(F)(F)C(F)(F)C(F)(F)C(F)(F)C(F)(F)F] | CAS No. 375-95-1 |
| perfluorononanoic acid (“PFNA”); | |
| 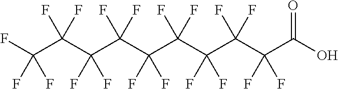 [SMILES: O=C(O)C(F)(F)C(F)(F)C(F)(F)C(F)(F)C(F)(F)C(F)(F)C(F)(F)C(F)(F)C(F)(F)F] | CAS No. 335-76-2 |
| perfluorodecanoic acid (“PFDA”); | |
| 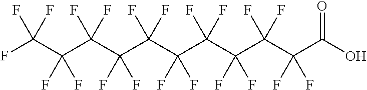 [SMILES: O=C(O)C(F)(F)C(F)(F)C(F)(F)C(F)(F)C(F)(F)C(F)(F)C(F)(F)C(F)(F)C(F)(F)C(F)(F)F] | CAS No. 2058-94-8 |
| perfluoroundecanoic acid (“PFUnA”); | |
| 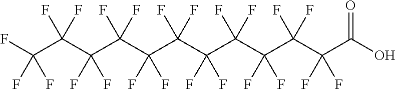 [SMILES: O=C(O)C(F)(F)C(F)(F)C(F)(F)C(F)(F)C(F)(F)C(F)(F)C(F)(F)C(F)(F)C(F)(F)C(F)(F)C(F)(F)F] | CAS No. 307-55-1 |
| perfluorododecanoic acid (“PFDoA”); | |
| 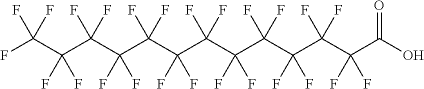 [SMILES: O=C(O)C(F)(F)C(F)(F)C(F)(F)C(F)(F)C(F)(F)C(F)(F)C(F)(F)C(F)(F)C(F)(F)C(F)(F)C(F)(F)C(F)(F)F] | CAS No. 72629-94-8 |
| perfluorotridecanoic acid (“PFTriA”); | |
| 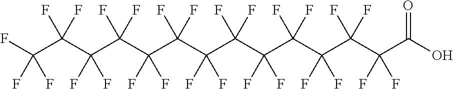 [SMILES: O=C(O)C(F)(F)C(F)(F)C(F)(F)C(F)(F)C(F)(F)C(F)(F)C(F)(F)C(F)(F)C(F)(F)C(F)(F)C(F)(F)C(F)(F)C(F)(F)F] | CAS No. 376-06-7 |
| perfluorotetradecanoic acid (“PFTeA”); | |
| 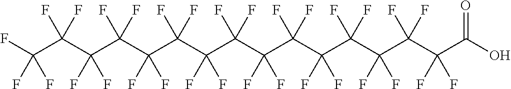 [SMILES: O=C(O)C(F)(F)C(F)(F)C(F)(F)C(F)(F)C(F)(F)C(F)(F)C(F)(F)C(F)(F)C(F)(F)C(F)(F)C(F)(F)C(F)(F)C(F)(F)C(F)(F)C(F)(F)F] | CAS No. 67905-19-5 |
| perfluoro-n-hexadecanoic acid (“PFHxDA”); | |
| 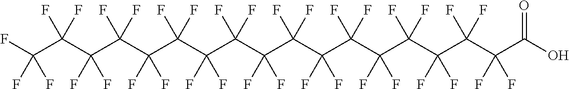 [SMILES: O=C(O)C(F)(F)C(F)(F)C(F)(F)C(F)(F)C(F)(F)C(F)(F)C(F)(F)C(F)(F)C(F)(F)C(F)(F)C(F)(F)C(F)(F)C(F)(F)C(F)(F)C(F)(F)C(F)(F)C(F)(F)F] | CAS No. 16517-11-6 |
| perfluorooctadecanoic acid (“PFODA”); | |
| 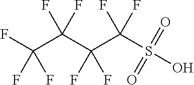 [SMILES: O=S(=O)(O)C(F)(F)C(F)(F)C(F)(F)C(F)(F)F] | CAS No. 375-73-5 |
| perfluorobutanesulfonic acid (“PFBS”); | |
| 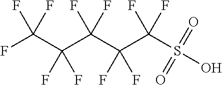 [SMILES: O=S(=O)(O)C(F)(F)C(F)(F)C(F)(F)C(F)(F)C(F)(F)F] | CAS No. 2706-91-4 |
| perfluoropentanesulfonic acid (“PFPeS”); | |
| 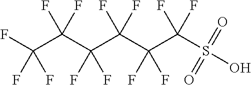 [SMILES: O=S(=O)(O)C(F)(F)C(F)(F)C(F)(F)C(F)(F)C(F)(F)C(F)(F)F] | CAS No. 355-46-4 |
| perfluorohexanesulfonic acid (“PFHxS”); | |
| 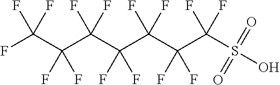 [SMILES: O=S(=O)(O)C(F)(F)C(F)(F)C(F)(F)C(F)(F)C(F)(F)C(F)(F)C(F)(F)F] | CAS No. 375-92-8 |
| perfluoroheptanesulfonic acid (“PFHpS”); | |
| 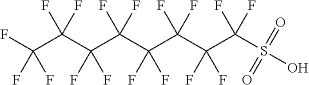 [SMILES: O=S(=O)(O)C(F)(F)C(F)(F)C(F)(F)C(F)(F)C(F)(F)C(F)(F)C(F)(F)C(F)(F)F] | CAS No. 1763-23-1 |
| perfluorooctanesulfonic acid (“PFOS”); | |
| 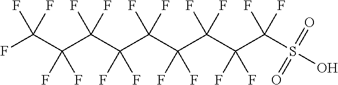 [SMILES: O=S(=O)(O)C(F)(F)C(F)(F)C(F)(F)C(F)(F)C(F)(F)C(F)(F)C(F)(F)C(F)(F)C(F)(F)F] | CAS No. 68259-12-1 |
| perfluorononanesulfonic acid (“PFNS”); | |
| 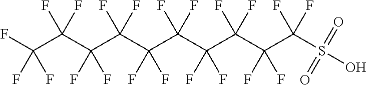 [SMILES: O=S(=O)(O)C(F)(F)C(F)(F)C(F)(F)C(F)(F)C(F)(F)C(F)(F)C(F)(F)C(F)(F)C(F)(F)C(F)(F)F] | CAS No. 335-77-3 |
| perfluorodecanesulfonic acid (“PFDS”); | |
| 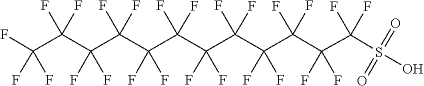 [SMILES: O=S(=O)(O)C(F)(F)C(F)(F)C(F)(F)C(F)(F)C(F)(F)C(F)(F)C(F)(F)C(F)(F)C(F)(F)C(F)(F)C(F)(F)C(F)(F)F] | CAS No. 79780-39-5 |
| perfluorododecanesulfonic acid (“PFDoS”); | |
| 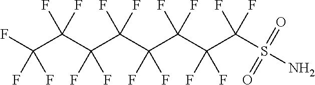 [SMILES: NS(=O)(=O)C(F)(F)C(F)(F)C(F)(F)C(F)(F)C(F)(F)C(F)(F)C(F)(F)C(F)(F)F] | CAS No. 754-91-6 |
| perfluorooctanesulfonamide (“PFOSA”); | |
| 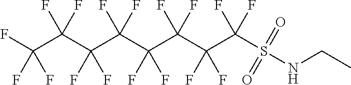 [SMILES: CCNS(=O)(=O)C(F)(F)C(F)(F)C(F)(F)C(F)(F)C(F)(F)C(F)(F)C(F)(F)C(F)(F)F] | CAS No. 4151-50-2 |
| N-ethyl-1,1,2,2,3,3,4,4,5,5,6,6,7,7,8,8,8-heptadecafluorooctane-1- | |
| sulfonamide (“NEtFOSA”); | |
| 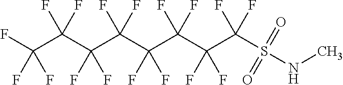 [SMILES: CNS(=O)(=O)C(F)(F)C(F)(F)C(F)(F)C(F)(F)C(F)(F)C(F)(F)C(F)(F)C(F)(F)F] | CAS No. 31506-32-8 |
| N-methyl-1,1,2,2,3,3,4,4,5,5,6,6,7,7,8,8,8-heptadecafluorooctane- | |
| 1-sulfonamide (“NMeFOSA”); | |
| 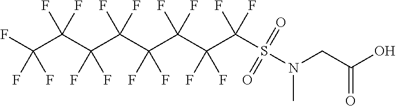 [SMILES: CN(CC(=O)O)S(=O)(=O)C(F)(F)C(F)(F)C(F)(F)C(F)(F)C(F)(F)C(F)(F)C(F)(F)C(F)(F)F] | CAS No. 2355-31-9 |
| 2-[1,1,2,2,3,3,4,4,5,5,6,6,7,7,8,8,8- | |
| heptadecafluorooctylsulfonyl(methyl)amino]acetic acid | |
| (“NMeFOSAA”); | |
| 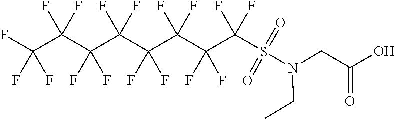 [SMILES: CCN(CC(=O)O)S(=O)(=O)C(F)(F)C(F)(F)C(F)(F)C(F)(F)C(F)(F)C(F)(F)C(F)(F)C(F)(F)F] | CAS No. 2991-50-6 |
| 2-[1,1,2,2,3,3,4,4,5,5,6,6,7,7,8,8,8- | |
| heptadecafluorooctylsulfonyl(ethyl)amino]acetic acid | |
| (“NEtFOSAA”); | |
| 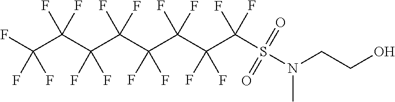 [SMILES: CN(CCO)S(=O)(=O)C(F)(F)C(F)(F)C(F)(F)C(F)(F)C(F)(F)C(F)(F)C(F)(F)C(F)(F)F] | CAS No. 24448-09-7 |
| 1,1,2,2,3,3,4,4,5,5,6,6,7,7,8,8,8-heptadecafluoro-N-(2- | |
| hydroxyethyl)-N-methyloctane-1-sulfonamide (“NMeFOSE”); | |
| 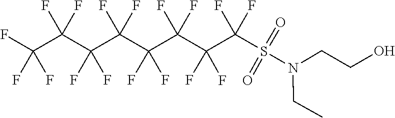 [SMILES: CCN(CCO)S(=O)(=O)C(F)(F)C(F)(F)C(F)(F)C(F)(F)C(F)(F)C(F)(F)C(F)(F)C(F)(F)F] | CAS No. 1691-99-2 |
| 1,1,2,2,3,3,4,4,5,5,6,6,7,7,8,8,8-heptadecafluoro-N-ethyl-N-(2- | |
| hydroxyethyl)-octane-1-sulfonamide (“NEtFOSE”); | |
| 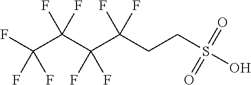 [SMILES: O=S(=O)(O)CCC(F)(F)C(F)(F)C(F)(F)C(F)(F)F] | CAS No. 757124-72-4 |
| 3,3,4,4,5,5,6,6,6-nonafluorohexane-1-sulfonic acid (“4:2 FTS”); | |
| 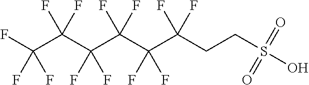 [SMILES: O=S(=O)(O)CCC(F)(F)C(F)(F)C(F)(F)C(F)(F)C(F)(F)C(F)(F)F] | CAS No. 27619-97-2 |
| 3,3,4,4,5,5,6,6,7,7,8,8,8-tridecafluorooctane-1-sulfonic acid | |
| (“6:2 FTS”); | |
| 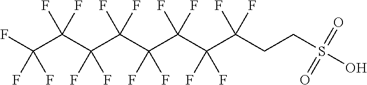 [SMILES: O=S(=O)(O)CCC(F)(F)C(F)(F)C(F)(F)C(F)(F)C(F)(F)C(F)(F)C(F)(F)C(F)(F)F] | CAS No. 39108-34-4 |
| 3,3,4,4,5,5,6,6,7,7,8,8,9,9,10,10,10-heptadecafluorodecane-1- | |
| sulfonic acid (“8:2 FTS”); | |
| 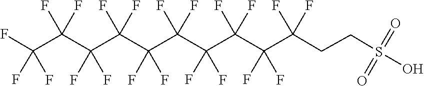 [SMILES: O=S(=O)(O)CCC(F)(F)C(F)(F)C(F)(F)C(F)(F)C(F)(F)C(F)(F)C(F)(F)C(F)(F)C(F)(F)C(F)(F)F] | CAS No. 120226-60-0 |
| 3,3,4,4,5,5,6,6,7,7,8,8,9,9,10,10,11,11,12,12,12- | |
| henicosafluorododecane-1-sulfonic acid (“10:2 FTS”); | |
| 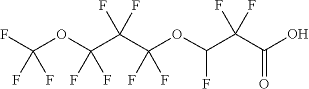 [SMILES: O=C(O)C(F)(F)C(F)OC(F)(F)C(F)(F)C(F)(F)OC(F)(F)F] | CAS No. 919005-14-4 |
| 2,2,3-trifluoro-3-[1,1,2,2,3,3-hexafluoro-3- | |
| (trifluoromethoxy)propoxy]propanoic acid (“DONA”); | |
| 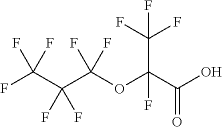 [SMILES: O=C(O)C(F)(OC(F)(F)C(F)(F)C(F)(F)F)C(F)(F)F] | CAS No. 13252-13-6 |
| 2,3,3,3-tetrafluoro-2-(1,1,2,2,3,3,3-heptafluoropropoxy)propanoic | |
| acid (“HFPO-DA” or “Gen-X”); | |
| 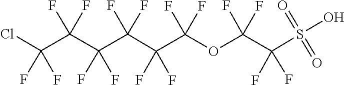 [SMILES: O=S(=O)(O)C(F)(F)C(F)(F)OC(F)(F)C(F)(F)C(F)(F)C(F)(F)C(F)(F)C(F)(F)Cl] | CAS No. 756426-58-1 |
| 2-(6-chloro-1,1,2,2,3,3,4,4,5,5,6,6-dodecafluorohexoxy)-1,1,2,2- | |
| tetrafluoroethanesulfonic acid (“F-53B Major”); | |
| 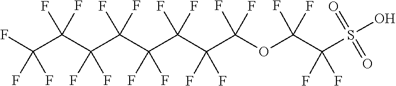 [SMILES: O=S(=O)(O)C(F)(F)C(F)(F)OC(F)(F)C(F)(F)C(F)(F)C(F)(F)C(F)(F)C(F)(F)C(F)(F)C(F)(F)F] | CAS No. 763051-92-9 |
| 2-(8-chloro-1,1,2,2,3,3,4,4,5,5,6,6,7,7,8,8-hexadecafluorooctoxy)- | |
| 1,1,2,2-tetrafluoroethanesulfonic acid (“F-53B Minor”); | |
| 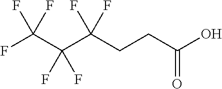 [SMILES: O=C(O)CCC(F)(F)C(F)(F)C(F)(F)F] | CAS No. 356-02-5 |
| 4,4,5,5,6,6,6-heptafluorohexanoic acid (“3:3 FTCA”); | |
| 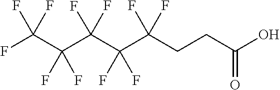 [SMILES: O=C(O)CCC(F)(F)C(F)(F)C(F)(F)C(F)(F)C(F)(F)F] | CAS No. 914637-49-3 |
| 4,4,5,5,6,6,7,7,8,8,8-undecafluorooctanoic acid (“5:3 FTCA”); | |
| 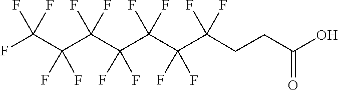 [SMILES: O=C(O)CCC(F)(F)C(F)(F)C(F)(F)C(F)(F)C(F)(F)C(F)(F)C(F)(F)F] | CAS No. 812-70-4 |
| 4,4,5,5,6,6,7,7,8,8,9,9,10,10,10-pentadecafluorodecanoic acid | |
| (“7:3 FTCA”); | |
| 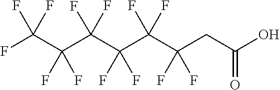 [SMILES: O=C(O)CC(F)(F)C(F)(F)C(F)(F)C(F)(F)C(F)(F)C(F)(F)F] | CAS No. 53826-12-3 |
| 3,3,4,4,5,5,6,6,7,7,8,8,8-tridecafluorooctanoic acid (“6:2 FTCA”); | |
| 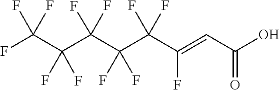 [SMILES: O=C(O)/C=C(\F)C(F)(F)C(F)(F)C(F)(F)C(F)(F)C(F)(F)F] | CAS No. 70887-88-6 |
| 3,4,4,5,5,6,6,7,7,8,8,8-dodecafluorooct-2-enoic acid (“6:2 | |
| FTUCA”); | |
| 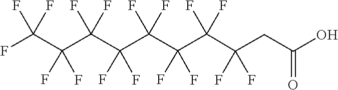 [SMILES: O=C(O)CC(F)(F)C(F)(F)C(F)(F)C(F)(F)C(F)(F)C(F)(F)C(F)(F)C(F)(F)F] | CAS No. 27854-31-5 |
| 3,3,4,4,5,5,6,6,7,7,8,8,9,9,10,10,10-heptadecafluorodecanoic acid | |
| (“8:2 FTCA”); | |
| 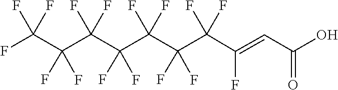 [SMILES: O=C(O)/C=C(\F)C(F)(F)C(F)(F)C(F)(F)C(F)(F)C(F)(F)C(F)(F)C(F)(F)F] | CAS No. 70887-84-2 |
| 3,4,4,5,5,6,6,7,7,8,8,9,9,10,10,10-hexadecafluorodec-2-enoic acid | |
| (“8:2 FTUCA”); | |
| 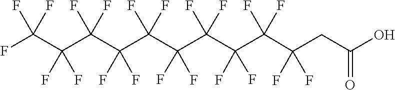 [SMILES: O=C(O)CC(F)(F)C(F)(F)C(F)(F)C(F)(F)C(F)(F)C(F)(F)C(F)(F)C(F)(F)C(F)(F)C(F)(F)F] | CAS No. 53826-13-4 |
| 3,3,4,4,5,5,6,6,7,7,8,8,9,9,10,10,11,11,12,12,12- | |
| henicosafluorododecanoic acid (“10:2 FTCA”); | |
| 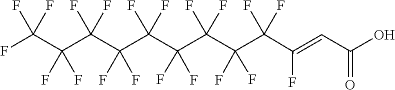 [SMILES: O=C(O)/C=C(\F)C(F)(F)C(F)(F)C(F)(F)C(F)(F)C(F)(F)C(F)(F)C(F)(F)C(F)(F)C(F)(F)F] | CAS No. 70887-94-4 |
| (Z)-3,4,4,5,5,6,6,7,7,8,8,9,9,10,10,11,11,12,12,12- | |
| icosafluorododec-2-enoic acid (“10:2 FTUCA”); | |
| 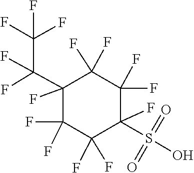 [SMILES: O=S(=O)(O)C1(F)C(F)(F)C(F)(F)C(F)(C(F)(F)C(F)(F)F)C(F)(F)C1(F)F] | CAS No. 133201-07-7 |
| perfluoro(4-perfluoroethyl)cyclohexanesulfonic acid | |
| (“PFECHS”); | |
| 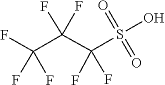 [SMILES: O=S(=O)(O)C(F)(F)C(F)(F)C(F)(F)F] | CAS No. 423-41-6 |
| 1,1,2,2,3,3,3-heptafluoropropane-1-sulfonic acid (“PFPrS”); | |
| 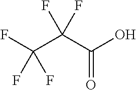 | CAS No. 422-64-0 |
| 2,2,3,3,3-pentafluoropropanoic acid (“PFPrA”); | |
| 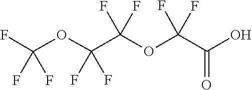 [SMILES: O=C(O)C(F)(F)OC(F)(F)C(F)(F)OC(F)(F)F] | CAS No. 151772-58-6 |
| 2,2-difluoro-2-[1,1,2,2-tetrafluoro-2- | |
| (trifluoromethoxy)ethoxy]acetic acid (“NFDHA”); | |
| 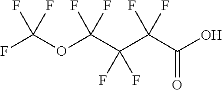 [SMILES: O=C(O)C(F)(F)C(F)(F)C(F)(F)OC(F)(F)F] | CAS No. 863090-89-5 |
| 2,2,3,3,4,4-hexafluoro-4-(trifluoromethoxy)butanoic acid | |
| (“PFMBA”); | |
| 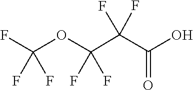 [SMILES: O=C(O)C(F)(F)C(F)(F)OC(F)(F)F] | CAS No. 377-73-1 |
| 2,2,3,3-tetrafluoro-3-(trifluoromethoxy)propanoic acid | |
| (“PFMPA”); | |
| 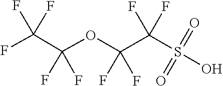 [SMILES: O=S(=O)(O)C(F)(F)C(F)(F)OC(F)(F)C(F)(F)F] | CAS No. 113507-82-7 |
| 1,1,2,2-tetrafluoro-2-(perfluoroethoxy)ethanesulfonic acid | |
| (“PFEESA”); | |
| 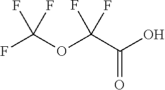 [SMILES: O=C(O)C(F)(F)OC(F)(F)F] | CAS No. 674-13-5 |
| 2,2-difluoro-2-(trifluoromethoxy)acetic acid (“PFMOAA”); | |
| 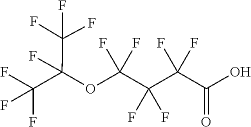 [SMILES: O=C(O)C(F)(F)C(F)(F)C(F)(F)OC(F)(C(F)(F)F)C(F)(F)F] | CAS No. 801212-59-9 |
| perfluoro-4-isopropoxybutanoic acid (“PFECA G”); | |
| 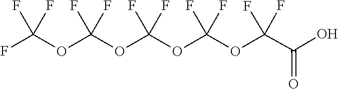 [SMILES: O=C(O)C(F)(F)OC(F)(F)OC(F)(F)OC(F)(F)OC(F)(F)F] | CAS No. 39492-90-5 |
| perfluoro-3,5,7,9-butaoxadecanoic acid (“PFO4DA”); | |
| 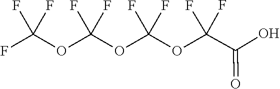 [SMILES: O=C(O)C(F)(F)OC(F)(F)OC(F)(F)OC(F)(F)F] | CAS No. 39492-89-2 |
| perfluoro-3,5,7-trioxaoctanoic acid (“PFO3OA”); | |
| 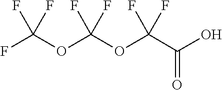 [SMILES: O=C(O)C(F)(F)OC(F)(F)OC(F)(F)F] | CAS No. 39492-88-1 |
| perfluoro-3,5-dioxahexanoic acid (“PFO2HxA”); | |
| 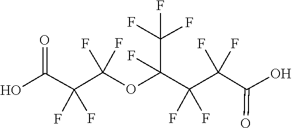 [SMILES: O=C(O)C(F)(F)C(F)(F)OC(F)(C(F)(F)F)C(F)(F)C(F)(F)C(=O)O] | CAS No. 2416366-22-6 |
| 4-(2-carboxy-1,1,2,2-tetrafluoroethoxy)-perfluoropentanoic acid | |
| (“R-EVE”); | |
| 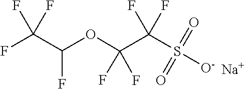 [SMILES: O=S(=O)([O-])C(F)(F)C(F)(F)OC(F)C(F)(F)F ; [Na+]] | CAS No. 1132933-86-8 |
| sodium 1,1,2,2-tetrafluoro-2-(1,2,2,2- | |
| tetrafluoroethoxy)ethanesulfonate (“NVOHS”); | |
| 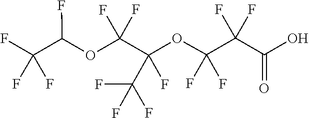 [SMILES: O=C(O)C(F)(F)C(F)(F)OC(F)(C(F)(F)F)C(F)(F)OC(F)C(F)(F)F] | CAS No. 773804-62-9 |
| 2,2,3,3-tetrafluoro-3-{[1,1,1,2,3,3-hexafluoro-3-(1,2,2,2- | |
| tetrafluoroethoxy)propan-2-yl]oxy)propanoic acid (“Hydro-EVE Acid”); | |
| 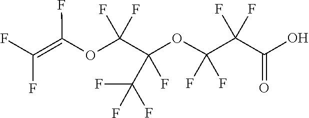 [SMILES: O=C(O)C(F)(F)C(F)(F)OC(F)(C(F)(F)F)C(F)(F)OC(F)=C(F)F] | CAS No. 69087-46-3 |
| 2,2,3,3-tetrafluoro-3-[1,1,1,2,3,3]hexafluoro-3-(1,2,2- | |
| trifluoroethenoxy)propan-2-yl]oxypropanoic acid (“EVE Acid”); | |
| 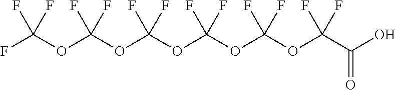 [SMILES: O=C(O)C(F)(F)OC(F)(F)OC(F)(F)OC(F)(F)OC(F)(F)OC(F)(F)F] | CAS No. 39492-91-6 |
| perfluoro-3,5,7,9,11-pentaoxadodecanoic acid (“PFO5DA”); | |
| 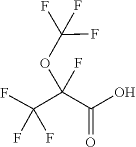 [SMILES: O=C(O)C(F)(OC(F)(F)F)C(F)(F)F] | CAS No. 13140-29-9 |
| 2,3,3,3-tetrafluoro-2-(trifluoromethoxy)propanoic acid | |
| (“PMPA”); | |
| 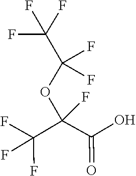 [SMILES: O=C(O)C(F)(OC(F)(F)C(F)(F)F)C(F)(F)F] | CAS No. 267239-61-2 |
| 2,3,3,3-tetrafluoro-2-(pentafluoroethoxy)propanoic acid | |
| (“PEPA”); | |
| 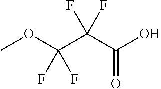 | CAS No. 93449-21-9 |
| 2,2,3,3-tetrafluoro-3-methoxy-propanoic acid (“MTP”); | |
| 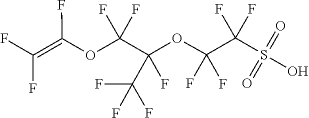 [SMILES: O=S(=O)(O)C(F)(F)C(F)(F)OC(F)(C(F)(F)F)C(F)(F)OC(F)=C(F)F] | CAS No. 29311-67-9 |
| 1,1,2,2-tetrafluoro-2-[1,1,1,2,3,3-hexafluoro-3-(1,2,2- | |
| trifluoroethenoxy)propan-2-yl]oxyethanesulfonic acid | |
| (“PS Acid”); | |
| 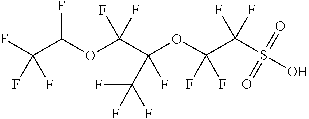 [SMILES: O=S(=O)(O)C(F)(F)C(F)(F)OC(F)(C(F)(F)F)C(F)(F)OC(F)C(F)(F)F] | CAS No. 2416366-18-0 |
| 1,1,2,2-tetrafluoro-2-[1,1,1,2,3,3-hexafluoro-3-(1,2,2,2- | |
| tetrafluoroethoxy)propan-2-yl]oxyethanesulfonic acid | |
| (“Hydro-PS Acid”); | |
| 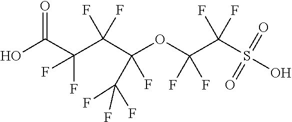 [SMILES: O=C(O)C(F)(F)C(F)(F)C(F)(OC(F)(F)C(F)(F)S(=O)(=O)O)C(F)(F)F] | CAS No. 2416366-18-0 |
| 2,2,3,3,4,5,5,5-4-(1,1,2,2-tetrafluoro-2-sulfoethoxy)pentanoic acid | |
| (“R-PSDA”); | |
| 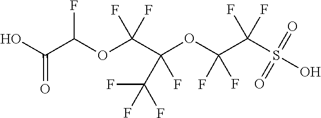 [SMILES: O=C(O)C(F)OC(F)(F)C(F)(OC(F)(F)C(F)(F)S(=O)(=O)O)C(F)(F)F] | CAS No. 2416366-19-1 |
| 2-fluoro-2-[1,1,2,3,3,3-hexafluoro-2-(1,1,2,2-tetrafluoro-2- | |
| sulfoethoxy)propoxy]acetic acid (“Hydrolyzed PSDA”); | |
| 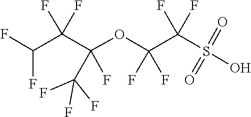 [SMILES: O=S(=O)(O)C(F)(F)C(F)(F)OC(F)(C(F)(F)F)C(F)(F)C(F)F] | CAS No. 2416366-21-5 |
| 1,1,2,2-tetrafluoro-2-[(1,1,1,2,3,3,4,4-octafluorobutan-2- | |
| yl)oxy]ethane-1-sulfonic acid (“R-PSDCA”); | |
| 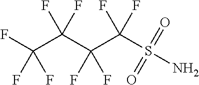 [SMILES: NS(=O)(=O)C(F)(F)C(F)(F)C(F)(F)C(F)(F)F] | CAS No. 30334-69-1 |
| 1,1,2,2,3,3,4,4,4-nonafluorobutane-1-sulfonamide (“FBSA”); | |
| 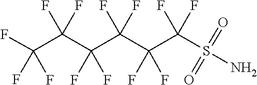 [SMILES: NS(=O)(=O)C(F)(F)C(F)(F)C(F)(F)C(F)(F)C(F)(F)C(F)(F)F] | CAS No. 41997-13-1 |
| 1,1,2,2,3,3,4,4,5,5,6,6,6-tridecafluorohexane-1-sulfonamide | |
| (“FHxSA”); | |
| 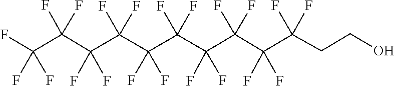 [SMILES: OCCC(F)(F)C(F)(F)C(F)(F)C(F)(F)C(F)(F)C(F)(F)C(F)(F)C(F)(F)C(F)(F)C(F)(F)F] | CAS No. 865-86-1 |
| 3,3,4,4,5,5,6,6,7,7,8,8,9,9,10,10,11,11,12,12,12- | |
| henicosafluorododecan-1-ol (“10:2 FTOH”); | |
| 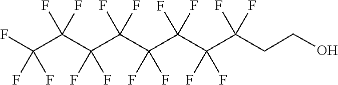 [SMILES: OCCC(F)(F)C(F)(F)C(F)(F)C(F)(F)C(F)(F)C(F)(F)C(F)(F)C(F)(F)F] | CAS No. 678-39-7 |
| 3,3,4,4,5,5,6,6,7,7,8,8,9,9,10,10,10-heptadecafluorodecan-1-ol | |
| (“8:2 FTOH”); | |
| 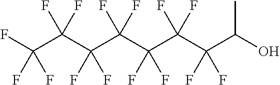 [SMILES: CC(O)C(F)(F)C(F)(F)C(F)(F)C(F)(F)C(F)(F)C(F)(F)C(F)(F)F] | CAS No. 24015-83-6 |
| 3,3,4,4,5,5,6,6,7,7,8,8,9,9,9-pentadecafluorononan-2-ol | |
| (“7:2 FTOH”); | |
| 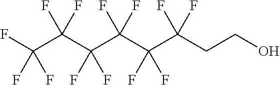 [SMILES: OCCC(F)(F)C(F)(F)C(F)(F)C(F)(F)C(F)(F)C(F)(F)F] | CAS No. 647-42-7 |
| 3,3,4,4,5,5,6,6,7,7,8,8,8-tridecafluorooctan-1-ol | |
| (“6:2 FTOH”); | |
| 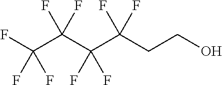 [SMILES: OCCC(F)(F)C(F)(F)C(F)(F)C(F)(F)F] | CAS No. 2043-47-2 |
| 3,3,4,4,5,5,6,6,6-nonafluorohexan-1-ol (“4:2 FTOH”); | |
| 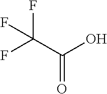 | CAS No. 76-05-1 |
| trifluoroacetic acid (“TFA”); | |
| 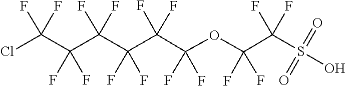 [SMILES: O=S(=O)(O)C(F)(F)C(F)(F)OC(F)(F)C(F)(F)C(F)(F)C(F)(F)C(F)(F)C(F)(F)Cl] | CAS No. 73606-19-6 |
| 9-chlorohexadecafluoro-3-oxanonane-1-sulfonic acid | |
| (“9Cl-PF3ONS”); | |
| 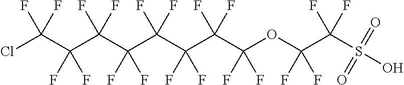 [SMILES: O=S(=O)(O)C(F)(F)C(F)(F)OC(F)(F)C(F)(F)C(F)(F)C(F)(F)C(F)(F)C(F)(F)C(F)(F)C(F)(F)Cl] | CAS No. 763051-92-9 |
| 11-chloroeicosafluoro-3-oxaundecane-1-sulfonic acid (“11Cl- | |
| PF3OUDS”); | |
| and any combination thereof. | |

Examples of ionic compounds may include a cation of an alkali metal or an alkaline earth metal. Alkali metals include lithium (Li), sodium (Na), potassium (K), rubidium (Rb), cesium (Cs), and francium (Fr). Alkaline earth metals include beryllium (Be), magnesium (Mg), calcium (Ca), strontium (Sr), barium (Ba), and radium (Ra). Examples of ionic compounds may include an anion such as nitrate or perchlorate.

In an example of an electrochemical cell of the present disclosure, an applied current density may be in a value of from about 1 mA/cm² to about 1000 mA/cm², including, for example, from about 2 mA/cm², or from about 3 mA/cm², or from about 4 mA/cm², or from about 5 mA/cm², or from about 6 mA/cm², or from about 7 mA/cm², or from about 8 mA/cm², or from about 9 mA/cm², or from about 10 mA/cm², or from about 11 mA/cm², or from about 12 mA/cm², or from about 13 mA/cm², or from about 14 mA/cm², or from about 15 mA/cm², or from about 16 mA/cm², or from about 17 mA/cm², or from about 18 mA/cm², or from about 19 mA/cm², or from about 20 mA/cm², or from about 21 mA/cm², or from about 22 mA/cm², or from about 23 mA/cm², or from about 24 mA/cm², or from about 25 mA/cm², or from about 26 mA/cm², or from about 27 mA/cm², or from about 28 mA/cm², or from about 29 mA/cm², or from about 30 mA/cm², or from about 31 mA/cm², or from about 32 mA/cm², or from about 33 mA/cm², or from about 34 mA/cm², or from about 35 mA/cm², or from about 36 mA/cm², or from about 37 mA/cm², or from about 38 mA/cm², or from about 39 mA/cm², or from about 40 mA/cm², or from about 41 mA/cm², or from about 42 mA/cm², or from about 43 mA/cm², or from about 44 mA/cm², or from about 45 mA/cm², or from about 46 mA/cm², or from about 47 mA/cm², or from about 48 mA/cm², or from about 49 mA/cm², or from about 50 mA/cm², or from about 55 mA/cm², or from about 60 mA/cm², or from about 65 mA/cm², or from about 70 mA/cm², or from about 75 mA/cm², or from about 80 mA/cm², or from about 85 mA/cm², or from about 90 mA/cm², or from about 95 mA/cm², or from about 100 mA/cm², or from about 110 mA/cm², or from about 120 mA/cm², or from about 130 mA/cm², or from about 140 mA/cm², or from about 150 mA/cm², or from about 160 mA/cm², or from about 170 mA/cm², or from about 180 mA/cm², or from about 190 mA/cm², or from about 200 mA/cm², or from about 225 mA/cm², or from about 250 mA/cm², or from about 275 mA/cm², or from about 300 mA/cm², or from about 325 mA/cm², or from about 350 mA/cm², or from about 375 mA/cm², or from about 400 mA/cm², or from about 425 mA/cm², or from about 450 mA/cm², or from about 475 mA/cm², or from about 500 mA/cm², or from about 525 mA/cm², or from about 550 mA/cm², or from about 575 mA/cm², or from about 600 mA/cm², or from about 625 mA/cm², or from about 650 mA/cm², or from about 675 mA/cm², or from about 700 mA/cm², or from about 725 mA/cm², or from about 750 mA/cm², or from about 775 mA/cm², or from about 800 mA/cm², or from about 825 mA/cm², or from about 850 mA/cm², or from about 875 mA/cm², or from about 900 mA/cm², or from about 925 mA/cm², or from about 950 mA/cm², or from about 975 mA/cm²; or to about 2 mA/cm², or to about 3 mA/cm², or to about 4 mA/cm², or to about 5 mA/cm², or to about 6 mA/cm², or to about 7 mA/cm², or to about 8 mA/cm², or to about 9 mA/cm², or to about 10 mA/cm², 11 mA/cm², or to about 12 mA/cm², or to 13 about mA/cm², or to about 14 mA/cm², or to about 15 mA/cm², or to about 16 mA/cm², or to about 17 mA/cm², or to about 18 mA/cm², or to about 19 mA/cm², or to about 20 mA/cm², or to about 21 mA/cm², or to about 22 mA/cm², or to about 23 mA/cm², or to about 24 mA/cm², or to about 25 mA/cm², or to about 26 mA/cm², or to about 27 mA/cm², or to about 28 mA/cm², or to about 29 mA/cm², or to about 30 mA/cm², or to about 31 mA/cm², or to about 32 mA/cm², or to about 33 mA/cm², or to about 34 mA/cm², or to about 35 mA/cm², or to about 36 mA/cm², or to about 37 mA/cm², or to about 38 mA/cm², or to about 39 mA/cm², or to about 40 mA/cm², or to about 41 mA/cm², or to about 42 mA/cm², or to about 43 mA/cm², or to about 44 mA/cm², or to about 45 mA/cm², or to about 46 mA/cm², or to about 47 mA/cm², or to about 48 mA/cm², or to about 49 mA/cm²; or to about 50 mA/cm², or to about 55 mA/cm², or to about 60 mA/cm², or to about 65 mA/cm², or to about 70 mA/cm², or to about 75 mA/cm², or to about 80 mA/cm², or to about 85 mA/cm², or to about 90 ma/cm², or to about 95 mA/cm², or to about 100 mA/cm², or to about 110 mA/cm², or to about 120 mA/cm², or to about 130 mA/cm², or to about 140 mA/cm², or to about 150 mA/cm², or to about 160 mA/cm², or to about 170 mA/cm², or to about 180 mA/cm², or to about 190 mA/cm², or to about 200 mA/cm², or to about 225 mA/cm², or to about 250 mA/cm², or to about 275 mA/cm², or to about 300 mA/cm², or to about 325 mA/cm², or to about 350 mA/cm², or to about 375 mA/cm², or to about 400 mA/cm², or to about 425 mA/cm², or to about 450 mA/cm², or to about 475 mA/cm², or to about 500 mA/cm², or to about 525 mA/cm², or to about 550 mA/cm², or to about 575 mA/cm², or to about 600 mA/cm², or to about 625 mA/cm², or to about 650 mA/cm², or to about 675 mA/cm², or to about 700 mA/cm², or to about 725 mA/cm², or to about 750 mA/cm², or to about 775 mA/cm², or to about 800 mA/cm², or to about 825 mA/cm², or to about 850 mA/cm², or to about 875 mA/cm², or to about 900 mA/cm², or to about 925 mA/cm², or to about 950 mA/cm², or to about 975 mA/cm², or a range formed from any two of the foregoing current densities, including any subranges therebetween.

In an example, the present disclosure provides a method for degrading a halogenated compound, including: applying a current density to a working electrode, the working electrode in contact with a nonaqueous solution of an ionic compound and the halogenated compound in an organic solvent to provide a product solution comprising fluoride anion.

In certain examples, the ionic compound includes a cation of an alkali metal or an alkaline earth metal.

In certain examples, the ionic compound includes a lithium cation.

In certain examples, the ionic compound comprises a nitrate or a perchlorate anion.

In certain examples, the halogenated compound is a poly- or perfluoroalkyl substance.

In certain examples, the organic solvent is a sulfoxide, an ether, or a carbonate.

In certain examples, the organic solvent is dimethyl sulfoxide.

In certain examples, the applying is in the presence of a positive electric field.

In certain examples, the halogenated compound is at least 90% defluorinated.

In certain examples, the method for degrading a halogenated compound includes, after the applying, isolating fluoride anion from the product solution and/or an electrode in contact with the solution.

In certain examples, the method for degrading a halogenated compound includes reacting the fluoride anion with another reagent to produce a compound that is not poly- or perfluorinated.

The compositions and processes described above may be better understood in connection with the following Examples. In addition, the following non-limiting examples are an illustration. The illustrated methods are applicable to other examples of the present disclosure. The procedures described as general methods describe what is believed will be typically effective to prepare the compositions indicated. However, the person skilled in the art will appreciate that it may be necessary to vary the procedures for any given example of the present disclosure, for example, vary the order or steps and/or the chemical reagents used.

### EXAMPLES

### I. Introduction

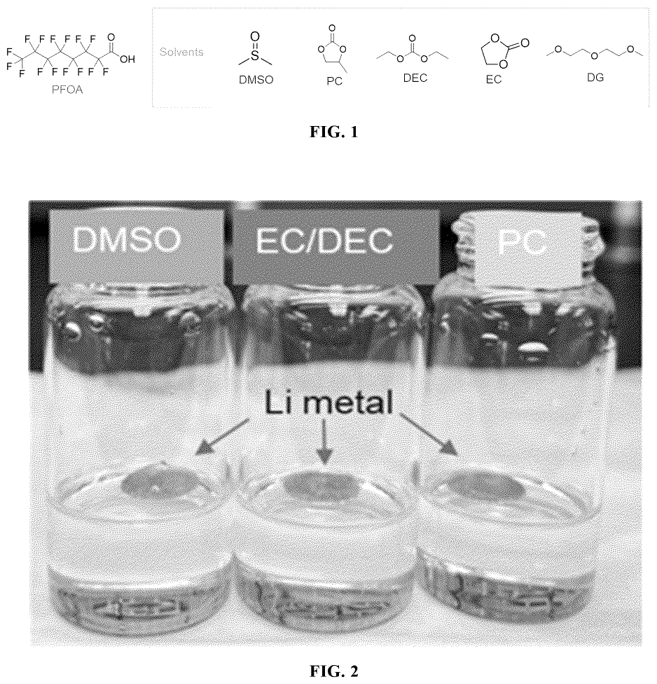

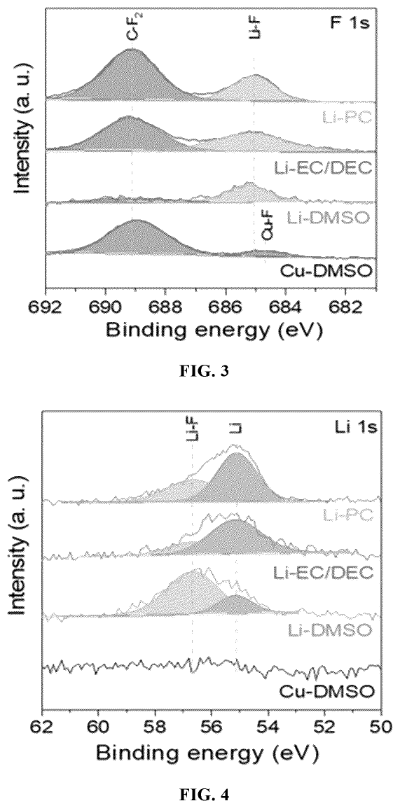

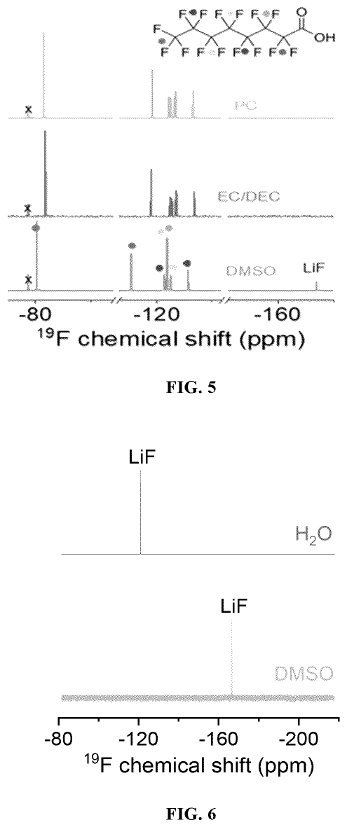

The reactivity of metals such as lithium toward PFASs was studied chemically. Lithium metal was added to a solution containing 10 mM of dissolved PFOA. As FIG. 1 illustrates, solvents such as dimethyl sulfoxide, ethers, and carbonates were used as nonaqueous solvents to determine reactivity. After 24 hours of exposure of lithium metal to PFOA in the various solvents, as illustrated in FIG. 2, the lithium surface was analyzed using XPS. Across all solvents analyzed, mineralization of the PFOA to LiF was observed as illustrated in the plots of XPS data in FIGS. 3 and 4. A Cu foil was also analyzed in DMSO as a control that demonstrated the presence of C—F₂ and Cu—F peaks, indicating the interactions were arising by residual PFOA on the surface of the foil. Residual PFOA was also observed at the lithium surface for the carbonate-based solvents. For DMSO, a much higher fraction of LiF was observed. The supernatant was also studied using ¹⁹F solution NMR, as illustrated in FIG. 5. The fluoride peak was assigned at 166.6 ppm following a spectrum of LiF in DMSO control as illustrated in FIG. 6. No small-chain fluorinated compounds were observed. The combination of XPS and NMR data demonstrated conclusively that reactive metals such as lithium may degrade PFOA and mineralize the fluorine to fluoride. Because new lithium metal surface would always be needed, there is a need for an electrochemical process for the PFAS degradation.

### II. Materials

Perfluorooctanoic acid (95%), lithium perchlorate (99%), dimethyl sulfoxide (“DMSO,” anhydrous, 99.9%), ethylene carbonate (anhydrous, 98%), diglyme (anhydrous, 99.5%), diethyl carbonate (99.9%), propylene carbonate (anhydrous, 99%), and 4 Å molecular sieves were purchased from Sigma-Aldrich. HFPO-DA (95%) was purchased from Combi blocks, and LiTFA (97%) from Thermo Scientific. Tetrabutylammonium perchlorate (99%) was purchased form Alfa Aesar. Ethane sulfonyl chloride (>98% purity) was purchased from TCI. Deuterated DMSO (≥99.8 atom % D) was purchased from Cambridge Isotope Laboratories. The different solvents were dried and stored with 4 Å molecular sieves overnight inside an Ar-filled glovebox (VigorTech, O₂ and H₂O<1 ppm). All the PFASs and salts used were vacuum dried overnight before transferring to the glovebox. The Cu working electrode (0.28 cm², 99.99%) was purchased from McMaster-Carr and designed by taking the polycrystalline Cu rod and mounted into a PTFE tube. Ag/AgCl reference electrodes were purchased from eDAQ, and graphite rod counter-electrode was purchased from Sigma-Aldrich.

### III. Methods

### A. Electrochemical Characterization

All electrochemical characterizations were carried out using a Bio-Logic VSP-300 potentiostat inside an Ar-filled glovebox, utilizing a typical three-electrode propylene cell. The setup included a Cu rod (0.28 cm²) as the working electrode, a leakless Ag/AgCl as the reference electrode, and a graphite rod as the counter electrode at room temperature. The working electrode was soaked in a 0.1 M aqueous sulfuric acid solution for 30 minutes to remove any organic contaminants and passivation layer and then polished on a cloth pad with alumina suspension, rinsed with Milli-Q water (18.4 MQ·cm), and sonicated for 15 minutes. Chronopotentiometry (“CP”) experiments were conducted at a constant applied current density ranging from 10 to 50 mA/cm² for 24 hours at room temperature with magnetic stirring at 400 rpm. The initial PFOA concentration was 1 mM with 0.5 M LiClO₄ or TBAClO₄ in 5 mL of DMSO, unless otherwise specified.

### B. Nuclear Magnetic Resonance (“NMR”)

NMR spectra were recorded on a Bruker Ascend instrument (400 MHz) using a capillary setup inside a Wilmad NMR tube. An internal standard (2 mM LiTFSI) in deuterated DMSO was placed inside a capillary tube and capped with a PTFE cover. For analysis, 400 μL of the sample was used, and the capillary with the internal standard in DMSO-d₆ was added.

### C. X-Ray Photoelectron Spectroscopy (“XPS”)

All the XPS measurements were carried out using the Physical Electronics, PHI 5000 VersaProbe II System equipped with an A1 Ka radiation (hν=1486.6 eV) beam (100 μm, 25 W). Cu foil (0.5*6 cm²) was used as the working electrode for investigating XPS, which is masked with tape to have an exposed surface area of 0.5*0.5 cm² immersed in the electrolyte. The electrodeposition of Li was performed inside an Ar-filled glovebox. After electrodeposition, the area with Li deposition on the foil is cut and rinsed three times with dimethoxyethane (“DME”) and transferred to a glass vial. The foil was dried in a glovebox antechamber for 30 minutes under vacuum to get rid of any residual solvent. The data was fitted using CasaXPS software with C—C peak in C Is referenced at 284.8 eV.

### D. Scanning Electron Microscopy (“SEM”)

SEM images were taken on a Carl Zeiss Merlin field emission SEM with an accelerating voltage of 15 kV. Cu foil was used as the working electrode to deposit Li. The deposition capacity for all of the samples was fixed to 2 mAh/cm². After electrodeposition, the samples were washed with DME three times, transferred into a vial, and moved to the glovebox antechamber for drying.

### E. Ion Chromatography (“IC”)

A Shimadzu LC-20Ai IC system consisting of a conductivity detector (CDD-10AVP) was used to obtain all ion chromatograms. A 10-μL sample was injected into the column using an autosampler (SIL-20AC). Separations were carried out on an analytical column (Shodex IC NI-424, anion-specific) coupled with a guard column (Shodex IC IA-G). The column was maintained at 40° C., with a run time of 20 minutes. For optimal peak separation of various anions, two mobile phases were utilized. The first mobile phase consisted of 8 mM 4-hydroxybenzoic acid, 1.9 mM Bis-Tris, 2 mM phenylboronic acid, and 0.005 mM trans-1,2-diaminocyclohexane-N,N,N′,N′-tetraacetic acid in aqueous solution. The second mobile phase was identical, except for the exclusion of Bis-Tris. Data collection and processing were performed using the LabSolutions software.

### F. Gas Chromatography Mass Spectrometry (“GCMS”)

A Shimadzu GCMS-QP2020 NX single quadrupole mass spectrometer, equipped with an HS-20 Headspace autosampler, was employed to analyze post-degradation samples. Separation was achieved using an SH-Q-BOND column (30 m×0.32 mm×10 μm) with helium as the carrier gas. The detector temperature was maintained at 40° C., and 1 mL of undiluted sample was used for analysis.

### G. Liquid Chromatography Mass Spectrometry (“LCMS”)

LCMS data was collected using a Shimadzu Nexera LC-40DXR UHPLC coupled with a LCMS-2050 single quadrupole detector. Separation was carried out with two mobile phases: mobile phase A consisted of acetonitrile, while mobile phase B was 5 mM aqueous ammonium acetate. A Shimadzu Nexcol C18 column (1.8 μm, 50×2.1 mm) was used for the separation, with an Agilent Eclipse Plus C18 guard column (1.8 μm, 3× 5 mm). The column temperature was maintained at 40° C. Samples were diluted to a total volume of 500 μL using a 1:1 mixture of water and acetonitrile, with 5 μL of injection volume for each run.

### IV. Electrochemical Degradation of PFASs

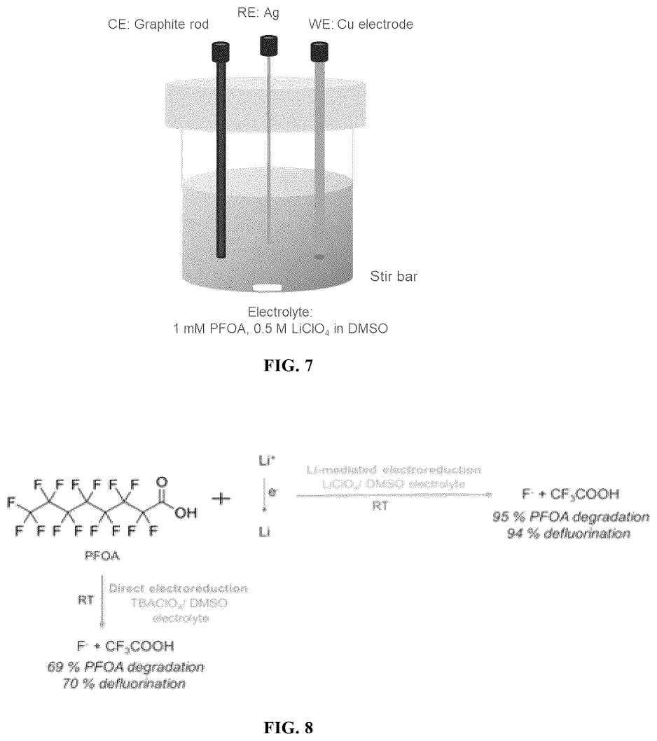

An electrochemical process was developed at ambient temperature and pressure to enhance PFAS degradation. As FIG. 7 illustrates, the electrochemical cell includes an organic solvent, a dissolved salt, a Cu working electrode, a Pt or graphite counter electrode, and an Ag/Ag⁺ leakless reference electrode. Non-fluorinated salts such as LiClO₄ and LiNO₃ were analyzed. These salts limit the type of solvents that may be explored to ensure sufficient salt dissolution and high ionic conductivity. A range of solvents listed in Table 1 were explored and compositions that yielded ionic conductivities>3 mS/cm were analyzed.

TABLE 1

| | | | | Selected for | |
|---|---|---|---|---|---|
| | | Conductivity | Boiling | PFAS | |
| Solvent | Salt | (mS/cm) | Point (° C.) | Degradation | Remarks |
| DMSO | 0.5M | 4.5 | 189 | Yes | High |
| | LiClO₄ | | | | conductivity |
| DMSO | 0.5M | 6.2 | 189 | Yes | High |
| | LiNO₃ | | | | conductivity |
| DMSO | 2M | 8.2 | 189 | Yes | High |
| | KClO₄ | | | | conductivity |
| Diglyme | 0.5M | 0.3 | 162 | No | Low |
| | LiNO₃ | | | | conductivity |
| Tetraglyme | 0.5M | 0.1 | 275 | No | Low |
| | LiNO₃ | | | | conductivity |
| 1,2- | 0.5M | 2.6 | 85 | No | Low |
| dimethoxyethane | LiClO₄ | | | | conductivity |
| | | | | | and boiling |
| | | | | | point |
| 1,3-dioxolane | 0.5M | 0.1 | 165 | No | Low |
| | LiClO₄ | | | | conductivity |
| Propylene | 0.5M | 3.5 | 242 | Yes | High |
| carbonate | LiClO₄ | | | | conductivity |
| EC:DEC (1:1) | 0.5M | 4.6 | 125.8 | Yes | High |
| | LiClO₄ | | | | conductivity |
| EC:diglyme | 0.5M | 2.5 | 162 | No | Low |
| | LiNO₃ | | | | conductivity |
| EC:diglyme | 0.5M | 6.2 | 162 | Yes | High |
| | LiClO₄ | | | | conductivity |
| EC:tetraglyme | 0.5M | 1.2 | 275 | No | Low |
| | LiNO₃ | | | | conductivity |

Tetrabutylammonium perchlorate (“TBAClO₄”) was used to ascertain the impact of the applied potential and current density by electroreduction (“DE”) without the presence of lithium. Using a current density of 50 mA/cm² with a catalyst-free Cu working electrode, significant degradation of PFOA (1 mM) and mineralization to fluoride ion was observed at ambient conditions.

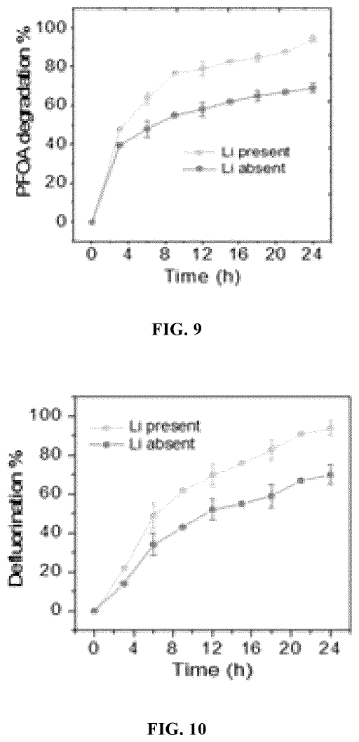

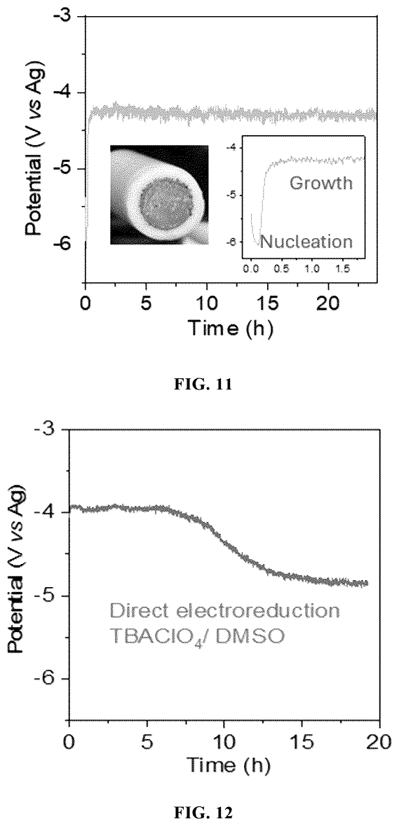

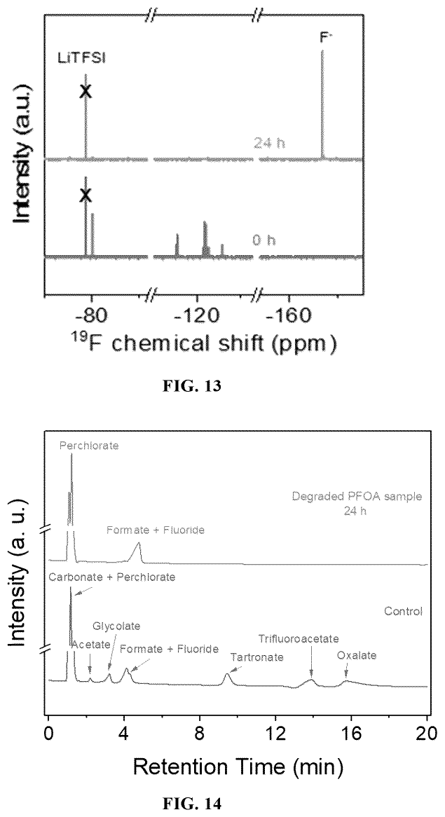

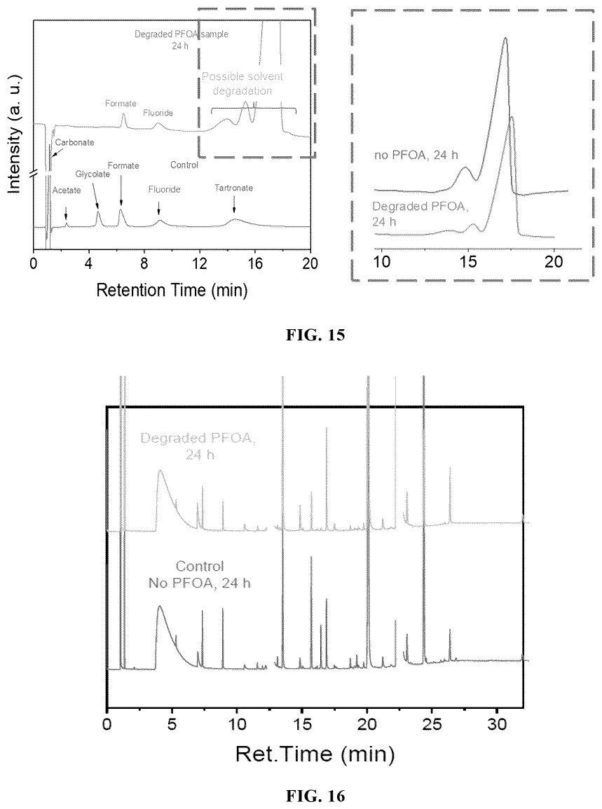

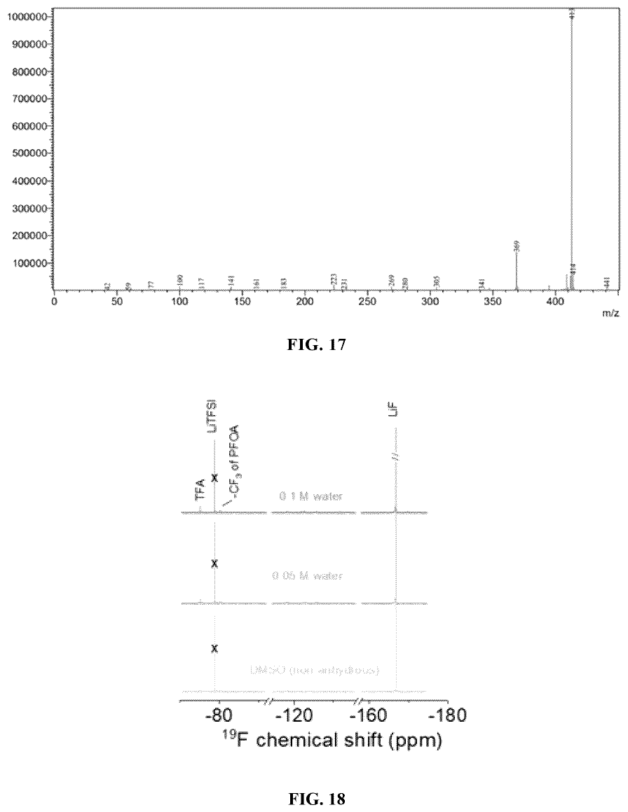

When LiClO₄ was added as the salt and lithium metal was allowed to deposit, the degradation process was significantly enhanced by lithium-mediated electroreduction (LME), as illustrated in FIGS. 8-10. FIGS. 11 and 12 illustrate that lithium metal was electrodeposited as a shiny luster. The electrochemical profile illustrated in FIG. 12 demonstrated the nucleation and growth overpotentials associated with lithium metal electrodeposition. As the ¹⁹F spectrum in FIG. 13 illustrates, almost all of the PFOA (1 mM) is converted to fluoride. The degradation increases to 95% for PFOA and defluorination conversion to 94%, as illustrated in FIGS. 9 and 10, respectively. Minute concentrations of trifluoroacetate were observed. Ion chromatography analysis illustrated formate as another degradation product, with no other detectable products, according to FIGS. 14-17.

A single-chamber, membrane less cell was used for simplicity. To probe the reaction sensitivity, control experiments were conducted under less stringent conditions outside the glovebox (exposed to air) and introduced water into the electrolyte. As shown in Table 2 and FIG. 18, the LME is successful in degrading PFOA, albeit at slightly lower efficiencies. These results ensure the robustness of the method.

TABLE 2

| | Water content | Water content | | |
|---|---|---|---|---|
| | initial, t = 0 h | final, t = 24 h | Degradation | Defluorination |
| Solvent | (ppm) | (ppm) | % | % |
| Non-anhydrous | 140.7 | 10085.2 | 90.2 | 86.4 |
| DMSO (kept | | | | |
| outside GB) | | | | |
| DMSO + 0.05M | 946.8 | 10774.0 | 88.9 | 79.2 |
| water | | | | |
| DMSO + 0.1M | 1803.4 | 10880.4 | 87.7 | 75.2 |
| water | | | | |

In Table 2, the solvents tested with added water and the respective PFOA degradation and defluorination efficiencies are included. The degradation % is calculated from ¹⁹F NMR and defluorination % by using fluoride ISE (ion selective electrode).

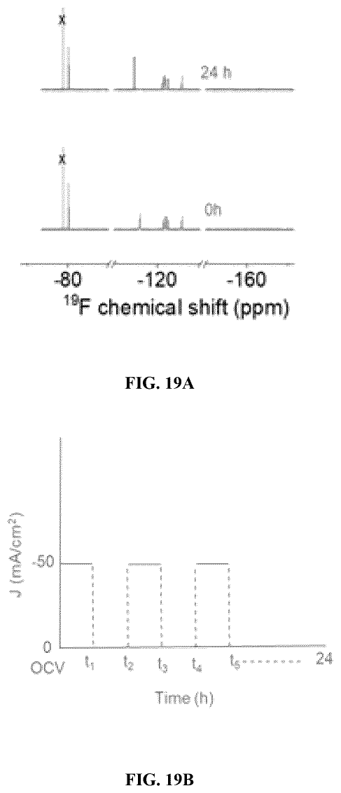

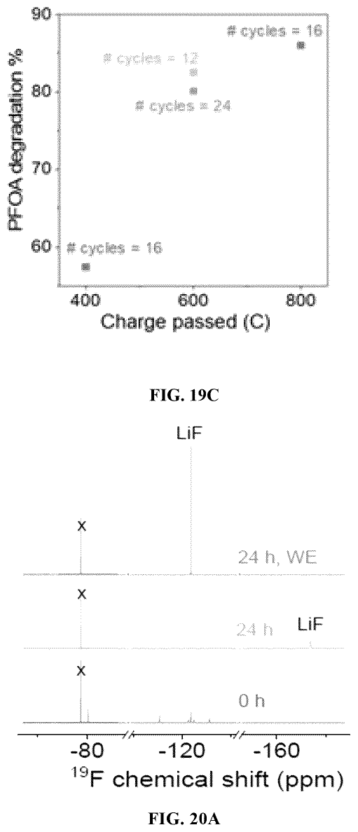

To investigate the role of the current applied, control experiments were carried out where Li was electrodeposited without PFOA, followed by PFOA addition without applying current. After 24 hours, only ~4% degradation was observed with no fluoride peak in the ¹⁹F NMR, it was believed the limited surface area might limit degradation. Hence, continuous electrodeposition to generate fresh Li surface, as well as the applied current, is essential for degradation (FIGS. 19A-19C).

To further probe the role of reductive conditions, the number of deposition (current-on) and rest (current-off) cycles were varied, where each cycle represents fresh Li exposure, and the total charge passed corresponds to the reductive conditions. As shown in FIGS. 19A-19C and Table 3, PFOA degradation correlates with total charge rather than cycle number, confirming that the reaction is driven by reductive conditions.

TABLE 3

| | | | | Total deposition | Charge | |
|---|---|---|---|---|---|---|
| Experiment | Deposition | Rest | No of | time after 24 h | passed | Degradation |
| No. | time (h) | time (h) | cycles | (h) | (C) | % |
| 1 | 0.5 | 1 | 16 | 8 | 400 | 57.4 |
| 2 | 1 | 1 | 12 | 12 | 600 | 82.5 |
| 3 | 0.5 | 0.5 | 24 | 12 | 600 | 80.1 |
| 4 | 1 | 0.5 | 16 | 16 | 800 | 86 |

In Table 3, the reaction parameters for the control “deposition and rest” experiments are shown. Deposition times, tₙ (n=1, 3, 5, . . . ) and resting times, tₙ+1 vary for each experiment (number 1 to 4). For example, for experiment #1, each deposition step lasts 0.5 h followed by a 1 h rest period, then t₁=0.5 h, t₂=1.5 h, t₃=2 h, t₄=3 h, t₅=3.5 h and so on. For experiment #2, each deposition step lasts 1 h followed by a 1 h rest period, then t₁=1 h, t₂=2 h, t₃=3 h, t₄=4 h, t₅=5 h and so on.

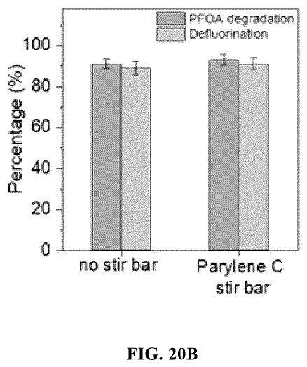

To demonstrate that PFOA was the sole source of fluorine in the reaction, the reaction was conducted in the absence of any other potential fluorine sources, such as PTFE stir bars or Teflon-coated electrodes but with parylene C coated stainless steel stir bars. FIG. 20A illustrates the degradation of PFOA and the formation of LiF both in the electrolyte and on the electrode surface, confirming that PFOA degradation was the exclusive source of fluoride ions. The data in FIG. 20B showed that the degradation of PFOA and the formation of LiF both in the electrolyte and on the electrode surface arose primarily from the degradation of the added PFAS and not affected by any extraneous fluorine source.

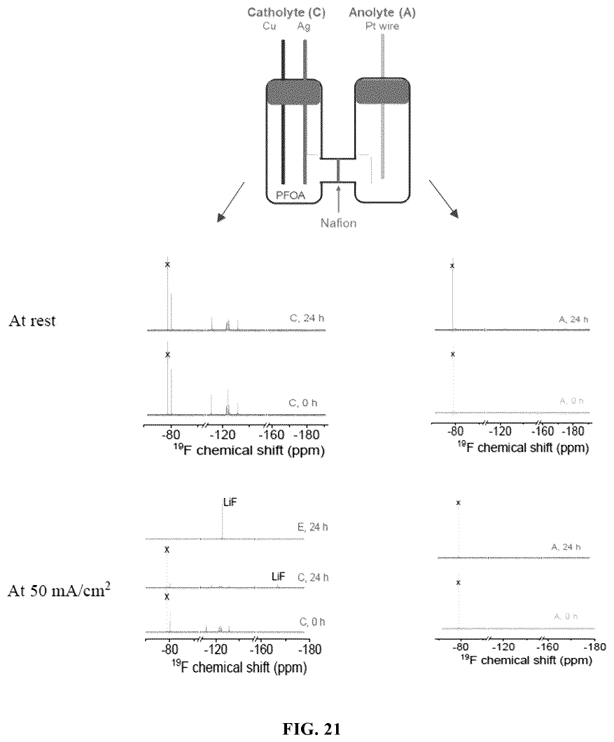

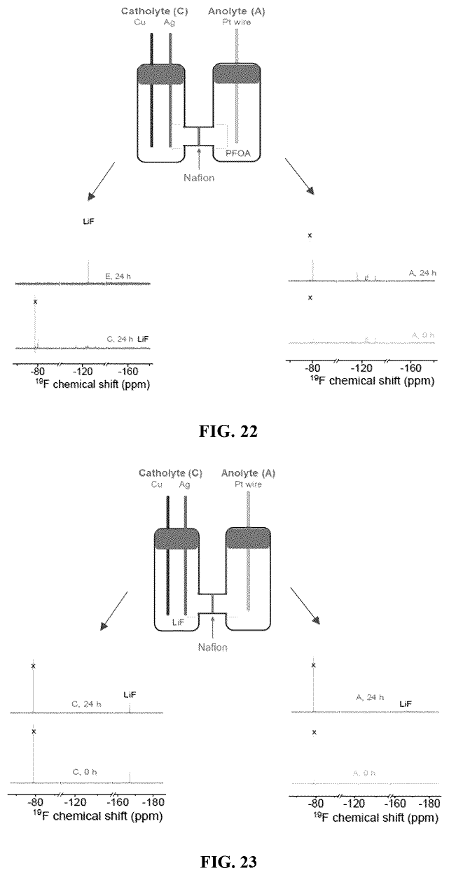

To demonstrate clearly that the lithium metal and the reductive process leads to PFAS degradation rather than any oxidation process, an H-cell was fabricated. The H-Cell included a Nafion cation exchange membrane to segregate the catholyte and anolyte chambers. FIGS. 21-23 illustrate that the Nafion membrane may substantially limit PFOA and LiF crossover. When PFOA was added to the catholyte chamber, fluoride ion was readily observed. However, when PFOA was added to the anolyte chamber, fluoride ion was not observed in the anolyte chamber, but only again in the catholyte chamber due to suspected PFOA crossover and degradation in the catholyte chamber. Regardless of whether PFOA was added to the catholyte or anolyte, LiF was observed on the surface of the working electrode, indicating that PFOA interacts with the Li surface, and leading to the formation of LiF at the interface.

For single chamber experiments, the Coulombic efficiency for PFOA degradation and conversion to fluorides in DMSO to be approximately 7.7%, which was higher than other reported electrochemical approaches.

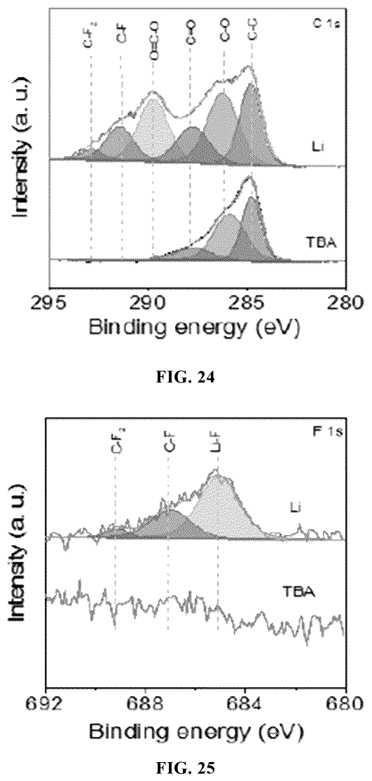

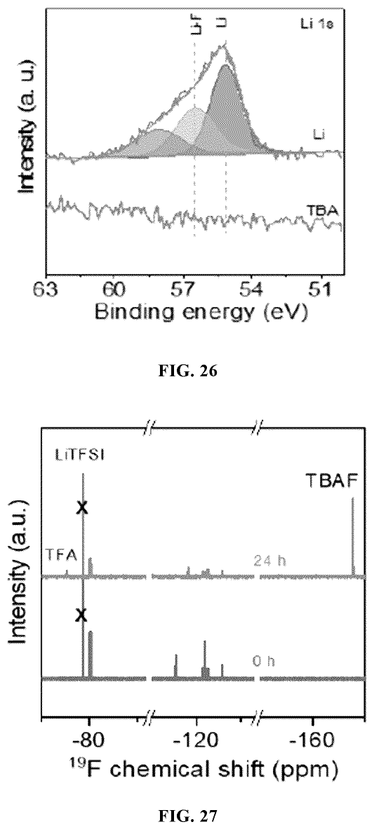

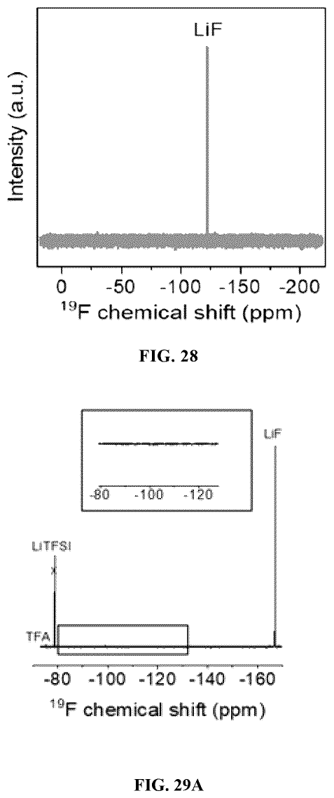

The interfacial composition of the lithium metal and electrode surface was analyzed using XPS. For tetrabutylammonium (“TBA”)-based electrolytes, the copper electrode was studied. FIGS. 24-26 illustrates little or no degradation products on the copper surface for TBA, demonstrating that the copper does not participate directly in the reaction and serves primarily as a shuttle for electrons. The fluorinated degradation products, such as TBA fluoride, were known to have high solubilities in organic media and were not present on the electrode surface but instead in solution, as illustrated in FIGS. 27 and 28. By contrast, the electrodeposited lithium demonstrated breakdown and defluorination of PFOA to fluoride on the surface.

### V. Analyzing Electrochemical Reaction Space

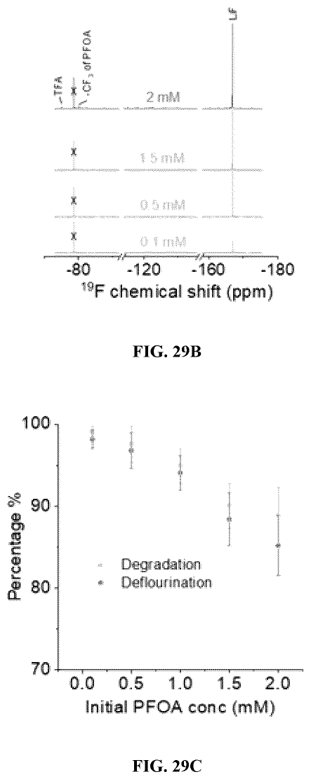

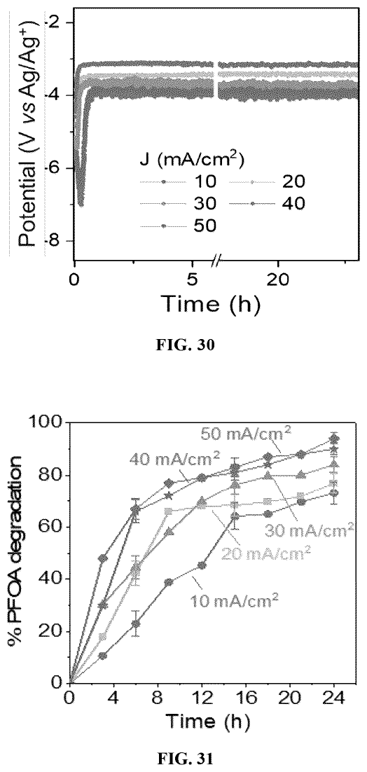

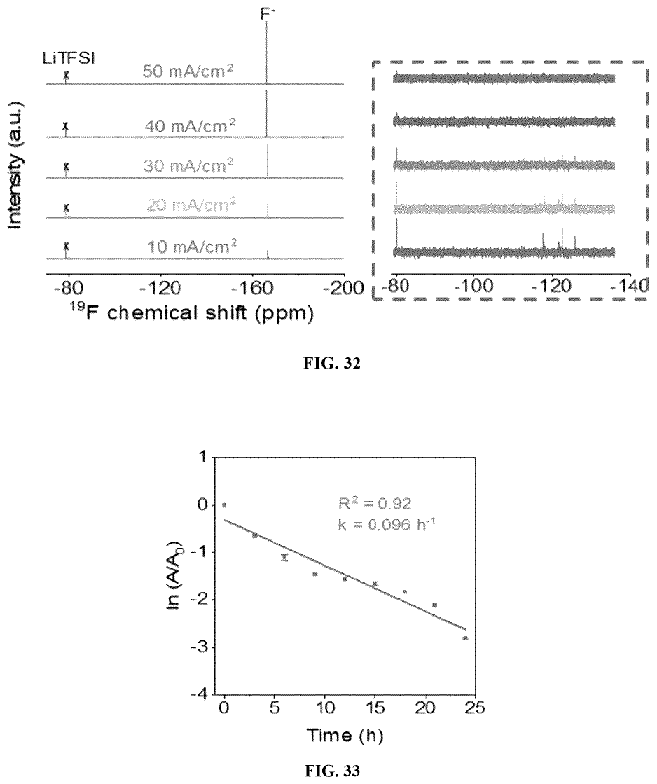

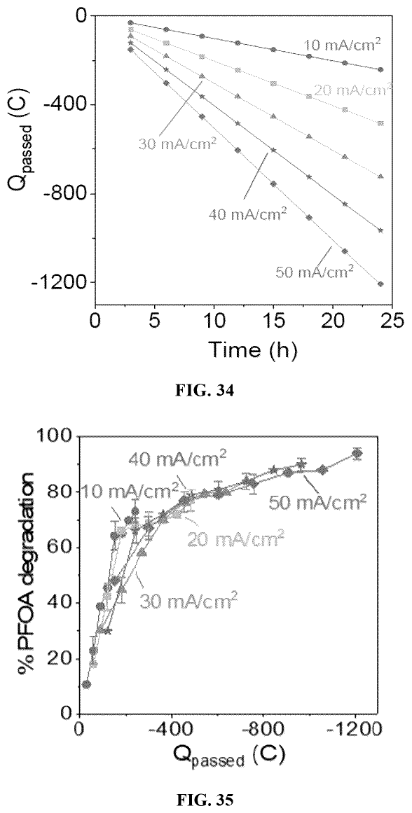

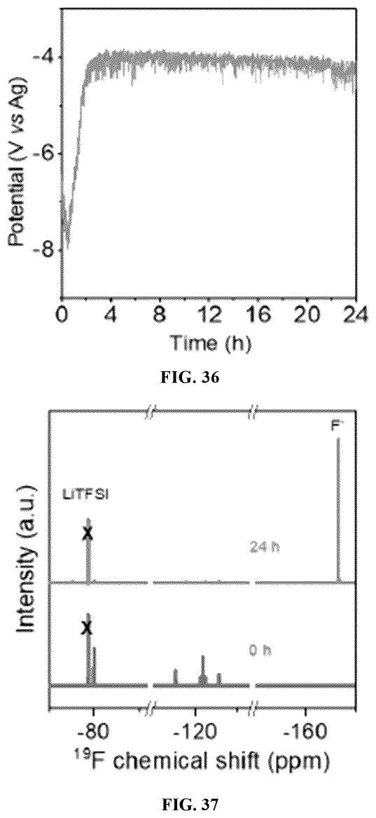

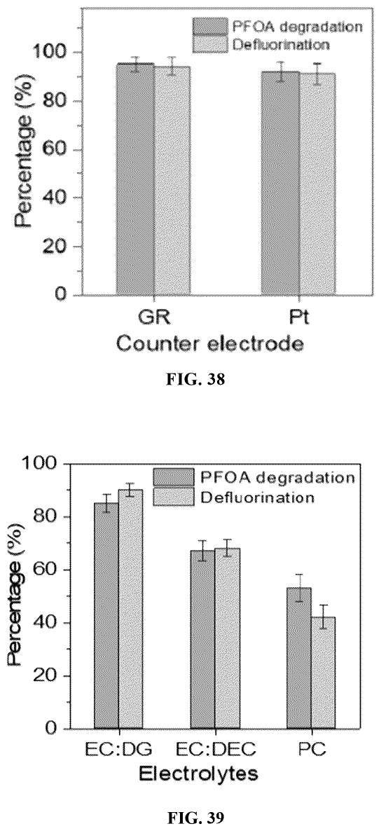

The influence of electrochemical variables such as initial PFOA concentration, current density, electrolyte, and electrode was further explored. As shown in FIG. 29A-29C, the degradation % and defluorination % increase with decreasing PFOA concentration, with >99% degradation for 0.1 mM. This highlights that the LME method is capable of effectively treating concentrated PFAS waste, whereas most existing methods aim to degrade much lower PFAS concentrations. The influence of reductive current on PFOA degradation was studied by varying the applied current density from 10 to 50 mA/cm², as illustrated in FIG. 30. As FIG. 31 illustrates, current density impacts PFAS degradation. Even current densities as low as 10 mA/cm² demonstrated mineralization to fluoride ion, while the degradation at 40 mA/cm² largely mirrored the degradation at 50 mA/cm². The ¹⁹F NMR analysis revealed a progressive increase in the formation of LiF as a product, accompanied by a reduction in PFOA concentration as illustrated in FIG. 32, with the reaction following a pseudo-first order reaction with a rate constant of 0.096 h⁻¹, as illustrated in FIG. 33. No smaller-chain fluorinated residues were observed. Because the total amount of time was fixed while the current density varied, the amount of charge varied, as illustrated in FIG. 34. As the total amount of charge applied increased, the extent of PFAS degradation increased as illustrated in FIG. 35. Though differences in the extent of degradation was observed at the same fixed charge, the differences were attributed to the differences in the observed voltages. The influence of the anode was also studied with platinum and graphite, demonstrating similar overall cell voltages and no effect on the overall degradation, as illustrated in FIGS. 36-38. The anodic reaction was not optimized, but it is expected that incorporation of water may provide anodic oxygen evolution reaction, and a boron doped diamond (BDD) anode may provide for simultaneous reductive and oxidative PFAS destruction.

The influence of solvent selection on the electrochemical degradation process was analyzed. FIG. 39 illustrates that there was a significant solvent dependence, with propylene carbonate (“PC”) demonstrating the poorest degradation efficiencies, while the ethylene carbonate (“EC”):diglyme (“DG”) mixture was much closer to the DMSO-based system.

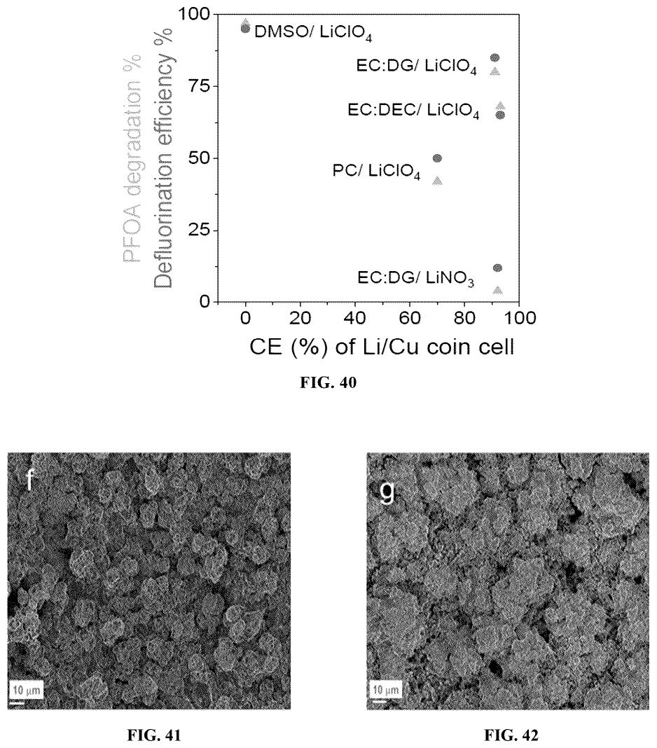

Lithium metal batteries were fabricated using the solvents to analyze the solvent influence on lithium metal Coulombic efficiency. To determine the lithium Coulombic efficiency in different electrolytes tested for PFOA degradation, Li/Cu coin cells were prepared in the following configuration: negative case∥spring∥spacer∥lithium metal (12 mm diameter, 500 μm thickness)∥25 μL solvent∥1 separator∥25 μL electrolyte∥Cu (15 mm diameter)∥spacer∥positive case. Celgard 2325 was used for most solvents except for PC, for which Celgard 3501 was used for better wetting. Lithium was first deposited on Cu at a current density of 0.5 mA/cm² to a capacity of 5 mA/cm², and then striped at the same current density until cell voltage reached 1 V. Coulombic efficiency was calculated as stripping capacity/deposition capacity (constant 5 mA/cm²)*100%. Because 0.5 M LiClO₄ in DMSO solvent had a very high overpotential and failed to complete the deposition step, the Columbic efficiency was assigned as 0%, as illustrated in FIG. 40. By contrast, FIG. 40 illustrated that solvents supporting low Li metal Coulombic efficiency had higher PFOA degradation efficiencies.

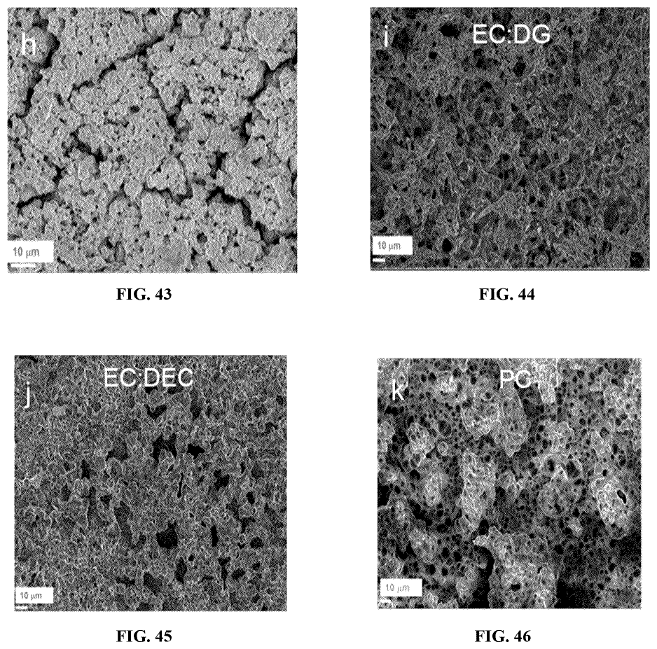

The influence of electrolyte selection on the lithium metal deposition morphology was also analyzed. FIGS. 41-46 illustrate SEM images of lithium deposited at different current densities and with different solvents. FIGS. 41-46 illustrate that in DMSO, the Li particle size decreased with increasing current, providing highly porous deposited lithium with large active surface area for reaction with PFAS.

### VI. Density Functional Theory (“DFT”) to Understand Degradation Mechanism

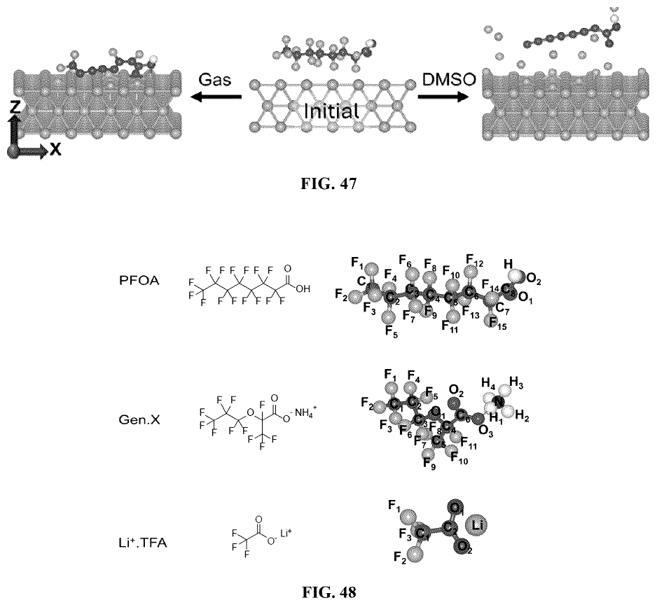

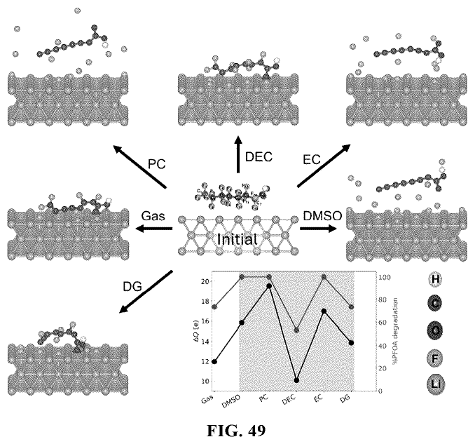

DFT was performed to obtain insight into the degradation process mechanism. The calculations refer to PFOA near a small lithium crystal, in the presence of solvents that implicitly influence the mechanism, and with all atoms free to move except for the lithium atoms, which are assumed fixed. The geometry of the PFOA molecule that is obtained from energy minimization of the starting structure is illustrated in FIGS. 47 and 48. FIG. 47 illustrates significant fragmentation of the PFOA, with the results significantly altered in some solvent environments compared to others, as illustrated in FIG. 49. In DMSO (dielectric constant (8)≈46.7), PC (≈64), and EC (≈89.78), the PFOA molecule was pushed away from the Li surface during the geometry relaxation process, with all C—F bonds degraded and the carbon chain becoming linear. The carbon chain structures are similar to the known structures of small anionic polyacetylenic carbon clusters with the same number of atoms, but the carboxylate group is not disassociated from the chain. By contrast, in low dielectric constant solvents, DG (≈7.2) and DEC (≈2.805), and in the gas phase, the PFOA molecule is attracted to the Li surface, and only roughly half of the C—F bonds are broken, as illustrated in FIG. 49. To understand this behavior, the charge transfer dynamics was analyzed in both the gas phase and DMSO solvent systems. The results illustrated in FIG. 49 demonstrate that the number of electrons transferred (ΔQ) was significantly higher when PFOA was solvated in DMSO, with 15.8 electrons transferred from the Li surface to the PFOA molecule, while the gas phase charge transfer was ~12.0 electrons. For both DMSO and vacuum, the high number of electrons transferred lead to substantial C—F bond degradation, but only DMSO led to complete defluorination, like the experimental observations. While the model was oversimplified compared to the experiment, the calculations suggested the conditions required to remove all fluorines from PFOA. The transfer of ~16 electrons to PFOA and degradation of 12 fluoride ions leave the carbon fragment of PFOA negatively charged such that the carbon fragment was repelled by fluoride near the lithium surface. Many of the fluoride ions were solvated in the DMSO, while others entered the lattice.

In PC and EC solvents, similar 100% C—F bond degradation was observed, with charge transfers of 19.5 e and 17.0 e, respectively. The PC and EC solvents, like DMSO, have relatively high dielectric constants, likely contributing to the efficient charge transfer and subsequent C—F bond degradation. In DEC and DG solvents, the lower dielectric constants lead to less stabilization of charged intermediates, less charge transfer, and less bond degradation. In DEC, a lower C—F bond degradation fraction of 53.3% was observed, with the corresponding charge transfer of 10.1 e. In DG, the C—F bond degradation fraction is 73.3%, like the gas phase, with a charge transfer of 13.9 e. Overall, the DFT results demonstrated that the solvents support PFOA degradation to some extent, but only DMSO, PC, and EC provided complete degradation.

### VII. Ab Initio Molecular Dynamics (AIMD) Studies to Understand the Effect of Electric Field

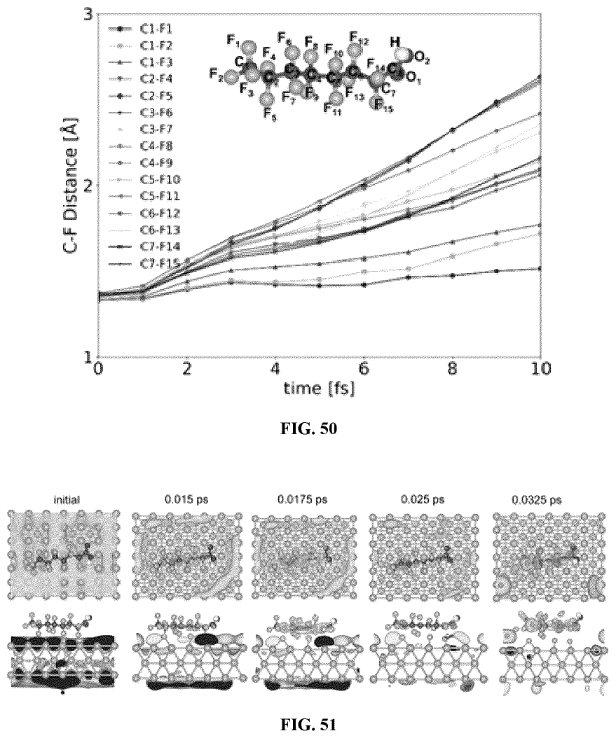

The degradation mechanism of PFOA on Li, which promotes C—F bond cleavage, was investigated using ab-initio molecular dynamics (AIMD) simulations under reductive conditions in a DMSO solvent. The simulations show a stepwise defluorination pathway initiated by a rapid charge transfer, and C—F bond dissociation. In the initial step (starting with the PFOA and Li metal in close proximity), occurring at 0.015 ps during the simulation, four C—F bonds were cleaved, resulting in the formation of Li—F and F-ions, accompanied by an electron transfer of 5.6 e. To further understand the C—F bond cleavage mechanism, bond length fluctuations were monitored during the first 0.01 ps of the simulation (FIG. 50). Initially, all C—F bonds fluctuated around an equilibrium bond length of ~1.3 Å. At 0.01 ps, the bond lengths of four specific C—F bonds (C5-F11, C7-F15, C2-F5, and C4-F9) stretched to ~2.5 Å, corresponding to complete dissociation. A second defluorination event was observed at 0.0175 ps, resulting in the cleavage of four additional C—F bonds and increasing the total electron transfer to 6.3 e. A third defluorination step occurred at 0.025 ps, where four more C—F bonds were broken, culminating in a total charge transfer of 9.3 e. Complete C—F bond dissociation was achieved by 0.0325 ps, leaving behind a linear C₆COOH chain and a total charge transfer of 14.7 e⁻. Subsequent degradation steps occurred at later times. At 0.2924 ps, protonation and decarboxylation produced CO₂ and a C₅-chain fragment. Spin density analysis shows the formation of transient carbon-centered radicals, however, these intermediates are extremely short-lived and rapidly undergo further C—F bond cleavage and fragmentation, forming Li—F, F⁻, CO₂, and smaller hydrocarbon fragments (FIG. 51). By 0.715 ps, further fragmentation produced CO and a C₂ species, indicating continued breakdown of the carbon backbone under reductive conditions. Prolonging the simulation beyond this point did not affect the final product distribution.

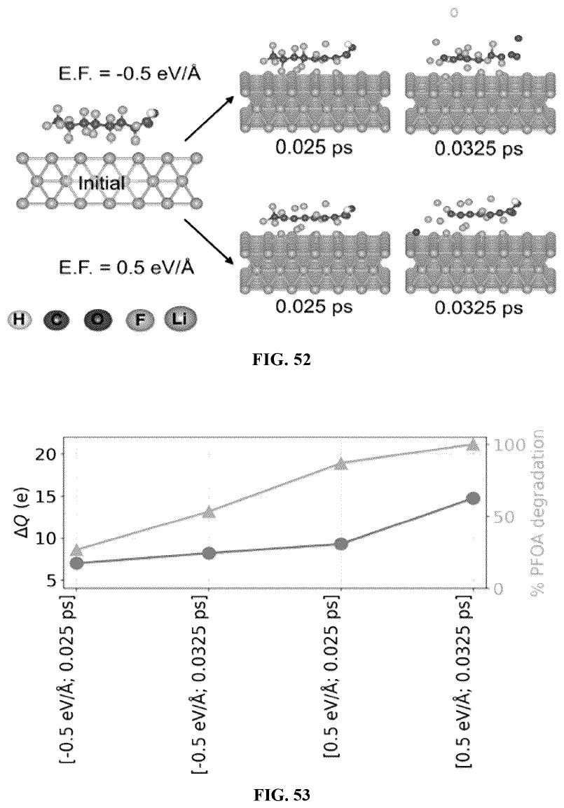

To simulate influence of applied electrochemical potential on PFOA degradation, AIMD simulations were conducted at 0 K for 5 ps with and without an electric field perpendicular to a Li surface. Under a reductive environment (+0.5 eV/Å) in DMSO solvent, significant degradation was observed, with the breaking of eight C—F bonds and the formation of Li—F bonds at 0.025 ps (FIGS. 52-53). A comparison between explicit and implicit solvent models under identical electric field conditions reveals PFOA degradation and charge transfer are similar (FIGS. 52-54). While implicit solvent methods offer computational efficiency, they may underrepresent solvent-mediated charge transfer pathways, which are essential for accurate modeling of interfacial electrochemical processes, as previously identified.

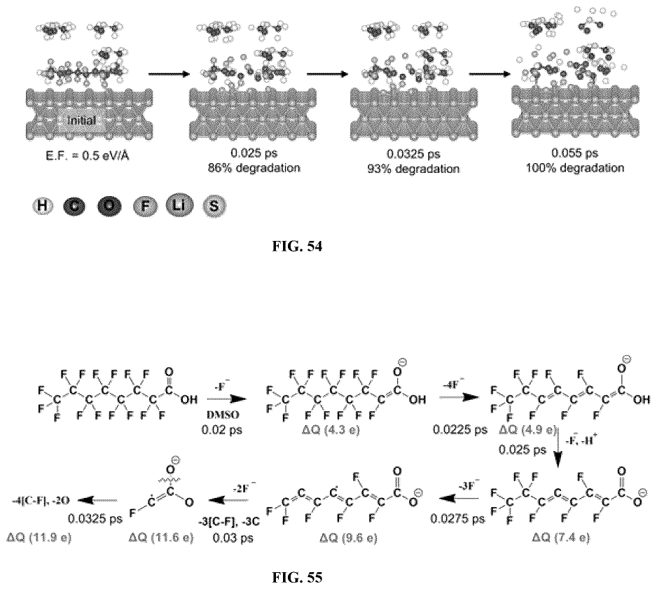

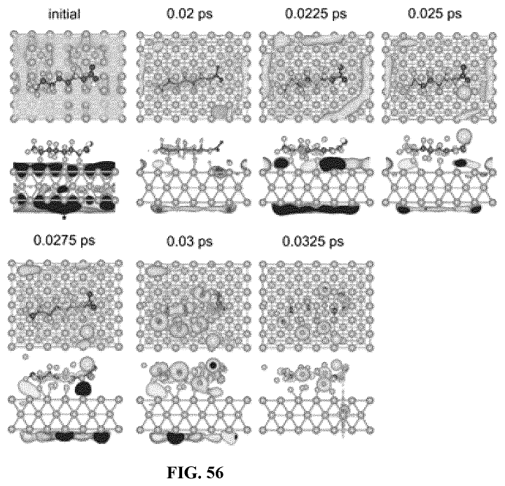

By contrast, under oxidation conditions (−0.5 eV/Å), degradation starts slowly, with bond breakages and fragments observed more gradually. AIMD simulations for oxidative degradation of PFOA on Li surface show that the process involves successive fluoride and proton eliminations, accompanied by a total charge transfer of ~11.9 e⁻, likely forming smaller fluorocarbon or carboxylate fragments (FIG. 55). Spin density analysis confirms the formation of carbon-centered radicals, indicating a radical-driven degradation pathway (FIG. 56).

The significant electronegativity difference between Li and PFOA atoms facilitates electron transfer from Li, weakening the C—F bonds and promoting degradation. Under reductive conditions with a positive electric field, the degradation was more pronounced, leading to greater and faster PFOA degradation compared to oxidative conditions with a negative electric field.

### VIII. Expanding Reaction Scope

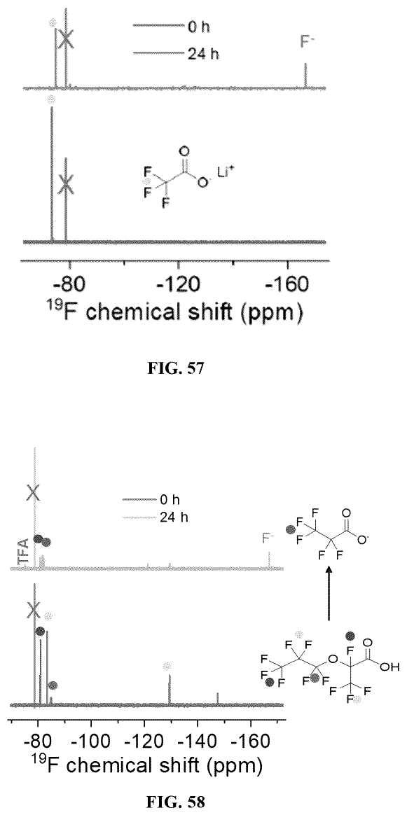

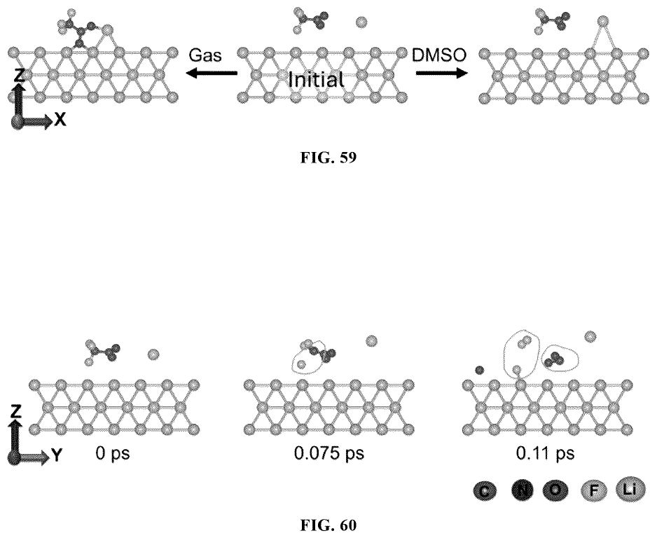

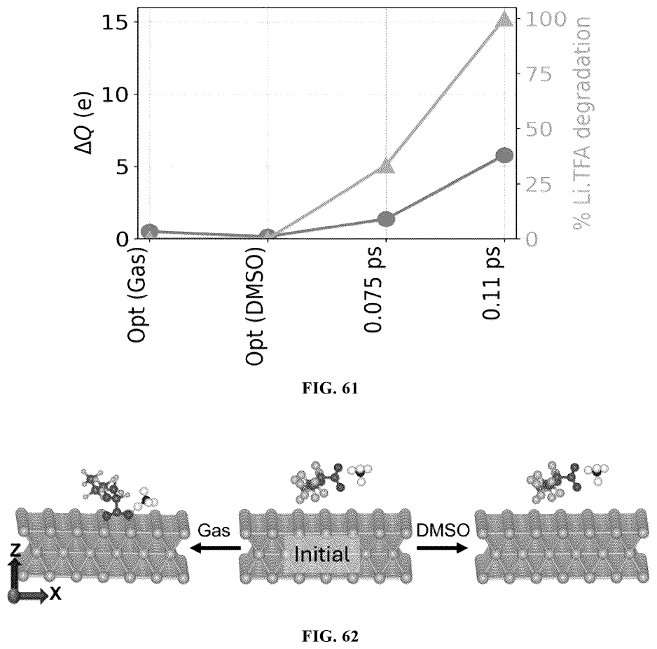

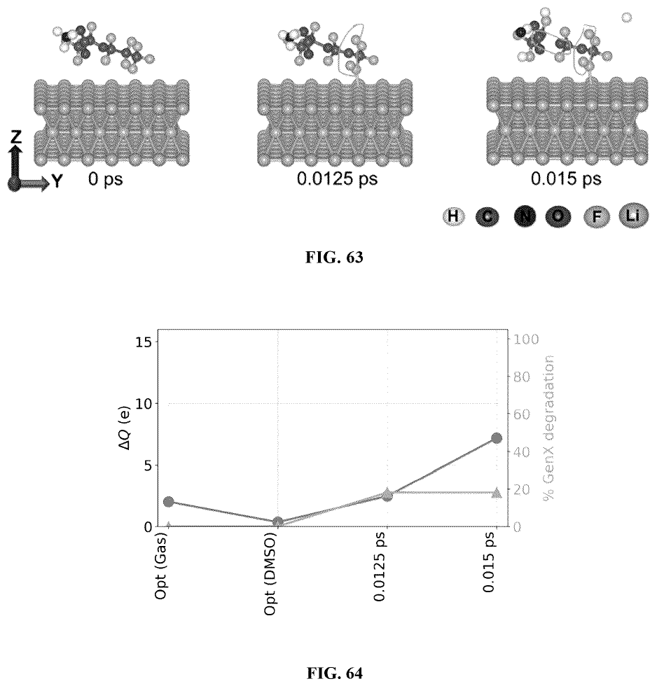

FIGS. 57 and 58 illustrated that lithium may degrade smaller chain PFASs such as HFPO-DA and TFA, with 24-hour degradation efficiencies of 71% and 29%, respectively. DFT calculations were performed to investigate the interaction and degradation of LiTFA and HFPO-DA on a Li surface. In the gas phase, LiTFA showed strong interactions with the Li surface, where the Lit and COO groups of TFA formed bonds, stabilizing the molecule, as illustrated in FIGS. 59-61. The bond distances in the CF₃ group were altered, but the charge transfer of 0.5 e from the Li surface was insufficient for degradation. In DMSO solvent, the charge transfer was even lower at 0.2 e, leading to no degradation. However, AIMD simulations over 5 ps in DMSO revealed significant changes. At 0.075 ps, the charge transfer increased to 1.39 e, resulting in breaking the C—F bonds. By 0.11 ps, the charge transfer rose dramatically to 5.77 e, leading to complete defluorination. For HFPO-DA, no degradation was observed in both gas phase and DMSO implicit solvent calculations. AIMD simulations over 5 ps in DMSO showed HFPO-DA beginning to defluorinate at 0.0125 ps with a charge transfer of 2.5 e, leading to the disassociation of two CF bonds, as illustrated in FIG. 62-64. By 0.015 ps, the molecule broke into fragments with the charge transfer increasing to 7.2 e, which provided enough electrons to destabilize and degrade the molecule. Thus, higher charge transfer promoted degradation.

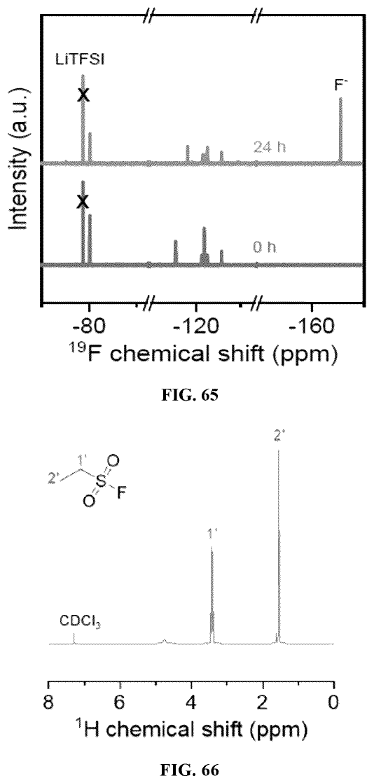

Beyond lithium, other reactive metals such as potassium may be incorporated. Potassium may enable 34% degradation of PFOA to KF, as illustrated in FIG. 65. Potassium may exhibit a higher solvent solution resistance relative to lithium.

### IX. Valorization of Degraded PFASs to Non-PFAS Products

Though the Department of Energy listed fluorine as critical for energy, PFASs thus far are considered waste compounds. Therefore, recovering fluorides obtained from PFAS degradation, and converting them to non-PFAS fluorinated products may close the fluorine loop. KF was reported widely as a reagent for fluorination reactions, and the synthesis of ethane sulfonyl fluoride, is a pertinent example, because of the use of ethane sulfonyl fluoride in battery applications as well as in drug discovery. Further, ethane sulfonyl fluoride is not considered a PFAS.

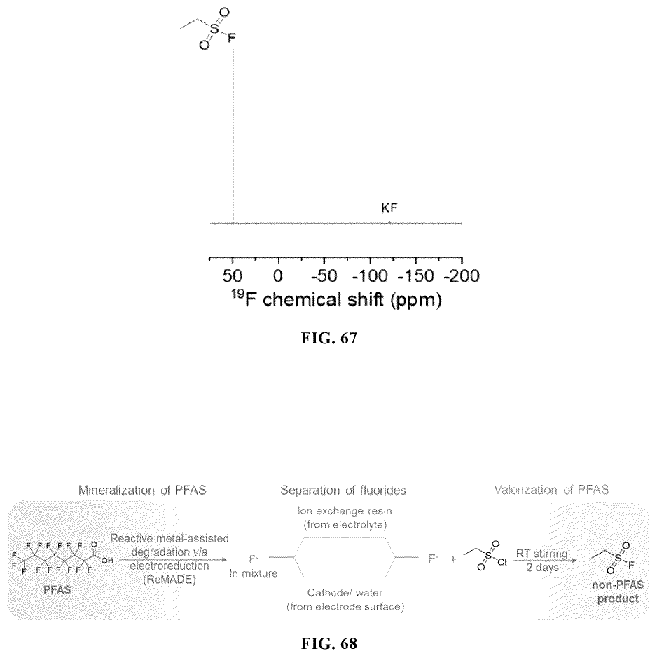

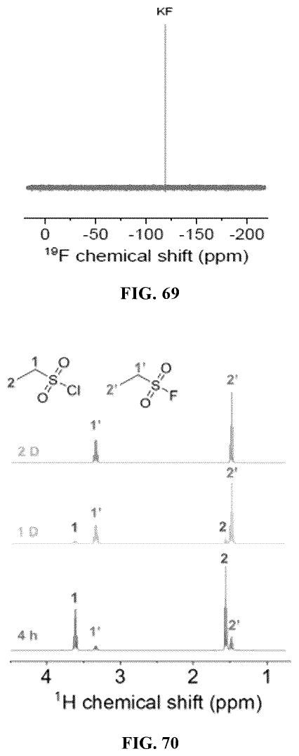

Ethane sulfonyl fluoride was initially synthesized using commercial KF, following literature procedure for synthesizing sulfonyl fluorides, as illustrated in FIGS. 66 and 67. The initial synthesis served as a reference. After degradation of PFOA, the resulting KF was separated from the DMSO solvent by either washing the anode surface or by ion exchange chromatography, as illustrated in FIGS. 68 and 69. KF on the anode surface was collected by washing the anode thoroughly with water to dissolve and collect all of the deposited KF. The fluoride-containing solution was passed through an ion-exchange column packed with Amberlite IRA-402 (Cl⁻ form) resin at a flow rate of approximately 0.5 mL/min. The fluoride ions were adsorbed onto the resin and subsequently eluted using 2% NaCl solution. The collected fluoride was washed with water and concentrated using a rotary evaporator to obtain a saturated KF solution. The solution was then reacted with ethane sulfonyl chloride as a biphasic mixture.

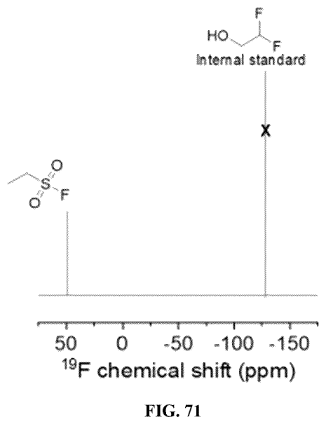

As illustrated in FIG. 70, the ¹H NMR spectra reveal a gradual decrease in the ethane sulfonyl chloride peaks and a corresponding increase in the ethane sulfonyl fluoride peaks, indicating the successful conversion of ethane sulfonyl chloride to ethane sulfonyl fluoride over two days. By the end of the reaction, only the ethane sulfonyl fluoride peak was observed with 82% yield, as illustrated in FIG. 71. The process demonstrated a successful upcycling pathway, converting PFAS degradation products into ethane sulfonyl chloride, a valuable non-PFAS fluorinated compound.

Although the present disclosure has been described with reference to examples and the accompanying drawings, the present disclosure is not limited thereto but may be variously modified and altered by those skilled in the art to which the present disclosure pertains without departing from the spirit and scope of the present disclosure.

What is claimed is:

1. An electrochemical degradation system for a halogenated compound, the system comprising:
a working electrode, to which a current density is applicable; and
a nonaqueous solution of an ionic compound and the halogenated compound in an organic solvent, the solution in contact with the working electrode.

2. The system of claim 1, wherein the ionic compound comprises a cation of an alkali metal or an alkaline earth metal.

3. The system of claim 2, wherein the ionic compound comprises a lithium cation.

4. The system of claim 1, wherein the ionic compound comprises a nitrate or a perchlorate anion.

5. The system of claim 1, wherein the halogenated compound is a poly- or perfluoroalkyl substance.

6. The system of claim 5, wherein the halogenated compound is selected from the group consisting of: 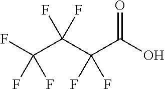 [SMILES: O=C(O)C(F)(F)C(F)(F)C(F)(F)F]
perfluorobutanoic acid (″PFBA″); 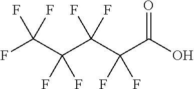 [SMILES: O=C(O)C(F)(F)C(F)(F)C(F)(F)C(F)(F)F]
perfluoropentanoic acid (″PFPeA″); 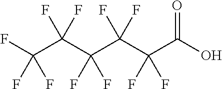 [SMILES: O=C(O)C(F)(F)C(F)(F)C(F)(F)C(F)(F)C(F)(F)F]
perfluorohexanoic acid (″PFHxA″); 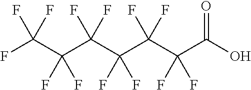 [SMILES: O=C(O)C(F)(F)C(F)(F)C(F)(F)C(F)(F)C(F)(F)C(F)(F)F]
perfluoroheptanoic acid (″PFHpA″); 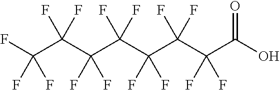 [SMILES: O=C(O)C(F)(F)C(F)(F)C(F)(F)C(F)(F)C(F)(F)C(F)(F)C(F)(F)F]
perfluorooctanoic acid (″PFOA″); 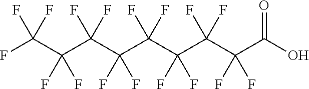 [SMILES: O=C(O)C(F)(F)C(F)(F)C(F)(F)C(F)(F)C(F)(F)C(F)(F)C(F)(F)C(F)(F)F]
perfluorononanoic acid (″PFNA″); 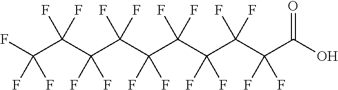 [SMILES: O=C(O)C(F)(F)C(F)(F)C(F)(F)C(F)(F)C(F)(F)C(F)(F)C(F)(F)C(F)(F)C(F)(F)F]
perfluorodecanoic acid (″PFDA″); 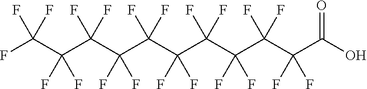 [SMILES: O=C(O)C(F)(F)C(F)(F)C(F)(F)C(F)(F)C(F)(F)C(F)(F)C(F)(F)C(F)(F)C(F)(F)C(F)(F)F]
perfluoroundecanoic acid (″PFUnA″); 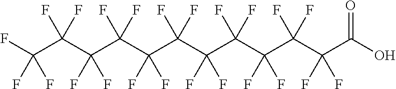 [SMILES: O=C(O)C(F)(F)C(F)(F)C(F)(F)C(F)(F)C(F)(F)C(F)(F)C(F)(F)C(F)(F)C(F)(F)C(F)(F)C(F)(F)F]
perfluorododecanoic acid (″PFDoA″); 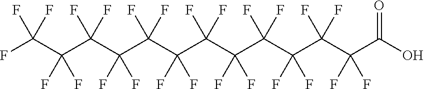 [SMILES: O=C(O)C(F)(F)C(F)(F)C(F)(F)C(F)(F)C(F)(F)C(F)(F)C(F)(F)C(F)(F)C(F)(F)C(F)(F)C(F)(F)C(F)(F)F]
perfluorotridecanoic acid (″PFTriA″); 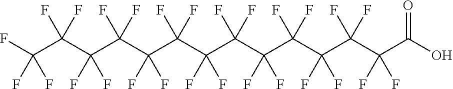 [SMILES: O=C(O)C(F)(F)C(F)(F)C(F)(F)C(F)(F)C(F)(F)C(F)(F)C(F)(F)C(F)(F)C(F)(F)C(F)(F)C(F)(F)C(F)(F)C(F)(F)F]
perfluorotetradecanoic acid (″PFTeA″); 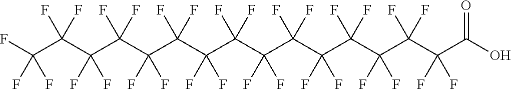 [SMILES: O=C(O)C(F)(F)C(F)(F)C(F)(F)C(F)(F)C(F)(F)C(F)(F)C(F)(F)C(F)(F)C(F)(F)C(F)(F)C(F)(F)C(F)(F)C(F)(F)C(F)(F)C(F)(F)F]
perfluoro-n-hexadecanoic acid (″PFHxDA″); 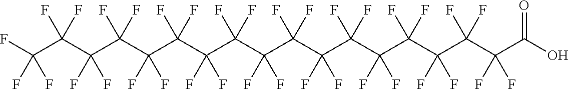 [SMILES: O=C(O)C(F)(F)C(F)(F)C(F)(F)C(F)(F)C(F)(F)C(F)(F)C(F)(F)C(F)(F)C(F)(F)C(F)(F)C(F)(F)C(F)(F)C(F)(F)C(F)(F)C(F)(F)C(F)(F)C(F)(F)F]
perfluorooctadecanoic acid (″PFODA″); 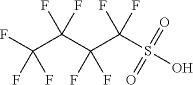 [SMILES: O=S(=O)(O)C(F)(F)C(F)(F)C(F)(F)C(F)(F)F]
perfluorobutanesulfonic acid (″PFBS″); 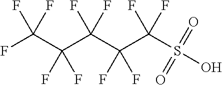 [SMILES: O=S(=O)(O)C(F)(F)C(F)(F)C(F)(F)C(F)(F)C(F)(F)F]
perfluoropentanesulfonic acid (″PFPeS″); 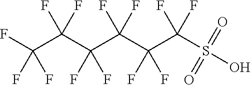 [SMILES: O=S(=O)(O)C(F)(F)C(F)(F)C(F)(F)C(F)(F)C(F)(F)C(F)(F)F]
perfluorohexanesulfonic acid (″PFHxS″); 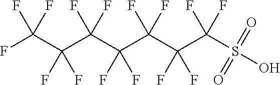 [SMILES: O=S(=O)(O)C(F)(F)C(F)(F)C(F)(F)C(F)(F)C(F)(F)C(F)(F)C(F)(F)F]
perfluoroheptanesulfonic acid (″PFHpS″); 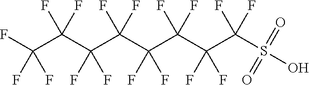 [SMILES: O=S(=O)(O)C(F)(F)C(F)(F)C(F)(F)C(F)(F)C(F)(F)C(F)(F)C(F)(F)C(F)(F)F]
perfluorooctanesulfonic acid (″PFOS″); 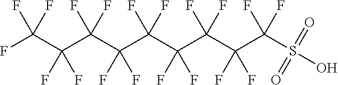 [SMILES: O=S(=O)(O)C(F)(F)C(F)(F)C(F)(F)C(F)(F)C(F)(F)C(F)(F)C(F)(F)C(F)(F)C(F)(F)F]
perfluorononanesulfonic acid (″PFNS″); 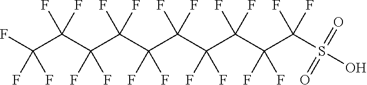 [SMILES: O=S(=O)(O)C(F)(F)C(F)(F)C(F)(F)C(F)(F)C(F)(F)C(F)(F)C(F)(F)C(F)(F)C(F)(F)C(F)(F)F]
perfluoroodecanesulfonic acid (″PFDS″); 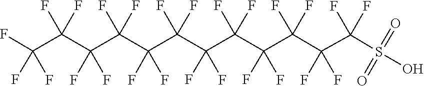 [SMILES: O=S(=O)(O)C(F)(F)C(F)(F)C(F)(F)C(F)(F)C(F)(F)C(F)(F)C(F)(F)C(F)(F)C(F)(F)C(F)(F)C(F)(F)C(F)(F)F]
perfluorododecanesulfonic acid (″PFDoS″); 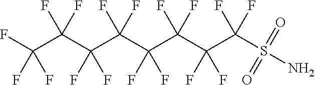 [SMILES: NS(=O)(=O)C(F)(F)C(F)(F)C(F)(F)C(F)(F)C(F)(F)C(F)(F)C(F)(F)C(F)(F)F]
perfluorooctanesulfonamide (″PFOSA″); 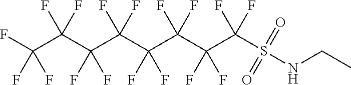 [SMILES: CCNS(=O)(=O)C(F)(F)C(F)(F)C(F)(F)C(F)(F)C(F)(F)C(F)(F)C(F)(F)C(F)(F)F]
N-ethyl-1,1,2,2,3,3,4,4,5,5,6,6,7,7,8,8,8-
heptadecafluorooctane-1-sulfonamide
(″NEtFOSA″); 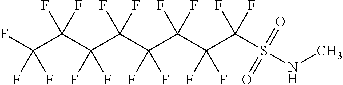 [SMILES: CNS(=O)(=O)C(F)(F)C(F)(F)C(F)(F)C(F)(F)C(F)(F)C(F)(F)C(F)(F)C(F)(F)F]
N-methyl-1,1,2,2,3,3,4,4,5,5,6,6,7,7,8,8,8-
heptadecafluorooctane-1-sulfonamide
(″NMeFOSA″); 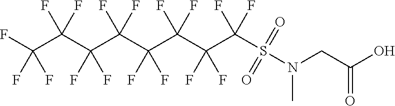 [SMILES: CN(CC(=O)O)S(=O)(=O)C(F)(F)C(F)(F)C(F)(F)C(F)(F)C(F)(F)C(F)(F)C(F)(F)C(F)(F)F]
2-[1,1,2,2,3,3,4,4,5,5,6,6,7,7,8,8,8-
heptadecafluorooctylsulfonyl(methyl)-
amino]acetic acid (″NMeFOSAA″); 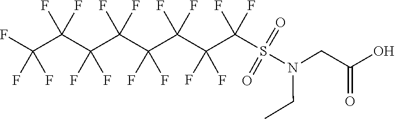 [SMILES: CCN(CC(=O)O)S(=O)(=O)C(F)(F)C(F)(F)C(F)(F)C(F)(F)C(F)(F)C(F)(F)C(F)(F)C(F)(F)F]
2-[1,1,2,2,3,3,4,4,5,5,6,6,7,7,8,8,8-
heptadecafluorooctylsulfony(ethyl)-
amino]acetic acid (″NEtFOSAA″); 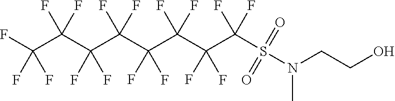 [SMILES: CN(CCO)S(=O)(=O)C(F)(F)C(F)(F)C(F)(F)C(F)(F)C(F)(F)C(F)(F)C(F)(F)C(F)(F)F]
1,1,2,2,3,3,4,4,5,5,6,6,7,7,8,8,8-
heptadecafluoro-N-(2-hydroxyethyl)-N-
methyloctane-1-sulfonamide
(″NMeFOSE″); 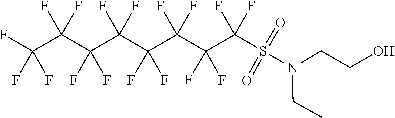 [SMILES: CCN(CCO)S(=O)(=O)C(F)(F)C(F)(F)C(F)(F)C(F)(F)C(F)(F)C(F)(F)C(F)(F)C(F)(F)F]
1,1,2,2,3,3,4,4,5,5,6,6,7,7,8,8,8-
heptadecafluoro-N-ethyl-N-(2-hydroxyethyl)-
octane-1-sulfonamide (″NEtFOSE″); 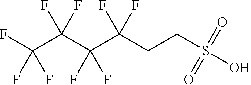 [SMILES: O=S(=O)(O)CCC(F)(F)C(F)(F)C(F)(F)C(F)(F)F]
3,3,4,4,5,5,6,6,6-nonafluorohexane-1-
sulfonic acid (″4:2 FTS″); 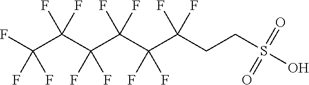 [SMILES: O=S(=O)(O)CCC(F)(F)C(F)(F)C(F)(F)C(F)(F)C(F)(F)C(F)(F)F]
3,3,4,4,5,5,6,6,7,7,8,8,8-tridecafluorooctane-1-
sulfonic acid (″6:2 FTS″); 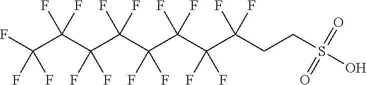 [SMILES: O=S(=O)(O)CCC(F)(F)C(F)(F)C(F)(F)C(F)(F)C(F)(F)C(F)(F)C(F)(F)C(F)(F)F]
3,3,4,4,5,5,6,6,7,7,8,8,9,9,10,10,10-
heptadecafluorodecane-1-sulfonic acid
(″8:2 FTS″); 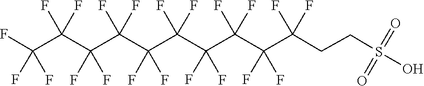 [SMILES: O=S(=O)(O)CCC(F)(F)C(F)(F)C(F)(F)C(F)(F)C(F)(F)C(F)(F)C(F)(F)C(F)(F)C(F)(F)C(F)(F)F]
3,3,4,4,5,5,6,6,7,7,8,8,9,9,10,10,11,11,-
12, 12, 12-henicoasfluorododecane-1-sulfonic
acid (″10:2 FTS″); 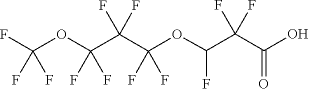 [SMILES: O=C(O)C(F)(F)C(F)OC(F)(F)C(F)(F)C(F)(F)OC(F)(F)F]
2,2,3-trifluoro-3-[1, 1,2,2,3,3-hexafluoro-3-
(trifluoromethoxy)propoxy]propanoic acid
(″DONA″); 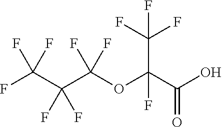 [SMILES: O=C(O)C(F)(OC(F)(F)C(F)(F)C(F)(F)F)C(F)(F)F]
2,3,3,3-tetrafluoro-2-(1, 1,2,2,3,3,3-
hexafluoropropoxy)propanoic acid (″HFPO-
DA″ or ″Gen-X″); 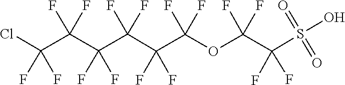 [SMILES: O=S(=O)(O)C(F)(F)C(F)(F)OC(F)(F)C(F)(F)C(F)(F)C(F)(F)C(F)(F)C(F)(F)Cl]
2-(6-chloro-1,1,2,2,3,3,4,4,5,5,6,6-
dodecafluorohexoxy)-1, 1,2,2-
tetrafluoroethanesulfonic acid (″F-53B
Major″); 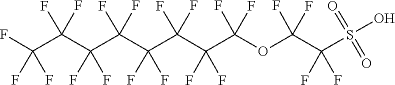 [SMILES: O=S(=O)(O)C(F)(F)C(F)(F)OC(F)(F)C(F)(F)C(F)(F)C(F)(F)C(F)(F)C(F)(F)C(F)(F)C(F)(F)F]
2-(8-chloro-1,1,2,2,3,3,4,4,5,5,6,6,7,7,8,8-
hexadecafluorooctoxy)-1, 1,2,2-
tetrafluoroethanesulfonic acid (″F-53B
Minor″); 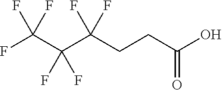 [SMILES: O=C(O)CCC(F)(F)C(F)(F)C(F)(F)F]
4,4,5,5,6,6,6-heptafluorohexanoic acid (″3:3
FTCA″); 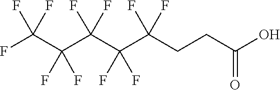 [SMILES: O=C(O)CCC(F)(F)C(F)(F)C(F)(F)C(F)(F)C(F)(F)F]
4,4,5,5,6,6,7,7,8,8,8-undecafluorooctanoic acid
(″5:3 FTCA″); 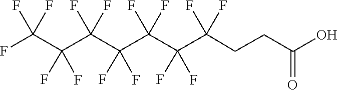 [SMILES: O=C(O)CCC(F)(F)C(F)(F)C(F)(F)C(F)(F)C(F)(F)C(F)(F)C(F)(F)F]
4,4,5,5,6,6,7,7,8,8,9,9,10,10,10-
pentadecafluorodecanoic acid (″7:3
FTCA″); 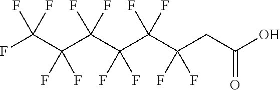 [SMILES: O=C(O)CC(F)(F)C(F)(F)C(F)(F)C(F)(F)C(F)(F)C(F)(F)F]
3,3,4,4,5,5,6,6,7, 7,8,8,8-tridecafluorooctanoic
acid (″6:2 FTCA″); 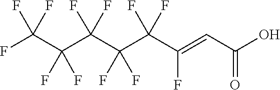 [SMILES: O=C(O)/C=C(\F)C(F)(F)C(F)(F)C(F)(F)C(F)(F)C(F)(F)F]
3,4,4,5,5,6,6,7,7,8,8,8-dodecafluorooct-2-
enoic acid (″6:2 FTUCA″); 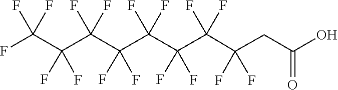 [SMILES: O=C(O)CC(F)(F)C(F)(F)C(F)(F)C(F)(F)C(F)(F)C(F)(F)C(F)(F)C(F)(F)F]
3,3,4,4,5,5,6,6,7,7,8,8,9,9,10,10,10-
heptadecafluorodecanoic acid (″8:2 FTCA″); 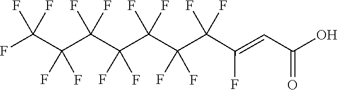 [SMILES: O=C(O)/C=C(\F)C(F)(F)C(F)(F)C(F)(F)C(F)(F)C(F)(F)C(F)(F)C(F)(F)F]
3,4,4,5,5,6,6,7,7,8,8,9,9,10,10,10-
hexadecafluorodec-2-enoic acid (″8:2
FTUCA″); 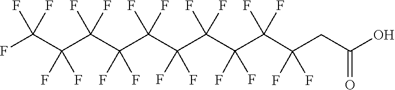 [SMILES: O=C(O)CC(F)(F)C(F)(F)C(F)(F)C(F)(F)C(F)(F)C(F)(F)C(F)(F)C(F)(F)C(F)(F)C(F)(F)F]
3,3,4,4,5,5,6,6,7,7,8,8,9,9,10,10,11,11,-
12,12,12-henicosafluorododecanoic acid (″10:2
FTCA″); 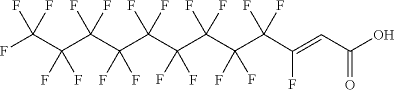 [SMILES: O=C(O)/C=C(\F)C(F)(F)C(F)(F)C(F)(F)C(F)(F)C(F)(F)C(F)(F)C(F)(F)C(F)(F)C(F)(F)F]
(Z)-3,4,4,5,5,6,6,7,7,8,8,9,9,10,10,11,11,-
12,12, 12-icosafluorododec-2-enoic acid
(″10:2 FTUCA″); 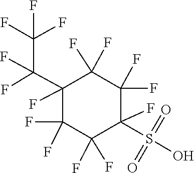 [SMILES: O=S(=O)(O)C1(F)C(F)(F)C(F)(F)C(F)(C(F)(F)C(F)(F)F)C(F)(F)C1(F)F]
perfluoro(4-perfluoroethyl)cyclohexanesulfonic
acid (″PFECHS″); 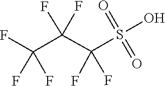 [SMILES: O=S(=O)(O)C(F)(F)C(F)(F)C(F)(F)F]
1,1,2,2,3,3,3-heptafluoropropane-1-sulfonic
acid (″PFPrS″); 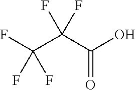
2,2,3,3,3-pentafluoropropanoic acid (″PFPrA″); 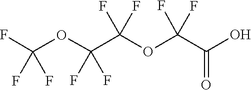 [SMILES: O=C(O)C(F)(F)OC(F)(F)C(F)(F)OC(F)(F)F]
2,2-difluoro-2-[1,1,2,2-tetrafluoro-2-
(trifluoromethoxy)ethoxy]acetic acid
(″NFDHA″); 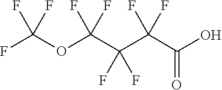 [SMILES: O=C(O)C(F)(F)C(F)(F)C(F)(F)OC(F)(F)F]
2,2,3,3,4,4-hexafluoro-4-
(trifluoromethoxy)butanoic acid (″PFMBA″); 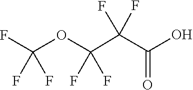 [SMILES: O=C(O)C(F)(F)C(F)(F)OC(F)(F)F]
2,2,3,3-tetrafluoro-3-
(trifluoromethoxy)propanoic acid
(″PFMPA″); 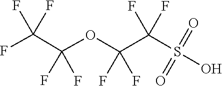 [SMILES: O=S(=O)(O)C(F)(F)C(F)(F)OC(F)(F)C(F)(F)F]
1, 1,2,2-tetrafluoro-2-
(perfluoroethoxy)ethanesulfonic acid
(″PFEESA″); 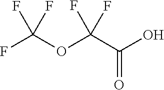 [SMILES: O=C(O)C(F)(F)OC(F)(F)F]
2,2-difluoro-2-(trifluoromethoxy)acetic acid
(″PFMOAA″); 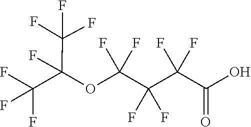 [SMILES: O=C(O)C(F)(F)C(F)(F)C(F)(F)OC(F)(C(F)(F)F)C(F)(F)F]
perfluoro-4-isopropoxybutanoic acid (″PFECA
G″); 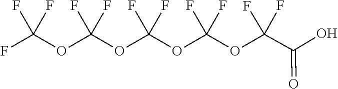 [SMILES: O=C(O)C(F)(F)OC(F)(F)OC(F)(F)OC(F)(F)OC(F)(F)F]
perfluoro-3,5,7,9-butaoxadecanoic acid
(″PFO4DA″); 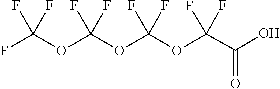 [SMILES: O=C(O)C(F)(F)OC(F)(F)OC(F)(F)OC(F)(F)F]
perfluoro-3,5,7-trioxaoctanoic acid
(″PFO3OA″); 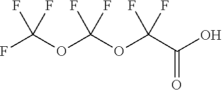 [SMILES: O=C(O)C(F)(F)OC(F)(F)OC(F)(F)F]
perfluoro-3,5-dioxahexanoic acid
(″PFO2HxA″); 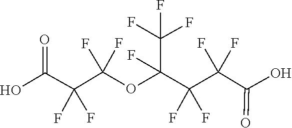 [SMILES: O=C(O)C(F)(F)C(F)(F)OC(F)(C(F)(F)F)C(F)(F)C(F)(F)C(=O)O]
4-(2-carboxy-1,1,2,2-tetrafluoroethoxy)-
perfluoropentanoic acid (″R-EVE″); 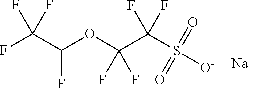 [SMILES: O=S(=O)([O-])C(F)(F)C(F)(F)OC(F)C(F)(F)F ; [Na+]]
sodium 1,1,2,2-tetrafluoro-2-(1,2,2,2-
tetrafluoroethoxy)ethanesulfonate
(″NVOHS″); 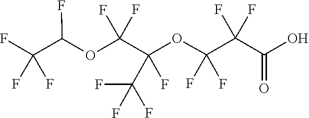 [SMILES: O=C(O)C(F)(F)C(F)(F)OC(F)(C(F)(F)F)C(F)(F)OC(F)C(F)(F)F]
2,2,3,3-tetrafluoro-3-{[1,1, 1,2,3,3-hexafluoro-
3-(1,2,2,2-tetrafluoroethoxy)propan-2-
yl]oxy)propanoic acid (″Hydro-EVE Acid″); 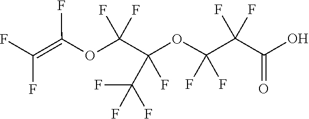 [SMILES: O=C(O)C(F)(F)C(F)(F)OC(F)(C(F)(F)F)C(F)(F)OC(F)=C(F)F]
2,2,3,3-tetrafluoro-3-
[1,1,1,2,3,3 ]hexafluoro-3-(1,2,2-
trifluoroethenoxy)propan-2-yl]oxypropanoic
acid (″EVE Acid″); 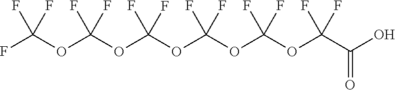 [SMILES: O=C(O)C(F)(F)OC(F)(F)OC(F)(F)OC(F)(F)OC(F)(F)OC(F)(F)F]
perfluoro-3,5,7,9, 11-pentaoxadodecanoic acid
(″PFO5DA″); 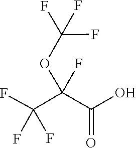 [SMILES: O=C(O)C(F)(OC(F)(F)F)C(F)(F)F]
2,3,3,3-tetrafluoro-2-
(trifluoromethoxy)propanoic acid
(″PMPA″); 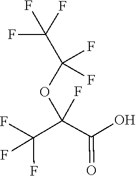 [SMILES: O=C(O)C(F)(OC(F)(F)C(F)(F)F)C(F)(F)F]
2,3,3,3-tetrafluoro-2-
(pentafluoroethoxy)propanoic acid (″PEPA″); 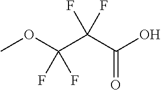
2,2,3,3-tetrafluoro-3-methoxy-propanoic
acid (″MTP″); 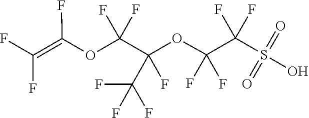 [SMILES: O=S(=O)(O)C(F)(F)C(F)(F)OC(F)(C(F)(F)F)C(F)(F)OC(F)=C(F)F]
1,1,2,2-tetrafluoro-2-[1,1,1,2,3,3-hexafluoro-3-
(1,2,2-trifluoroethenoxy)propan-2-
yl]oxyethanesulfonic acid (″PS Acid″); 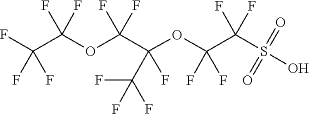 [SMILES: O=S(=O)(O)C(F)(F)C(F)(F)OC(F)(C(F)(F)F)C(F)(F)OC(F)(F)C(F)(F)F]
1,1,2,2-tetrafluoro-2-[1,1,1,2,3,3-
hexafluoro-3-(1,2,2,2-
tetrafluoroethoxy)propan-2-
yl]oxyethanesulfonic acid (″Hydro-PS
Acid″); 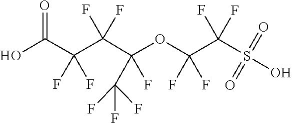 [SMILES: O=C(O)C(F)(F)C(F)(F)C(F)(OC(F)(F)C(F)(F)S(=O)(=O)O)C(F)(F)F]
2,2,3,3,4,5,5,5-4-(1,1,2,2-tetrafluoro-2-
sulfoethoxy)pentanoic acid (″R-PSDA″); 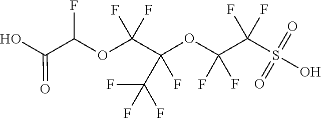 [SMILES: O=C(O)C(F)OC(F)(F)C(F)(OC(F)(F)C(F)(F)S(=O)(=O)O)C(F)(F)F]
2-fluoro-2-[1,1,2,3,3,3-hexafluoro-2-
(1,1,2,2-tetrafluoro-2-
sulfoethoxy)propoxy ]acetic acid
(″Hydrolyzed PSDA″); 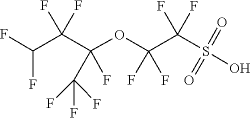 [SMILES: O=S(=O)(O)C(F)(F)C(F)(F)OC(F)(C(F)(F)F)C(F)(F)C(F)F]
1,1,2,2-tetrafluoro-2-[(1,1,1,2,3,3,4,4-
octafluorobutan-2-yl)oxyJethane-1-sulfonic
acid (″R-PSDCA″); 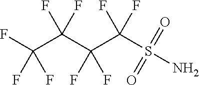 [SMILES: NS(=O)(=O)C(F)(F)C(F)(F)C(F)(F)C(F)(F)F]
1,1,2,2,3,3,4,4,4-nonafluorobutane-1-
sulfonamide (″FBSA″); 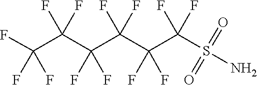 [SMILES: NS(=O)(=O)C(F)(F)C(F)(F)C(F)(F)C(F)(F)C(F)(F)C(F)(F)F]
1,1,2,2,3,3,4,4,5,5,6,6,6-tridecafluorohexane-1-
sulfonamide (″FHxSA″); 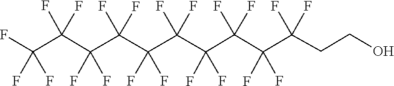 [SMILES: OCCC(F)(F)C(F)(F)C(F)(F)C(F)(F)C(F)(F)C(F)(F)C(F)(F)C(F)(F)C(F)(F)C(F)(F)F]
3,3,4,4,5,5,6,6,7,7,8,8,9,9,10,10,11,11,-
12,12, 12-henicosafluorododoecan-1-ol
(″10:2 FTOH″); 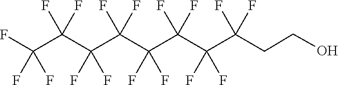 [SMILES: OCCC(F)(F)C(F)(F)C(F)(F)C(F)(F)C(F)(F)C(F)(F)C(F)(F)C(F)(F)F]
3,3,4,4,5,5,6,6,7,7,8,8,9,9,10,10,10-
heptadecafluorodecan-1-ol (″8:2 FTOH″); 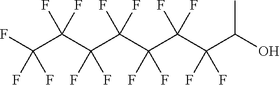 [SMILES: CC(O)C(F)(F)C(F)(F)C(F)(F)C(F)(F)C(F)(F)C(F)(F)C(F)(F)F]
3,3,4,4,5,5,6,6,7,7,8,8,9,9,9-
pentadecafluorononan-2-ol (″7:2 FTOH″); 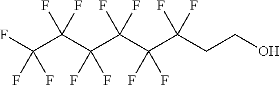 [SMILES: OCCC(F)(F)C(F)(F)C(F)(F)C(F)(F)C(F)(F)C(F)(F)F]
3,3,4,4,5,5,6,6,7,7,8,8,8-tridecafluorooctan-1-ol
(″6:2 FTOH″); 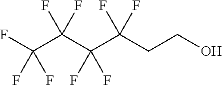 [SMILES: OCCC(F)(F)C(F)(F)C(F)(F)C(F)(F)F]
3,3,4,4,5,5,6,6,6-nonafluorohexan-1-ol (“4:2
FTOH″); 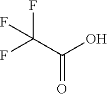
trifluoroacetic acid (″TFA″); 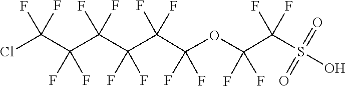 [SMILES: O=S(=O)(O)C(F)(F)C(F)(F)OC(F)(F)C(F)(F)C(F)(F)C(F)(F)C(F)(F)C(F)(F)Cl]
9-chlorohexadecafluoro-3-oxanonane-1-
sulfonic acid (″9C1-PF3ONS″);
and any combination thereof. 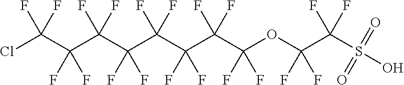 [SMILES: O=S(=O)(O)C(F)(F)C(F)(F)OC(F)(F)C(F)(F)C(F)(F)C(F)(F)C(F)(F)C(F)(F)C(F)(F)C(F)(F)Cl]
11-chloroeicosafluoro-3-oxaundecane-1-
sulfonic acid (″11C1-PF3OUDS″);

7. The system of claim 1, wherein the organic solvent is a sulfoxide, an ether, or a carbonate.

8. The system of claim 1, wherein the current density is in a range of from about 1 mA/cm² to about 1000 mA/cm².

9. Fluoride anion obtained from operation of the system of claim 1.

10. A method for degrading a halogenated compound, comprising:
applying a current density to a working electrode, the working electrode in contact with a nonaqueous solution of an ionic compound and the halogenated compound in an organic solvent to provide a product solution comprising fluoride anion.

11. The method of claim 10, wherein the ionic compound comprises a cation of an alkali metal or an alkaline earth metal.

12. The method of claim 10, wherein the ionic compound comprises a nitrate or a perchlorate anion.

13. The method of claim 10, wherein the halogenated compound is a poly- or perfluoroalkyl substance.

14. The method of claim 13, wherein the halogenated compound is selected from the group consisting of 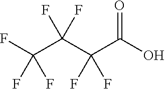 [SMILES: O=C(O)C(F)(F)C(F)(F)C(F)(F)F]
perfluorobutanoic acid (″PFBA″); 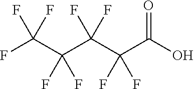 [SMILES: O=C(O)C(F)(F)C(F)(F)C(F)(F)C(F)(F)F]
perfluoropentanoic acid (″PFPeA″); 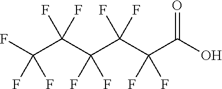 [SMILES: O=C(O)C(F)(F)C(F)(F)C(F)(F)C(F)(F)C(F)(F)F]
perfluorohexanoic acid (″PFHxA″); 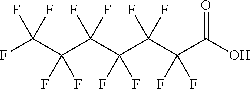 [SMILES: O=C(O)C(F)(F)C(F)(F)C(F)(F)C(F)(F)C(F)(F)C(F)(F)F]
perfluoroheptanoic acid (″PFHpA″); 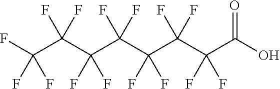 [SMILES: O=C(O)C(F)(F)C(F)(F)C(F)(F)C(F)(F)C(F)(F)C(F)(F)C(F)(F)F]
perfluorooctanoic acid (″PFOA″); 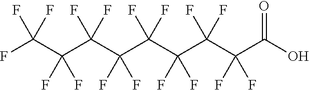 [SMILES: O=C(O)C(F)(F)C(F)(F)C(F)(F)C(F)(F)C(F)(F)C(F)(F)C(F)(F)C(F)(F)F]
perfluorononanoic acid (″PFNA″); 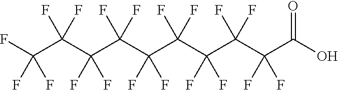 [SMILES: O=C(O)C(F)(F)C(F)(F)C(F)(F)C(F)(F)C(F)(F)C(F)(F)C(F)(F)C(F)(F)C(F)(F)F]
perfluorodecanoic acid (″PFDA″); 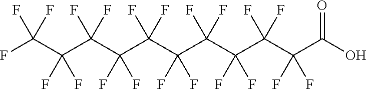 [SMILES: O=C(O)C(F)(F)C(F)(F)C(F)(F)C(F)(F)C(F)(F)C(F)(F)C(F)(F)C(F)(F)C(F)(F)C(F)(F)F]
perfluoroundecanoic acid (″PFUnA″); 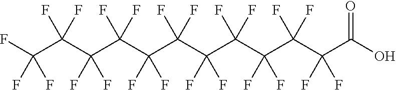 [SMILES: O=C(O)C(F)(F)C(F)(F)C(F)(F)C(F)(F)C(F)(F)C(F)(F)C(F)(F)C(F)(F)C(F)(F)C(F)(F)C(F)(F)F]
perfluorododecanoic acid (″PFDoA″); 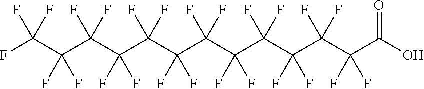 [SMILES: O=C(O)C(F)(F)C(F)(F)C(F)(F)C(F)(F)C(F)(F)C(F)(F)C(F)(F)C(F)(F)C(F)(F)C(F)(F)C(F)(F)C(F)(F)F]
perfluorotridecanoic acid (″PFTriA″); 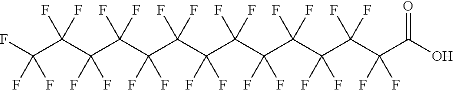 [SMILES: O=C(O)C(F)(F)C(F)(F)C(F)(F)C(F)(F)C(F)(F)C(F)(F)C(F)(F)C(F)(F)C(F)(F)C(F)(F)C(F)(F)C(F)(F)C(F)(F)F]
perfluorotetradecanoic acid (″PFTeA″); 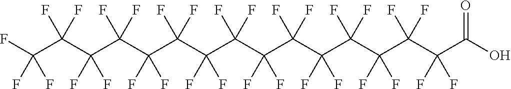 [SMILES: O=C(O)C(F)(F)C(F)(F)C(F)(F)C(F)(F)C(F)(F)C(F)(F)C(F)(F)C(F)(F)C(F)(F)C(F)(F)C(F)(F)C(F)(F)C(F)(F)C(F)(F)C(F)(F)F]
perfluoro-n-hexadecanoic acid (″PFHxDA″); 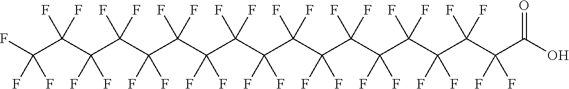 [SMILES: O=C(O)C(F)(F)C(F)(F)C(F)(F)C(F)(F)C(F)(F)C(F)(F)C(F)(F)C(F)(F)C(F)(F)C(F)(F)C(F)(F)C(F)(F)C(F)(F)C(F)(F)C(F)(F)C(F)(F)C(F)(F)F]
perfluorooctadecanoic acid (″PFODA″); 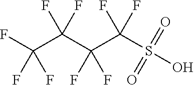 [SMILES: O=S(=O)(O)C(F)(F)C(F)(F)C(F)(F)C(F)(F)F]
perfluorobutanesulfonic acid (″PFBS″); 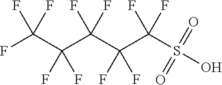 [SMILES: O=S(=O)(O)C(F)(F)C(F)(F)C(F)(F)C(F)(F)C(F)(F)F]
perfluoropentanesulfonic acid (″PFPeS″); 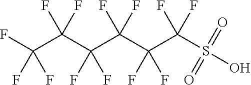 [SMILES: O=S(=O)(O)C(F)(F)C(F)(F)C(F)(F)C(F)(F)C(F)(F)C(F)(F)F]
perfluorohexanesulfonic acid (″PFHxS″); 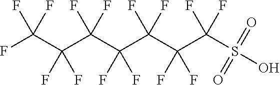 [SMILES: O=S(=O)(O)C(F)(F)C(F)(F)C(F)(F)C(F)(F)C(F)(F)C(F)(F)C(F)(F)F]
perfluoroheptanesulfonic acid (″PFHpS″); 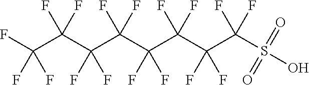 [SMILES: O=S(=O)(O)C(F)(F)C(F)(F)C(F)(F)C(F)(F)C(F)(F)C(F)(F)C(F)(F)C(F)(F)F]
perfluorooctanesulfonic acid (″PFOS″); 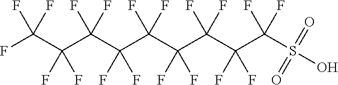 [SMILES: O=S(=O)(O)C(F)(F)C(F)(F)C(F)(F)C(F)(F)C(F)(F)C(F)(F)C(F)(F)C(F)(F)C(F)(F)F]
perfluorononanesulfonic acid (″PFNS″); 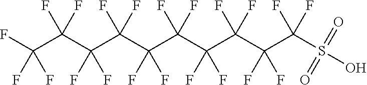 [SMILES: O=S(=O)(O)C(F)(F)C(F)(F)C(F)(F)C(F)(F)C(F)(F)C(F)(F)C(F)(F)C(F)(F)C(F)(F)C(F)(F)F]
perfluoroodecanesulfonic acid (″PFDS″); 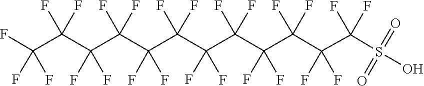 [SMILES: O=S(=O)(O)C(F)(F)C(F)(F)C(F)(F)C(F)(F)C(F)(F)C(F)(F)C(F)(F)C(F)(F)C(F)(F)C(F)(F)C(F)(F)C(F)(F)F]
perfluorododecanesulfonic acid (″PFDoS″); 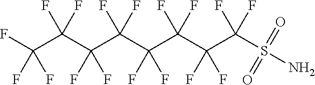 [SMILES: NS(=O)(=O)C(F)(F)C(F)(F)C(F)(F)C(F)(F)C(F)(F)C(F)(F)C(F)(F)C(F)(F)F]
perfluorooctanesulfonamide (″PFOSA″); 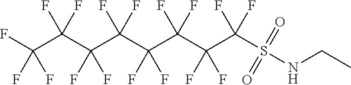 [SMILES: CCNS(=O)(=O)C(F)(F)C(F)(F)C(F)(F)C(F)(F)C(F)(F)C(F)(F)C(F)(F)C(F)(F)F]
N-ethyl-1,1,2,2,3,3,4,4,5,5,6,6,7,7,8,8,8-
heptadecafluorooctane-1-sulfonamide
(″NEtFOSA″); 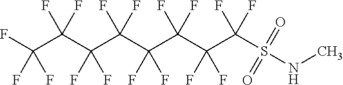 [SMILES: CNS(=O)(=O)C(F)(F)C(F)(F)C(F)(F)C(F)(F)C(F)(F)C(F)(F)C(F)(F)C(F)(F)F]
N-methyl-1,1,2,2,3,3,4,4,5,5,6,6,7,7,8,8,8-
heptadecafluorooctane-1-sulfonamide
(″NMeFOSA″); 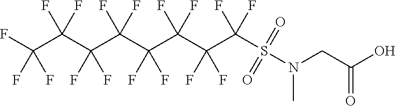 [SMILES: CN(CC(=O)O)S(=O)(=O)C(F)(F)C(F)(F)C(F)(F)C(F)(F)C(F)(F)C(F)(F)C(F)(F)C(F)(F)F]
2-[1,1,2,2,3,3,4,4,5,5,6,6,7,7,8,8,8-
heptadecafluorooctylsulfonyl(methyl)-
amino]acetic acid (″NMeFOSAA″); 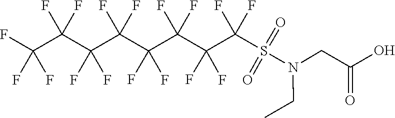 [SMILES: CCN(CC(=O)O)S(=O)(=O)C(F)(F)C(F)(F)C(F)(F)C(F)(F)C(F)(F)C(F)(F)C(F)(F)C(F)(F)F]
2-[1,1,2,2,3,3,4,4,5,5,6,6,7,7,8,8,8-
heptadecafluorooctylsulfony(ethyl)-
amino]acetic acid (″NEtFOSAA″); 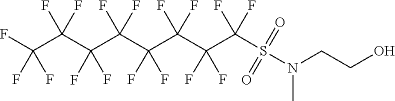 [SMILES: CN(CCO)S(=O)(=O)C(F)(F)C(F)(F)C(F)(F)C(F)(F)C(F)(F)C(F)(F)C(F)(F)C(F)(F)F]
1,1,2,2,3,3,4,4,5,5,6,6,7,7,8,8,8-
heptadecafluoro-N-(2-hydroxyethyl)-N-
methyloctane-1-sulfonamide
(″NMeFOSE″); 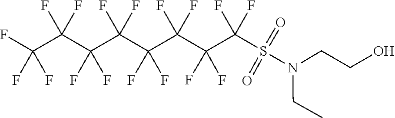 [SMILES: CCN(CCO)S(=O)(=O)C(F)(F)C(F)(F)C(F)(F)C(F)(F)C(F)(F)C(F)(F)C(F)(F)C(F)(F)F]
1,1,2,2,3,3,4,4,5,5,6,6,7,7,8,8,8-
heptadecafluoro-N-ethyl-N-(2-hydroxyethyl)-
octane-1-sulfonamide (″NEtFOSE″); 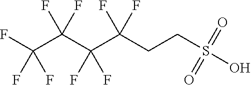 [SMILES: O=S(=O)(O)CCC(F)(F)C(F)(F)C(F)(F)C(F)(F)F]
3,3,4,4,5,5,6,6,6-nonafluorohexane-1-
sulfonic acid (″4:2 FTS″); 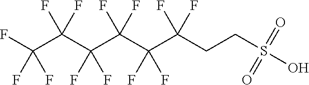 [SMILES: O=S(=O)(O)CCC(F)(F)C(F)(F)C(F)(F)C(F)(F)C(F)(F)C(F)(F)F]
3,3,4,4,5,5,6,6,7,7,8,8,8-tridecafluorooctane-1-
sulfonic acid (″6:2 FTS″); 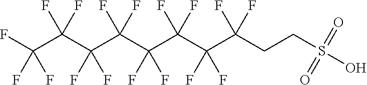 [SMILES: O=S(=O)(O)CCC(F)(F)C(F)(F)C(F)(F)C(F)(F)C(F)(F)C(F)(F)C(F)(F)C(F)(F)F]
3,3,4,4,5,5,6,6,7,7,8,8,9,9,10,10,10-
heptadecafluorodecane-1-sulfonic acid
(″8:2 FTS″); 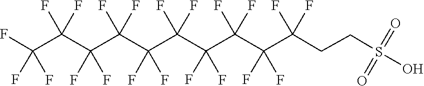 [SMILES: O=S(=O)(O)CCC(F)(F)C(F)(F)C(F)(F)C(F)(F)C(F)(F)C(F)(F)C(F)(F)C(F)(F)C(F)(F)C(F)(F)F]
3,3,4,4,5,5,6,6,7,7,8,8,9,9,10,10,11,11,-
12, 12, 12-henicoasfluorododecane-1-sulfonic
acid (″10:2 FTS″); 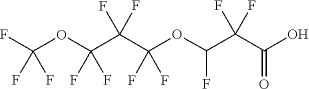 [SMILES: O=C(O)C(F)(F)C(F)OC(F)(F)C(F)(F)C(F)(F)OC(F)(F)F]
2,2,3-trifluoro-3-[1, 1,2,2,3,3-hexafluoro-3-
(trifluoromethoxy)propoxy]propanoic acid
(″DONA″); 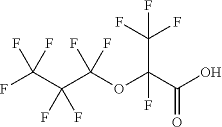 [SMILES: O=C(O)C(F)(OC(F)(F)C(F)(F)C(F)(F)F)C(F)(F)F]
2,3,3,3-tetrafluoro-2-(1,1,2,2,3,3,3-
hexafluoropropoxy)propanoic acid (″HFPO-
DA″ or ″Gen-X″); 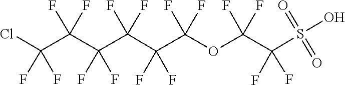 [SMILES: O=S(=O)(O)C(F)(F)C(F)(F)OC(F)(F)C(F)(F)C(F)(F)C(F)(F)C(F)(F)C(F)(F)Cl]
2-(6-chloro-1,1,2,2,3,3,4,4,5,5,6,6-
dodecafluorohexoxy)-1,1,2,2-
tetrafluoroethanesulfonic acid (″F-53B
Major″); 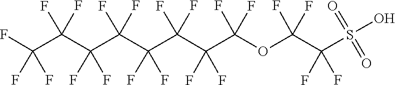 [SMILES: O=S(=O)(O)C(F)(F)C(F)(F)OC(F)(F)C(F)(F)C(F)(F)C(F)(F)C(F)(F)C(F)(F)C(F)(F)C(F)(F)F]
2-(8-chloro-1,1,2,2,3,3,4,4,5,5,6,6,7,7,8,8-
hexadecafluorooctoxy)-1,1,2,2-
tetrafluoroethanesulfonic acid (″F-53B
Minor″); 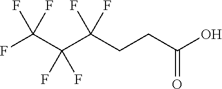 [SMILES: O=C(O)CCC(F)(F)C(F)(F)C(F)(F)F]
4,4,5,5,6,6,6-heptafluorohexanoic acid (“3:3
FTCA″); 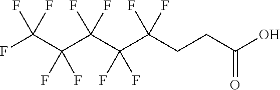 [SMILES: O=C(O)CCC(F)(F)C(F)(F)C(F)(F)C(F)(F)C(F)(F)F]
4,4,5,5,6,6,7,7,8,8,8-undecafluorooctanoic acid
(″5:3 FTCA″); 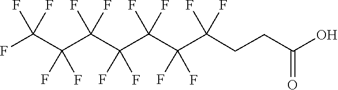 [SMILES: O=C(O)CCC(F)(F)C(F)(F)C(F)(F)C(F)(F)C(F)(F)C(F)(F)C(F)(F)F]
4,4,5,5,6,6,7,7,8,8,9,9,10,10,10-
pentadecafluorodecanoic acid (″7:3
FTCA″); 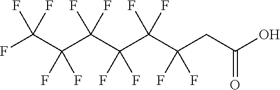 [SMILES: O=C(O)CC(F)(F)C(F)(F)C(F)(F)C(F)(F)C(F)(F)C(F)(F)F]
3,3,4,4,5,5,6,6,7,7,8,8,8-tridecafluorooctanoic
acid (″6:2 FTCA″); 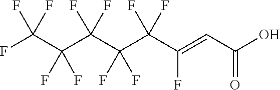 [SMILES: O=C(O)/C=C(\F)C(F)(F)C(F)(F)C(F)(F)C(F)(F)C(F)(F)F]
3,4,4,5,5,6,6,7,7,8,8,8-dodecafluorooct-2-
enoic acid (″6:2 FTUCA″); 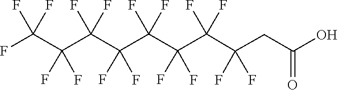 [SMILES: O=C(O)CC(F)(F)C(F)(F)C(F)(F)C(F)(F)C(F)(F)C(F)(F)C(F)(F)C(F)(F)F]
3,3,4,4,5,5,6,6,7,7,8,8,9,9,10,10,10-
heptadecafluorodecanoic acid (″8:2 FTCA″); 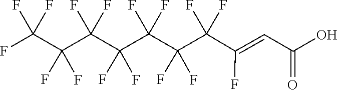 [SMILES: O=C(O)/C=C(\F)C(F)(F)C(F)(F)C(F)(F)C(F)(F)C(F)(F)C(F)(F)C(F)(F)F]
3,4,4,5,5,6,6,7,7,8,8,9,9,10,10,10-
hexadecafluorodec-2-enoic acid (″8:2
FTUCA″); 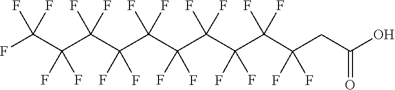 [SMILES: O=C(O)CC(F)(F)C(F)(F)C(F)(F)C(F)(F)C(F)(F)C(F)(F)C(F)(F)C(F)(F)C(F)(F)C(F)(F)F]
3,3,4,4,5,5,6,6,7,7,8,8,9,9,10,10,11,11,-
12,12, 12-henicosafluorododecanoic acid (″10:2
FTCA″); 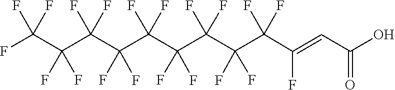 [SMILES: O=C(O)/C=C(\F)C(F)(F)C(F)(F)C(F)(F)C(F)(F)C(F)(F)C(F)(F)C(F)(F)C(F)(F)C(F)(F)F]
(Z)-3,4,4,5,5,6,6,7,7,8,8,9,9,10,10,11,11,-
12,12,12-icosafluorododec-2-enoic acid
(″10:2 FTUCA″); 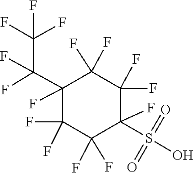 [SMILES: O=S(=O)(O)C1(F)C(F)(F)C(F)(F)C(F)(C(F)(F)C(F)(F)F)C(F)(F)C1(F)F]
perfluoro(4-perfluoroethyl)cyclohexanesulfonic
acid (″PFECHS″); 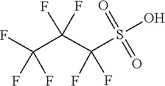 [SMILES: O=S(=O)(O)C(F)(F)C(F)(F)C(F)(F)F]
1,1,2,2,3,3,3-heptafluoropropane-1-sulfonic
acid (″PFPrS″); 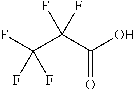
2,2,3,3,3-pentafluoropropanoic acid (″PFPrA″); 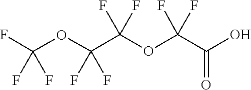 [SMILES: O=C(O)C(F)(F)OC(F)(F)C(F)(F)OC(F)(F)F]
2,2-difluoro-2-[1,1,2,2-tetrafluoro-2-
(trifluoromethoxy)ethoxy]acetic acid
(″NFDHA″); 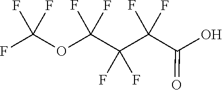 [SMILES: O=C(O)C(F)(F)C(F)(F)C(F)(F)OC(F)(F)F]
2,2,3,3,4,4-hexafluoro-4-
(trifluoromethoxy)butanoic acid (″PFMBA″); 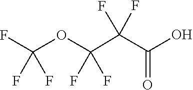 [SMILES: O=C(O)C(F)(F)C(F)(F)OC(F)(F)F]
2,2,3,3-tetrafluoro-3-
(trifluoromethoxy)propanoic acid
(″PFMPA″); 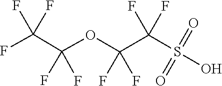 [SMILES: O=S(=O)(O)C(F)(F)C(F)(F)OC(F)(F)C(F)(F)F]
1,1,2,2-tetrafluoro-2-
(perfluoroethoxy)ethanesulfonic acid
(″PFEESA″); 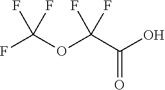 [SMILES: O=C(O)C(F)(F)OC(F)(F)F]
2,2-difluoro-2-(trifluoromethoxy)acetic acid
(″PFMOAA″); 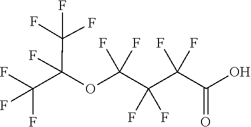 [SMILES: O=C(O)C(F)(F)C(F)(F)C(F)(F)OC(F)(C(F)(F)F)C(F)(F)F]
perfluoro-4-isopropoxybutanoic acid (″PFECA
G″); 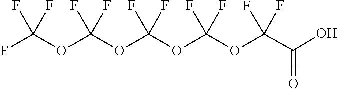 [SMILES: O=C(O)C(F)(F)OC(F)(F)OC(F)(F)OC(F)(F)OC(F)(F)F]
perfluoro-3,5,7,9-butaoxadecanoic acid
(″PFO4DA″); 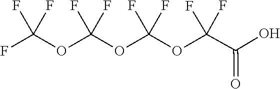 [SMILES: O=C(O)C(F)(F)OC(F)(F)OC(F)(F)OC(F)(F)F]
perfluoro-3,5,7-trioxaoctanoic acid
(″PFO3OA″); 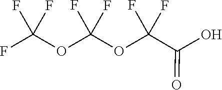 [SMILES: O=C(O)C(F)(F)OC(F)(F)OC(F)(F)F]
perfluoro-3,5-dioxahexanoic acid
(″PFO2HxA″); 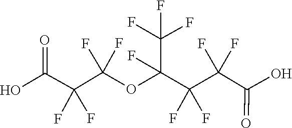 [SMILES: O=C(O)C(F)(F)C(F)(F)OC(F)(C(F)(F)F)C(F)(F)C(F)(F)C(=O)O]
4-(2-carboxy-1,1,2,2-tetrafluoroethoxy)-
perfluoropentanoic acid (″R-EVE″); 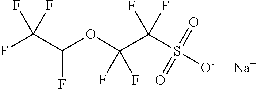 [SMILES: O=S(=O)([O-])C(F)(F)C(F)(F)OC(F)C(F)(F)F ; [Na+]]
sodium 1,1,2,2-tetrafluoro-2-(1,2,2,2-
tetrafluoroethoxy)ethanesulfonate
(″NVOHS″); 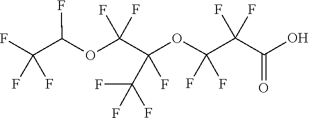 [SMILES: O=C(O)C(F)(F)C(F)(F)OC(F)(C(F)(F)F)C(F)(F)OC(F)C(F)(F)F]
2,2,3,3-tetrafluoro-3-{[1, 1, 1,2,3,3-hexafluoro-
3-(1,2,2,2-tetrafluoroethoxy)propan-2-
yl]oxy)propanoic acid (″Hydro-EVE Acid″); 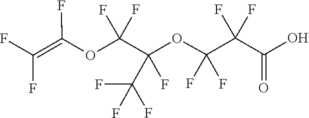 [SMILES: O=C(O)C(F)(F)C(F)(F)OC(F)(C(F)(F)F)C(F)(F)OC(F)=C(F)F]
2,2,3,3-tetrafluoro-3-
[1,1, 1,2,3,3 ]hexafluoro-3-(1,2,2-
trifluoroethenoxy)propan-2-yl ]oxypropanoic
acid (″EVE Acid″); 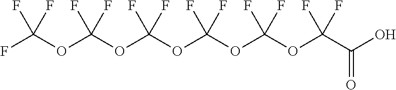 [SMILES: O=C(O)C(F)(F)OC(F)(F)OC(F)(F)OC(F)(F)OC(F)(F)OC(F)(F)F]
perfluoro-3,5,7,9, 11-pentaoxadodecanoic acid
(″PFO5DA″); 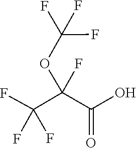 [SMILES: O=C(O)C(F)(OC(F)(F)F)C(F)(F)F]
2,3,3,3-tetrafluoro-2-
(trifluoromethoxy)propanoic acid
(″PMPA″); 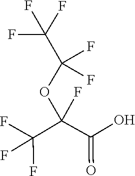 [SMILES: O=C(O)C(F)(OC(F)(F)C(F)(F)F)C(F)(F)F]
2,3,3,3-tetrafluoro-2-
(pentafluoroethoxy)propanoic acid (″PEPA″); 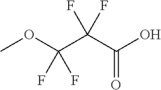
2,2,3,3-tetrafluoro-3-methoxy-propanoic
acid (″MTP″); 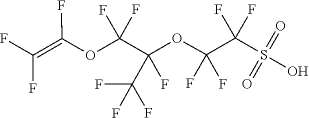 [SMILES: O=S(=O)(O)C(F)(F)C(F)(F)OC(F)(C(F)(F)F)C(F)(F)OC(F)=C(F)F]
1,1,2,2-tetrafluoro-2-[1,1,1,2,3,3-hexafluoro-3-
(1,2,2-trifluoroethenoxy)propan-2-
yl]oxyethanesulfonic acid (″PS Acid″); 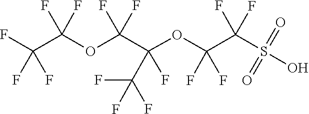 [SMILES: O=S(=O)(O)C(F)(F)C(F)(F)OC(F)(C(F)(F)F)C(F)(F)OC(F)(F)C(F)(F)F]
1,1,2,2-tetrafluoro-2-[1,1,1,2,3,3-
hexafluoro-3-(1,2,2,2-
tetrafluoroethoxy)propan-2-
yl]oxyethanesulfonic acid (″Hydro-PS
Acid″); 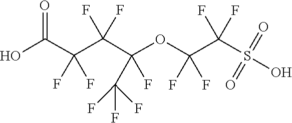 [SMILES: O=C(O)C(F)(F)C(F)(F)C(F)(OC(F)(F)C(F)(F)S(=O)(=O)O)C(F)(F)F]
2,2,3,3,4,5,5,5-4-(1,1,2,2-tetrafluoro-2-
sulfoethoxy)pentanoic acid (″R-PSDA″); 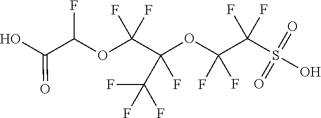 [SMILES: O=C(O)C(F)OC(F)(F)C(F)(OC(F)(F)C(F)(F)S(=O)(=O)O)C(F)(F)F]
2-fluoro-2-[1,1,2,3,3,3-hexafluoro-2-
(1,1,2,2-tetrafluoro-2-
sulfoethoxy)propoxy ]acetic acid
(″Hydrolyzed PSDA″); 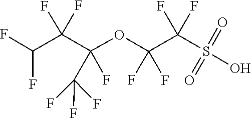 [SMILES: O=S(=O)(O)C(F)(F)C(F)(F)OC(F)(C(F)(F)F)C(F)(F)C(F)F]
1,1,2,2-tetrafluoro-2-[(1,1,1,2,3,3,4,4-
octafluorobutan-2-y1)oxyJethane-1-sulfonic
acid (″R-PSDCA″); 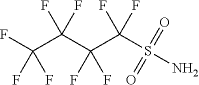 [SMILES: NS(=O)(=O)C(F)(F)C(F)(F)C(F)(F)C(F)(F)F]
1,1,2,2,3,3,4,4,4-nonafluorobutane-1-
sulfonamide (″FBSA″); 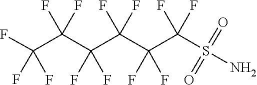 [SMILES: NS(=O)(=O)C(F)(F)C(F)(F)C(F)(F)C(F)(F)C(F)(F)C(F)(F)F]
1,1,2,2,3,3,4,4,5,5,6,6,6-tridecafluorohexane-1-
sulfonamide (″FHxSA″); 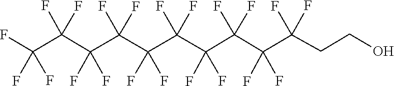 [SMILES: OCCC(F)(F)C(F)(F)C(F)(F)C(F)(F)C(F)(F)C(F)(F)C(F)(F)C(F)(F)C(F)(F)C(F)(F)F]
3,3,4,4,5,5,6,6,7,7,8,8,9,9,10,10,11,11,-
12,12, 12-henicosafluorododoecan-1-ol
(″10:2 FTOH″); 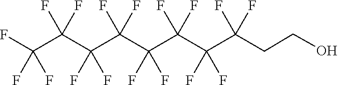 [SMILES: OCCC(F)(F)C(F)(F)C(F)(F)C(F)(F)C(F)(F)C(F)(F)C(F)(F)C(F)(F)F]
3,3,4,4,5,5,6,6,7,7,8,8,9,9,10,10,10-
heptadecafluorodecan-1-ol (″8:2 FTOH″); 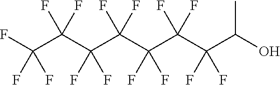 [SMILES: CC(O)C(F)(F)C(F)(F)C(F)(F)C(F)(F)C(F)(F)C(F)(F)C(F)(F)F]
3,3,4,4,5,5,6,6,7,7,8,8,9,9,9-
pentadecafluorononan-2-ol (″7:2 FTOH″); 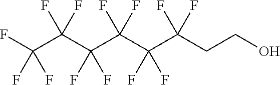 [SMILES: OCCC(F)(F)C(F)(F)C(F)(F)C(F)(F)C(F)(F)C(F)(F)F]
3,3,4,4,5,5,6,6,7,7,8,8,8-tridecafluorooctan-1-ol
(″6:2 FTOH″); 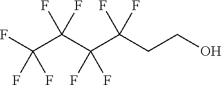 [SMILES: OCCC(F)(F)C(F)(F)C(F)(F)C(F)(F)F]
3,3,4,4,5,5,6,6,6-nonafluorohexan-1-ol (“4:2
FTOH″); 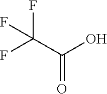
trifluoroacetic acid (″TFA″); 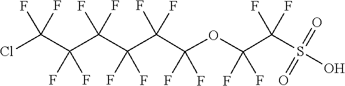 [SMILES: O=S(=O)(O)C(F)(F)C(F)(F)OC(F)(F)C(F)(F)C(F)(F)C(F)(F)C(F)(F)C(F)(F)Cl]
9-chlorohexadecafluoro-3-oxanonane-1-
sulfonic acid (″9C1-PF3ONS″);
and any combination thereof. 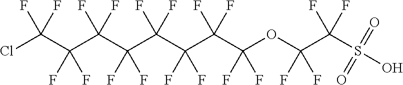 [SMILES: O=S(=O)(O)C(F)(F)C(F)(F)OC(F)(F)C(F)(F)C(F)(F)C(F)(F)C(F)(F)C(F)(F)C(F)(F)C(F)(F)Cl]
11-chloroeicosafluoro-3-oxaundecane-1-
sulfonic acid (″11C1-PF3OUDS″);

15. The method of claim 10, wherein the organic solvent is a sulfoxide, an ether, or a carbonate.

16. The method of claim 10, wherein the current density is in a range of from about 1 mA/cm² to about 1000 mA/cm².

17. The method of claim 10, wherein the applying is in the presence of a positive electric field.

18. The method of claim 10, wherein the halogenated compound is at least 90% defluorinated.

19. The method of claim 10, further comprising, after the applying, isolating fluoride anion from the product solution and/or an electrode in contact with the solution.

20. The method of claim 19, further comprising reacting the fluoride anion with another reagent to produce a compound that is not poly- or perfluorinated.
